(19) United States
(12) Patent Application Publication
(10) Pub. No.: US 2023/0297397 A1
(43) Pub. Date: Sep. 21, 2023

(54) SOFTWARE APPLICATION STREAMING SYSTEM

(71) Applicant: Oorbit, Inc., London (GB)

(72) Inventors: Ashkan Kooshanejad, London (GB); Pooya Kooshanezhad, London (GB)

(21) Appl. No.: 18/187,333

(22) Filed: Mar. 21, 2023

Related U.S. Application Data
(60) Provisional application No. 63/322,039, filed on Mar. 21, 2022.

(51) Int. Cl. G06F 9/451; G06F 9/50; G06F 3/0482; A63F 13/355; A63F 13/533

(52) U.S. Cl. CPC G06F 9/451; G06F 9/5083; G06F 3/0482; A63F 13/355; A63F 13/533

(57) ABSTRACT

Described herein are various embodiments of a software application streaming system for executing interactive applications (e.g., videogame applications). The system may execute various different interactive applications accessed by multiple different user devices by allocating geographically distributed computer hardware for execution of the interactive applications. For a given interactive application requested for access by a user device, the software application streaming system may identify particular computer hardware of the geographically distributed computer hardware that can be used to most efficiently stream the interactive application at the time the request is received. The software application streaming system may configure the identified computer hardware to execute the interactive application. The software application streaming system may execute the interactive application using the configured computer hardware and transmit a data stream (e.g., of video data and/or audio data) to the user device of content generated from execution of the interactive application.

### RELATED APPLICATIONS

This application claims benefit under 35 U.S.C. § 119(e) to U.S. Provisional Application No. 63/322,039, entitled “VIDEOGAME STREAMING SYSTEM,” filed on Mar. 21, 2022, which is incorporated by reference herein in its entirety.

### FIELD

This application relates generally to a cloud-based software application streaming system. The software application streaming system allocates geographically distributed computer hardware available to the system for execution of various interactive applications (e.g., videogame applications) requested by multiple different devices. The software application streaming system then transmits a data stream (e.g., of video and/or audio data) generated from execution of the interactive applications using the allocated computer hardware.

### BACKGROUND

A user can access video game content from an online repository. A computing device may download the videogame application from the online repository and execute the videogame application. When the computing device executes the videogame application, the computing device may present a graphical user interface (GUI) on a display of the computing device through which a user can play the videogame.

### SUMMARY

Described herein are various embodiments of a software application streaming system for executing interactive applications (e.g., videogame applications). The system may execute various different interactive applications accessed by multiple different user devices by allocating geographically distributed computer hardware for execution of the interactive applications. For a given interactive application requested for access by a user device, the software application streaming system may identify particular computer hardware of the geographically distributed computer hardware that can be used to efficiently stream the interactive application at the time the request is received. The software application streaming system may configure the identified computer hardware to execute the interactive application. The software application streaming system may execute the interactive application using the configured computer hardware and transmit a data stream (e.g., of video data and/or audio data) to the user device of content generated from execution of the interactive application.

Some embodiments provide a software application streaming system for executing a plurality of interactive applications accessible by multiple devices by allocating geographically distributed computer hardware for execution of the plurality of interactive applications. The system comprises: at least one processor; and at least one non-transitory computer-readable storage medium storing instructions that, when executed by the at least one processor, cause the at least one processor to execute a plurality of modules of the software application streaming system, the plurality of modules including: a client interface module configured to receive, from a plurality of devices through a communication network, a plurality of requests to access the plurality of interactive applications, the plurality of requests comprising a first request from a first one of the plurality of devices to access a first one of the plurality of interactive applications; a computing resource allocation module configured to allocate the geographically distributed computer hardware for executing the plurality of interactive applications, the allocating comprising: determining an indication of a geographic location of the first device; identifying, using the indication of the geographic location of the first device, first computer hardware from the geographically distributed hardware to execute the first interactive application requested for access by the first device; and configuring the first computer hardware for execution of the first interactive application; an application execution module configured to execute the plurality of interactive applications based on allocation of the geographically distributed computer hardware by the computing resource allocation module, the executing comprising: executing the first interactive application using the configured first computer hardware identified for the first device; wherein the client interface module is further configured to: transmit, to the first device through the communication network, content generated from execution of the first interactive application; and receive, from the first device through the communication network, user input for use by the first interactive application.

In some embodiments, configuring the first computer hardware for execution of the first interactive application comprises: configuring a portion of processing capacity of the first computer hardware for use in execution of the first interactive application. In some embodiments, the client interface module is further configured to receive, through the communication network from the first device, input during execution of the first interactive application; and configuring the first computer hardware for execution of the first interactive application comprises updating an amount of processing capacity and/or memory for use in execution of the first interactive application based on the input received during execution of the first interactive application.

In some embodiments, identifying, from the computer hardware distributed across the multiple geographic locations, the first computer hardware for execution of the first interactive application requested for access by the first device comprises: determining that the first computer hardware of the geographically distributed computer hardware is closest to the geographic location of the first device; and identifying the first computer hardware for execution of the first interactive application based on determining that the first computer hardware is the closest of the graphically distributed computer hardware to the geographic location of the first device.

In some embodiments, identifying, from the computer hardware distributed across the multiple geographic locations, the first computer hardware for execution of the first interactive application requested for access by the first device comprises: determining that second computer hardware of the geographically distributed computer hardware is closest to the geographic location of the first device; determining that the second computer hardware does not have capacity to execute the first interactive application; and identifying the first computer hardware for execution of the first interactive application when it is determined that the second computer hardware does not have the capacity to execute the first interactive application. In some embodiments, the allocating further comprises determining, after beginning execution of the first interactive application using the first computer hardware, that the second computer hardware has sufficient capacity to execute the first interactive application; wherein the application execution module is further configured to execute the first interactive application using the second computer hardware after a determination that the second computer hardware has sufficient capacity to execute the first interactive application.

In some embodiments, executing the first interactive application using the configured first computer hardware comprises executing the first interactive application as one or more containerized applications using the first computer hardware. In some embodiments, configuring the first computer hardware for execution of the first interactive application comprises configuring the first computer hardware for execution of a supporting application used by the first interactive application; and allocating the geographically distributed computer hardware for executing the plurality of interactive applications comprises: determining that at least one other interactive application of the plurality of interactive applications uses the supporting interactive application; and configuring the first computer hardware for execution of the at least one other interactive application, the configuring comprising providing the at least one other interactive application access to the supporting interactive application.

In some embodiments, supporting interactive application comprises a three-dimensional (3D) engine. In some embodiments, the plurality of interactive applications comprises a plurality of different videogame applications.

In some embodiments, the system further comprises a datastore, wherein: configuring the first computer hardware for execution of the first interactive application comprises designating at least a portion of computing capacity of the first computer hardware for execution of the first interactive application; and allocating the geographically distributed computer hardware for executing the plurality of interactive applications further comprises: determining to stop execution of the first interactive application; storing data generated from execution of the first interactive application in the datastore; and releasing the at least a portion of the computing capacity of the first computer hardware to make it available for execution of another interactive application. In some embodiments, determining to stop execution of the first interactive application comprises: determining that no input has been received from the first device for a threshold amount of time.

In some embodiments, the system further comprises a datastore storing data from a previously executed session of the first interactive application; wherein configuring the first computer hardware for execution of the first interactive application comprises loading the data from the previous session of the first interactive application into memory of the first computer hardware for use in executing the first interactive application. In some embodiments, allocating the geographically distributed computer hardware for executing the plurality of interactive applications further comprises: configuring first computer hardware for execution of multiple interactive applications of the plurality of interactive applications, the multiple interactive applications including the first interactive application.

In some embodiments, the client interface module is further configured to: generate a uniform resource locator (URL) through which the first device can communicate with the first interactive application configured for execution by the first computer hardware; and transmit, through the communication network to the first device, the URL to allow the first device to communicate with the first interactive application.

Some embodiments provide a method for executing a plurality of interactive applications accessible by multiple devices by allocating geographically distributed computer hardware for execution of the plurality of interactive applications. The method comprises: using at least one processor to perform: receiving, from a plurality of devices through a communication network, a plurality of requests to access the plurality of interactive applications, the plurality of requests comprising a first request from a first one of the plurality of devices to access a first one of the plurality of interactive applications; allocating the geographically distributed computer hardware for executing the plurality of interactive applications, the allocating comprising: determining an indication of a geographic location of the first device; identifying, using the indication of the geographic location of the first device, first computer hardware from the geographically distributed hardware to execute the first interactive application requested for access by the first device; and configuring the first computer hardware for execution of the first interactive application; executing the plurality of interactive applications based on allocation of the geographically distributed computer hardware by the computing resource allocation module, the executing comprising: executing the first interactive application using the configured first computer hardware identified for the first device; transmitting, to the first device through the communication network, content generated from execution of the first interactive application; and receiving, from the first device through the communication network, user input for use by the first interactive application.

In some embodiments, identifying, from the computer hardware distributed across the multiple geographic locations, the first computer hardware for execution of the first interactive application requested for access by the first device comprises: determining that the first computer hardware of the geographically distributed computer hardware is closest to the geographic location of the first device; and identifying the first computer hardware for execution of the first interactive application based on determining that the first computer hardware is the closest of the graphically distributed computer hardware to the geographic location of the first device.

In some embodiments, identifying, from the computer hardware distributed across the multiple geographic locations, the first computer hardware for execution of the first interactive application requested for access by the first device comprises: determining that second computer hardware of the geographically distributed computer hardware is closest to the geographic location of the first device; determining that the second computer hardware does not have capacity to execute the first interactive application; and identifying the first computer hardware for execution of the first interactive application when it is determined that the second computer hardware does not have the capacity to execute the first interactive application. In some embodiments, the allocating further comprises determining, after beginning execution of the first interactive application using the first computer hardware, that the second computer hardware has sufficient capacity to execute the first interactive application; and the method further comprises executing the first interactive application using the second computer hardware after a determination that the second computer hardware has sufficient capacity to execute the first interactive application.

Some embodiments least one non-transitory computer-readable storage medium storing instructions that, when executed by at least one processor, cause the at least one processor to perform a method for executing a plurality of interactive applications accessible by multiple devices by allocating geographically distributed computer hardware for execution of the plurality of interactive applications. The method comprises: receiving, from a plurality of devices through a communication network, a plurality of requests to access the plurality of interactive applications, the plurality of requests comprising a first request from a first one of the plurality of devices to access a first one of the plurality of interactive applications; allocating the geographically distributed computer hardware for executing the plurality of interactive applications, the allocating comprising: determining an indication of a geographic location of the first device; identifying, using the indication of the geographic location of the first device, first computer hardware from the geographically distributed hardware to execute the first interactive application requested for access by the first device; and configuring the first computer hardware for execution of the first interactive application; executing the plurality of interactive applications based on allocation of the geographically distributed computer hardware by the computing resource allocation module, the executing comprising: executing the first interactive application using the configured first computer hardware identified for the first device; transmitting, to the first device through the communication network, content generated from execution of the first interactive application; and receiving, from the first device through the communication network, user input for use by the first interactive application.

Some embodiments provide a software application streaming system for executing multiple interactive applications accessible by multiple devices using geographically distributed computer hardware for execution of the interactive applications. The system comprises: at least one processor; and at least one non-transitory computer-readable storage medium storing instructions that, when executed by the at least one processor, cause the at least one processor to execute a plurality of modules of the software application streaming system, the plurality of modules including: a client interface module configured to receive, from a plurality of devices through a communication network, a plurality of requests to access a plurality of interactive applications; a computing resource allocation module configured to allocate the geographically distributed computer hardware for execution of the plurality of interactive applications, wherein the allocating comprises: identifying, from the geographically distributed computer hardware, first computer hardware for execution of the plurality of interactive applications, the first computer hardware comprising at least one computer hardware processor; and configuring the first computer hardware for execution of the plurality of interactive applications, the configuring comprising: dividing computing capacity of the at least one computer hardware processor into multiple computing portions; and assigning a plurality of the multiple computing portions for execution of the plurality of interactive applications; an application execution module configured to execute the plurality of interactive applications based on allocation by the computing resource allocation module, the executing comprising: executing the plurality of interactive applications using the assigned plurality of computing portions; wherein the client interface module is further configured to transmit, to the plurality of devices through the communication network, content generated from execution of the plurality of interactive applications.

In some embodiments, the at least one computer hardware processor comprises a graphics processing unit (GPU). In some embodiments, transmitting, to the plurality of devices through the communication network, the content generated from execution of the plurality of interactive applications comprises: transmitting video and/or audio data to the plurality of devices. In some embodiments, the client interface module is further configured to receive, from the plurality of devices through the communication network, user input; and the application execution module is further configured to use the user inputs in execution of the plurality of interactive applications.

In some embodiments, assigning the plurality computing portions for execution of the plurality of interactive applications comprises: assigning each of the plurality of interactive applications to at least one of the plurality of computing portions. In some embodiments, executing the plurality of interactive applications using the assigned plurality of computing portions comprises: executing each of the plurality of interactive applications using one or more of the plurality of computing portions assigned to the interactive application.

In some embodiments, the multiple computing portions are associated with respective hardware portions of the at least one computer hardware processor. In some embodiments, identifying, from the geographically distributed computer hardware, the first computer hardware for execution of the plurality of interactive applications comprises: determining indications of geographic locations of the plurality of devices; and identifying the first computer hardware for execution of the plurality of interactive applications using the indications of the geographic locations of the plurality of devices. In some embodiments, identifying the first computer hardware for execution of the plurality of interactive applications using the indications of the geographic locations of the plurality of devices comprises: determining, using the indications of the geographic locations of the plurality of devices, that the first computer hardware is closest to at least some of the geographic locations of the plurality of devices; and identifying the first computer hardware for execution of the plurality of interactive applications based on determining that the first computer hardware is the closest to the at least some geographic locations.

In some embodiments, the first computer hardware comprises memory, the memory divided into multiple memory portions; and configuring the first computer hardware for execution of the plurality of interactive applications comprises: assigning a plurality of the multiple portions for execution of respective ones of the plurality of interactive applications.

In some embodiments, at least some of the plurality of interactive applications are videogame applications. In some embodiments, configuring the first computer hardware for execution of the plurality of interactive applications comprises: determining sizes of the plurality of computing portions assigned for execution of the plurality of interactive applications.

Some embodiments provide a method for executing multiple interactive applications accessible by multiple devices using geographically distributed computer hardware for execution of the interactive applications. The method comprises: using at least one processor to perform: receiving, from a plurality of devices through a communication network, a plurality of requests to access a plurality of interactive applications; allocating the geographically distributed computer hardware for execution of the plurality of interactive applications, wherein determining the allocating comprises: identifying, from the geographically distributed computer hardware, first computer hardware for execution of the plurality of interactive applications, the first computer hardware comprising at least one computer hardware processor; and configuring the first computer hardware for execution of the plurality of interactive applications, the configuring comprising: dividing computing capacity of the at least one computer hardware processor into multiple computing portions; and assigning a plurality of the multiple computing portions for execution of the plurality of interactive applications; executing the plurality of interactive applications based on allocation by the computing resource allocation module, the executing comprising: executing the plurality of interactive applications using the assigned plurality of computing portions; and transmitting, to the plurality of devices through the communication network, content generated from execution of the plurality of interactive applications.

In some embodiments, the at least one computer hardware processor comprises a graphics processing unit (GPU).

In some embodiments, assigning the plurality computing portions for execution of the plurality of interactive applications comprises: assigning each of the plurality of interactive applications to at least one of the plurality of computing portions. In some embodiments, executing the plurality of interactive applications using the assigned plurality of computing portions comprises: executing each of the plurality of interactive applications using one or more of the plurality of computing portions assigned to the interactive application.

In some embodiments, the multiple computing portions are associated with respective hardware portions of the at least one computer hardware processor. In some embodiments, the first computer hardware comprises memory, the memory divided into multiple memory portions; and configuring the first computer hardware for execution of the plurality of interactive applications comprises: assigning a plurality of the multiple portions for execution of respective ones of the plurality of interactive applications.

In some embodiments, configuring the first computer hardware for execution of the plurality of interactive applications comprises: determining sizes of the plurality of computing portions assigned for execution of the plurality of interactive applications.

Some embodiments provide least one non-transitory computer-readable storage medium storing instructions that, when executed by at least one processor, cause the at least one processor to perform a method for executing multiple interactive applications accessible by multiple devices using geographically distributed computer hardware for execution of the interactive applications The method comprises: receiving, from a plurality of devices through a communication network, a plurality of requests to access a plurality of interactive applications; allocating the geographically distributed computer hardware for execution of the plurality of interactive applications, wherein determining the allocating comprises: identifying, from the geographically distributed computer hardware, first computer hardware for execution of the plurality of interactive applications, the first computer hardware comprising at least one computer hardware processor; and configuring the first computer hardware for execution of the plurality of interactive applications, the configuring comprising: dividing computing capacity of the at least one computer hardware processor into multiple computing portions; and assigning a plurality of the multiple computing portions for execution of the plurality of interactive applications; executing the plurality of interactive applications based on allocation by the computing resource allocation module, the executing comprising: executing the plurality of interactive applications using the assigned plurality of computing portions; and transmitting, to the plurality of devices through the communication network, content generated from execution of the plurality of interactive applications.

Some embodiments provide a software application streaming system for providing a virtual network among a plurality of interactive applications executed by a software application streaming system using geographically distributed computer hardware. The system comprises: at least one processor; at least one network interface configured to communicate with the geographically distributed computers; and at least one non-transitory computer-readable storage medium storing instructions that, when executed by the at least one processor, cause the at least one processor to execute a plurality of modules of the software application streaming system, the plurality of modules including: a computing resource allocation module configured to allocate computer hardware of the geographically distributed computer hardware for execution of the plurality of interactive applications, wherein the allocating comprises: configuring first computer hardware of the geographically distributed computer hardware for execution of a first one of the plurality of interactive applications, the first computer hardware in a first location; and configuring second computer hardware of the geographically distributed computer hardware for execution of a second one of the plurality of interactive applications, the second computer hardware in a second location different from the first location; a virtual network module configured to: route data from interactive applications of the plurality of interactive application to other interactive applications of the plurality of interactive applications, the routing comprising: obtaining, through the at least one network interface from the first computer hardware, a first software object of the first interactive application; and transmitting, through the at least one network interface to the second computer hardware, the first software object for use in execution of the second interactive application; and an application execution module configured to execute the second interactive application on the second computer hardware using the data transmitted from the first interactive application.

In some embodiments, the first interactive application comprises a first videogame engine and the second interactive application comprises a second videogame engine. In some embodiments, transmitting, through the at least one network interface to the second computer hardware, the first software object affects execution of the second interactive application.

In some embodiments, routing the data from the interactive applications of the plurality of interactive applications to the other interactive applications comprises routing data indicating software objects from the interactive applications to the other interactive applications using a consensus protocol. In some embodiments, the consensus protocol indicates at least one software object of the first interactive application that can be transmitted for use in the second interactive application. In some embodiments, the consensus protocol indicates instructions for transforming the at least one software object of the first interactive application into at least one software object of the second interactive application. In some embodiments, the at least one software object of the first interactive application comprises data associated with a user, an executable function, a set of software code, a three dimensional (3D) virtual object, and/or an avatar. In some embodiments, the first interactive application is a first videogame application and the second interactive application is a second videogame application; and transmitting the first software object comprises transmitting at least one three-dimensional (3D) virtual from the first videogame application to the second videogame application.

In some embodiments, the system further comprises: a datastore storing, for at least one of the plurality of the interactive applications: an indication of at least one software object of the at least one interactive application; and an indication of one or more other ones of the plurality of interactive applications that the at least one software object can be routed to from the at least one interactive application.

In some embodiments, transmitting, through the at least one network interface to the second computer hardware, the first software object for use in execution of the second interactive application comprises: transforming the first software object from the first interactive application to obtain a transformed software object that is usable by the second interactive application; and providing the transformed software object to the second interactive application.

Some embodiments provide a method for providing a virtual network among a plurality of interactive applications executed using geographically distributed computer hardware. The method comprises: using at least one processor to perform: allocating computer hardware of the geographically distributed computer hardware for execution of the plurality of interactive applications, wherein the allocating comprises: configuring first computer hardware of the geographically distributed computer hardware for execution of a first one of the plurality of interactive applications, the first computer hardware in a first location; and configuring second computer hardware of the geographically distributed computer hardware for execution of a second one of the plurality of interactive applications, the second computer hardware in a second location different from the first location; routing data from interactive applications of the plurality of interactive application to other interactive applications of the plurality of interactive applications, the routing comprising: obtaining, through the at least one network interface from the first computer hardware, a first software object of the first interactive application; and transmitting, through the at least one network interface to the second computer hardware, the first software object for use in execution of the second interactive application; and executing the second interactive application on the second computer hardware using the data transmitted from the first interactive application.

In some embodiments, the first interactive application comprises a first videogame engine and the second interactive application comprises a second videogame engine.

In some embodiments, routing the data from the interactive applications of the plurality of interactive applications to the other interactive applications comprises routing data indicating software objects from the interactive applications to the other interactive applications using a consensus protocol. In some embodiments, the consensus protocol indicates at least one software object of the first interactive application that can be transmitted for use in the second interactive application. In some embodiments, the consensus protocol indicates instructions for transforming the at least one software object of the first interactive application into at least one software object of the second interactive application. In some embodiments, the at least one software object of the first interactive application comprises data associated with a user, an executable function, a set of software code, a three dimensional (3D) virtual object, and/or an avatar. In some embodiments, the first interactive application is a first videogame application and the second interactive application is a second videogame application; and transmitting the first software object comprises transmitting at least one three-dimensional (3D) virtual from the first videogame application to the second videogame application.

In some embodiments, the method further comprises: storing, in a datastore for at least one of the plurality of the interactive applications: an indication of at least one software object of the at least one interactive application; and an indication of one or more other ones of the plurality of interactive applications that the at least one software object can be routed to from the at least one interactive application.

In some embodiments, transmitting, through the at least one network interface to the second computer hardware, the first software object for use in execution of the second interactive application comprises: transforming the first software object from the first interactive application to obtain a transformed software object that is usable by the second interactive application; and providing the transformed software object to the second interactive application.

Some embodiments provide at least one non-transitory computer-readable storage medium storing instructions that, when executed by at least one processor, cause the at least one processor to perform a method for providing a virtual network among a plurality of interactive applications executed using geographically distributed computer hardware. The method comprises: allocating computer hardware of the geographically distributed computer hardware for execution of the plurality of interactive applications, wherein the allocating comprises: configuring first computer hardware of the geographically distributed computer hardware for execution of a first one of the plurality of interactive applications, the first computer hardware in a first location; and configuring second computer hardware of the geographically distributed computer hardware for execution of a second one of the plurality of interactive applications, the second computer hardware in a second location different from the first location; routing data from interactive applications of the plurality of interactive application to other interactive applications of the plurality of interactive applications, the routing comprising: obtaining, through the at least one network interface from the first computer hardware, a first software object of the first interactive application; and transmitting, through the at least one network interface to the second computer hardware, the first software object for use in execution of the second interactive application; and executing the second interactive application on the second computer hardware using the data transmitted from the first interactive application.

Some embodiments provide a system for searching for objects among a plurality of interactive applications accessible by multiple devices through a software application streaming system that allocates geographically distributed computer hardware for execution of the plurality of interactive applications. The system comprises: at least one processor; and at least one non-transitory computer-readable storage medium storing instructions that, when executed by the at least one processor, cause the at least one processor to execute a query processing module configured to: receive, from a device of the multiple devices through a graphical user interface (GUI) presented on the device, a query indicating a search object; process the query at least in part by: accessing, from the software application streaming system, at least some of the plurality of interactive applications; and searching the at least some interactive applications based on the search object indicated by the query to obtain one or more results, the one or more results comprising an indication of one or more of the plurality of interactive applications that match the search object indicated by the query; and present, in the GUI, the one or more results obtained from processing the query.

In some embodiments, the plurality of interactive applications provide a plurality of videogame environments; and searching the at least some interactive applications based on the search object indicated by the query to obtain the one or more results comprises: identifying one or more of the plurality of videogame environments that include the search object indicated by the query. In some embodiments, searching the at least some interactive applications to obtain the one or more results comprises: parsing code of the at least some interactive applications to identify the one or more results.

In some embodiments, the system comprises a datastore storing tags associated with different software objects in code of the plurality of interactive applications. In some embodiments, searching the at least some interactive applications based on the search object indicated by the query to obtain the one or more results comprises: identifying one or more of the tags based on the search object; and identifying one or more software objects associated with the identified one or more tags to determine the one or more search results.

In some embodiments, instructions further cause the at least one processor to execute a client interface module configured to: receive, through a communication network from the device, the query indicating the search object in response to user input provided through the GUI; and transmit, through the communication network to the device, the one or more results obtained from processing the query.

In some embodiments, presenting, in the GUI, the one or more results obtained from processing the query comprises including, in the GUI, one or more selectable elements corresponding to the one or more results, each of the one or more selectable elements associated with a respective one of the plurality of interactive applications; and the instructions further cause the at least one processor to: execute a computing resource allocation module configured to: in response to selection of a first one of the one or more selectable elements, configure first computer hardware of the distributed computer hardware for execution of a first one of the plurality of interactive applications associated with the first selectable element; and execute an application execution module configured to execute the first interactive application using the first computer hardware.

In some embodiments, accessing, from the software application streaming system, the at least some interactive applications comprises accessing code of the at least some interactive applications from a datastore of the software application streaming system. In some embodiments, searching the at least some interactive applications based on the search object indicated by the query comprises identifying text in the code of the at some interactive applications that matches the search object. In some embodiments, the at least one processor is configured to execute a computing resource allocation module configured to allocate the geographically distributed computer hardware for execution of the plurality of interactive applications.

Some embodiments provide a method for searching for objects among a plurality of interactive applications accessible by multiple devices through a software application streaming system that allocates geographically distributed computer hardware for execution of the plurality of interactive applications. The method comprises: using at least one processor to perform: receiving, from a device of the multiple devices through a graphical user interface (GUI) presented on the device, a query indicating a search object; processing the query at least in part by: accessing, from the software application streaming system, at least some of the plurality of interactive applications; and searching the at least some applications based on the search object indicated by the query to obtain one or more results, the one or more results comprising an indication of one or more of the plurality of interactive applications that match the search object indicated by the query; and presenting, in the GUI, the one or more results obtained from processing the query.

In some embodiments, the plurality of interactive applications provide a plurality of videogame environments; and searching the at least some interactive applications based on the search object indicated by the query to obtain the one or more results comprises: identifying one or more videogame environments that include the search object indicated by the query. In some embodiments, searching the at least some interactive applications to obtain the one or more results comprises: parsing code of the at least some interactive applications to identify the one or more results.

In some embodiments, the method comprises: storing, in a datastore, tags associated with different software objects in code of the plurality of interactive applications. In some embodiments, searching the at least some interactive applications based on the search object indicated by the query to obtain the one or more results comprises: identifying one or more of the tags based on the search object; and identifying one or more software objects associated with the identified one or more tags to determine the one or more search results.

In some embodiments, presenting, in the GUI, the one or more results obtained from processing the query comprises including, in the GUI, one or more selectable elements corresponding to the one or more results, each of the one or more selectable elements associated with a respective one of the plurality of interactive applications; and the method further comprises: in response to selection of a first one of the one or more selectable elements, configure first computer hardware of the distributed computer hardware for execution of a first one of the plurality of interactive applications associated with the first selectable element; and executing the first interactive application using the first computer hardware.

In some embodiments, accessing, from the software application streaming system, the at least some interactive applications comprises accessing code of the at least some interactive applications from a datastore of the software application streaming system. In some embodiments, searching the at least some interactive applications based on the search object indicated by the query comprises identifying text in the code of the at some interactive applications that matches the search object.

Some embodiments provide least one non-transitory computer-readable storage medium storing instructions that, when executed by at least one processor, cause the at least one processor to perform a method for searching for objects among a plurality of interactive applications accessible by multiple devices through a software application streaming system that allocates geographically distributed computer hardware for execution of the plurality of interactive applications. The method comprises: receiving, from a device of the multiple devices through a graphical user interface (GUI) presented on the device, a query indicating a search object; processing the query at least in part by: accessing, from the software application streaming system, at least some of the plurality of interactive applications; and searching the at least some applications based on the search object indicated by the query to obtain one or more results, the one or more results comprising an indication of one or more of the plurality of interactive applications that match the search object indicated by the query; and presenting, in the GUI, the one or more results obtained from processing the query.

Some embodiments provide a software application streaming system for executing a plurality of interactive applications accessible by multiple devices by allocating geographically distributed computer hardware for execution of the plurality of interactive applications. The system comprises: a datastore; at least one processor; and at least one non-transitory computer-readable storage medium storing instructions that, when executed by the at least one processor, cause the at least one processor to execute a plurality of modules of the software application streaming system, the plurality of modules including: an application execution module configured to: execute at least some of the plurality of the interactive applications using computer hardware of the geographically distributed computer hardware; and store, in the datastore, data obtained from previous execution of the at least some interactive applications; a client interface module configured to: provide a navigation GUI to the multiple devices through which the multiple devices can access the plurality of interactive applications, the navigation GUI comprising a map comprising a plurality of graphical elements each associated with a respective one of the plurality of interactive applications; access, from the datastore, data associated with the at least some interactive applications; determine, using the data associated with the at least some interactive applications, visual characteristics of at least some of the plurality of graphical elements; and receive, through the navigation GUI from a first one of the multiple devices, user input selecting a first one of the plurality of graphical elements associated with a first one of the at least some interactive applications; and a computing resource allocation module configured to: after receipt of the user input selecting the first graphical element, allocate first computer hardware of the geographically distributed computer hardware for execution of the first interactive application; wherein the application execution module is configured to use the first computer hardware to execute the first interactive application.

In some embodiments, determining, using the data associated with the at least some interactive applications, the visual characteristics of the at least some graphical elements associated with the at least some interactive applications comprises: setting dimensions of the at least some graphical elements in the GUI using the data associated with the at least some interactive applications.

In some embodiments, setting the sizes of the at least some graphical elements in the GUI using the data associated with the at least some interactive applications comprises: determining a rating of the at least some interactive applications using the data associated with the at least some interactive applications; and setting the dimensions of the at least some graphical elements in the GUI based on the rating.

In some embodiments, the data associated with the at least some interactive applications comprises data indicating numbers of accesses and/or viewers of the at least some interactive applications; and setting the dimensions of the at least some graphical elements using the data associated with the at least some interactive applications comprises setting the dimensions of the at least some graphical elements based on numbers of accesses and/or viewers of the at least some interactive applications. In some embodiments, the at least some interactive applications comprise a first interactive application and a second interactive application; and setting the dimensions of the at least some graphical elements based on numbers of accesses and/or viewers of the at least some interactive applications comprises: setting a first one of the at least some graphical elements associated with the first interactive application to a first size; and setting a second one of the at least some graphical elements associated with the second interactive application to a second size different from the first size.

In some embodiments, the plurality of graphical elements associated with the plurality of interactive applications comprises tiles associated with the plurality of interactive applications. In some embodiments, the client interface module is further configured to dynamically update the visual characteristics of the at least some graphical elements in response to updates to the data associated with the at least some interactive applications. In some embodiments, the data associated with the at least some interactive applications comprises data obtained from execution of the at least some interactive applications.

In some embodiments, the client interface module is further configured to: after receipt of a user selection of a graphical element of the plurality of graphical elements from a device of the multiple devices: provide, to the device, an application GUI displaying content generated from execution of an interactive application associated with the selected graphical element.

In some embodiments, the client interface module is further configured to provide, to a plurality of devices, a viewer GUI associated with a session of the first interactive application. In some embodiments, the viewer GUI comprises: a chat interface through which messages can be transmitted among at least some of the multiple devices. In some embodiments, the viewer GUI further comprises: a collaborative development interface through which users of the plurality of devices can provide input for developing functionality of the first interactive application. In some embodiments, the application execution module is further configured to: receive, through a viewer GUI of a device of the plurality of devices, user input; and affect execution of the session of the first interactive application based on the user input. In some embodiments, the first interactive application is a videogame application and affecting execution of the session of the first interactive application based on the user input comprises modifying an aspect of gameplay within the videogame application in response to the user input.

In some embodiments, receiving the user input comprises receiving the user input prior to initiation of the session of the first interactive application. In some embodiments, receiving the user input comprises receiving the user input during the session of the first interactive application.

Some embodiments provide a method for executing a plurality of interactive applications accessible by multiple devices by allocating geographically distributed computer hardware for execution of the plurality of interactive applications. The method comprises: using at least one processor to perform: executing at least some of the plurality of the interactive applications using computer hardware of the geographically distributed computer hardware; and storing, in a datastore of the software application streaming system, data obtained from previous execution of the at least some interactive applications; providing a navigation GUI to the multiple devices through which the multiple devices can access the plurality of interactive applications, the navigation GUI comprising a map comprising a plurality of graphical elements each associated with a respective one of the plurality of interactive applications; accessing, from the datastore, data associated with the at least some interactive applications; determining, using the data associated with the at least some interactive applications, visual characteristics of at least some of the plurality of graphical elements; and receiving, through the navigation GUI from a first one of the multiple devices, user input selecting a first one of the plurality of graphical elements associated with a first one of the at least some interactive applications; and after receipt of the user input selecting the first graphical element, allocating first computer hardware of the geographically distributed computer hardware for execution of the first interactive application; and using the first computer hardware to execute the first interactive application.

In some embodiments, determining, using the data associated with the at least some interactive applications, the visual characteristics of the at least some graphical elements associated with the at least some interactive applications comprises: setting dimensions of the at least some graphical elements in the GUI using the data associated with the at least some interactive applications. In some embodiments, the method further comprises: providing, to a plurality of devices, a viewer GUI associated with the first interactive application; receiving, through a viewer GUI of a device of the plurality of devices, user input; and affecting execution of the first interactive application in a session based on the user input.

Some embodiments provide least one non-transitory computer-readable storage medium storing instructions that, when executed by at least one processor, cause the at least one processor to perform a method for executing a plurality of interactive applications accessible by multiple devices by allocating geographically distributed computer hardware for execution of the plurality of interactive applications. The method comprises: executing at least some of the plurality of the interactive applications using computer hardware of the geographically distributed computer hardware; and storing, in a datastore of the software application streaming system, data obtained from previous execution of the at least some interactive applications; providing a navigation GUI to the multiple devices through which the multiple devices can access the plurality of interactive applications, the navigation GUI comprising a map comprising a plurality of graphical elements each associated with a respective one of the plurality of interactive applications; accessing, from the datastore, data associated with the at least some interactive applications; determining, using the data associated with the at least some interactive applications, visual characteristics of at least some of the plurality of graphical elements; and receiving, through the navigation GUI from a first one of the multiple devices, user input selecting a first one of the plurality of graphical elements associated with a first one of the at least some interactive applications; and after receipt of the user input selecting the first graphical element, allocating first computer hardware of the geographically distributed computer hardware for execution of the first interactive application; and using the first computer hardware to execute the first interactive application.

Some embodiments provide a system for delivering videogame content to a plurality of computing devices in real time. The system comprises: a processor; and a non-transitory computer-readable storage medium storing: a plurality of sets of instructions for executing a respective plurality of video games; and instructions. The instructions, when executed by the processor, cause the processor to: activate, via a communication network on a first computing device of the plurality of computing devices, access to a first video game of the plurality of video games during a first period of time; receive, via the communication network from the first computing device, a request to access a first one of the plurality of sets of instructions for executing the first video game during the first period of time; and transmit, via the communication network to the first computing device, the first set of instructions for executing at least a portion of the first video game in response to the request.

Some embodiments provide a system for accessing an interactive application through a software application streaming system that allocates geographically distributed computer hardware for execution of the interactive application. The system comprises: a display; a network communication interface; and at least one processor configured to: transmit, to the software application streaming system through a communication network using the network communication interface, a request to access the interactive application; establish, using the network communication interface through the communication network, a communication channel with computer hardware of the geographically distributed computer hardware allocated by the software application streaming system for execution of the interactive application; receive, from the computer hardware through the communication network using the network communication interface, data obtained from execution of the interactive application; generate, on the display, a visualization of the data; receive user input from a user of the system; and transmit, to the computer hardware through the communication network using the network communication interface, data indicating the user input for use in execution of the interactive application by the computer hardware. In some embodiments, the display comprises a smart TV.

In some embodiments, the system further comprises a controller communicatively coupled to the display. In some embodiments, the display comprises a smart TV and the controller is communicatively coupled to the smart TV. In some embodiments, the user input is received through the controller. In some embodiments, the controller comprises a touchscreen display. In some embodiments, the controller comprises one or more sensors.

The foregoing summary is non-limiting.

### BRIEF DESCRIPTION OF THE DRAWINGS

Various aspects and embodiments will be described herein with reference to the following figures. It should be appreciated that the figures are not necessarily drawn to scale. Items appearing in multiple figures are indicated by the same or a similar reference number in all the figures in which they appear.

FIG. 1A is an example environment in which some embodiments of the technology described herein may be implemented.

FIG. 1B shows various modules of the software application streaming system of FIG. 1A, according to some embodiments of the technology described herein.

FIG. 1C illustrates execution of the interactive applications by the software application streaming system of FIGS. 1A-1B, according to some embodiments of the technology described herein.

FIG. 1D shows an example user device interacting with the software application streaming system of FIGS. 1A-1C, according to some embodiments of the technology described herein.

FIG. 2A illustrates allocation of computer hardware for execution of sessions of various interactive applications, according to some embodiments of the technology described herein.

FIG. 2B shows additional information about application sessions being executed by computer hardware of FIG. 2A, according to some embodiments of the technology described herein.

FIG. 3A illustrates division of computation capacity of computer hardware at a geographic location, according to some embodiments of the technology described herein.

FIG. 3B illustrates an assignment of computing portions of the processor 300 for execution of different application sessions, according to some embodiments of the technology described herein.

FIG. 4A illustrates components of the virtual network module of a software application streaming system, according to some embodiments of the technology described herein.

FIG. 4B illustrates example transmission of a software object from an application session to another application session, according to some embodiments of the technology described herein.

FIG. 5 illustrates processing of a query by the search module of a software application streaming system, according to some embodiments of the technology described herein.

FIG. 6A illustrates an example navigation GUI that may be presented on a user device by a software application streaming system, according to some embodiments of the technology described herein.

FIG. 6B shows an example viewer GUI that may be presented by a software application streaming system, according to some embodiments of the technology described herein.

FIG. 7 shows an example process of allocating geographically distributed computer hardware for execution of interactive applications, according to some embodiments of the technology described herein.

FIG. 8 is an example process of dynamically allocating geographically distributed computer hardware for execution of a software application, according to some embodiments of the technology described herein.

FIG. 9 is an example process of allocating computer hardware capacity for execution of multiple interactive software applications, according to some embodiments of the technology described herein.

FIG. 10 shows an example process for routing data between interactive applications accessible through a software application streaming system, according to some embodiments of the technology described herein.

FIG. 11 is an example process of processing a search query submitted by a user device to a software application streaming system, according to some embodiments of the technology described herein.

FIG. 12 shows an example process for generating a navigation GUI to navigate applications provided by a software application streaming system, according to some embodiments of the technology described herein.

FIG. 13 is an example process of affecting execution of an interactive software application provided by a software application streaming system based on user input received through a viewer GUI, according to some embodiments of the technology described herein.

FIG. 14 is a block diagram of an example environment in which some embodiments of the technology herein may be implemented.

FIG. 15A is an example process of providing videogame content to devices, according to some embodiments of the technology described herein.

FIG. 15B is an example process of obtaining videogame content by a device, according to some embodiments of the technology described herein.

FIG. 16 is an example graphical user interface (GUI) for logging into a videogame delivery application, according to some embodiments of the technology described herein.

FIG. 17 is an example GUI providing access to streaming videogame content, according to some embodiments of the technology described herein.

FIG. 18A is an example GUI for providing access to a particular videogame, according to some embodiments of the technology described herein.

FIG. 18B is an example GUI of a menu for starting the videogame of FIG. 5A, according to some embodiments of the technology described herein.

FIG. 19A is an example GUI for providing access to a particular videogame, according to some embodiments of the technology described herein.

FIG. 19B is a GUI for gameplay of the videogame of FIG. 6A, according to some embodiments of the technology described herein.

FIG. 20 is an example GUI for accessing a virtual store, according to some embodiments of the technology described herein.

FIG. 21 is an example GUI for accessing a virtual store, according to some embodiments of the technology described herein.

FIG. 22 is an example GUI for providing access to featured videogame content, according to some embodiments of the technology described herein.

FIG. 23 is an example GUI displaying different channels of videogame content, according to some embodiments of the technology described herein.

FIG. 24 shows an example navigation GUI provided by a software application streaming system through which a user can navigate various software applications, according to some embodiments of the technology described herein.

FIG. 25 shows an example GUI showing content streamed to a device from execution of an interactive application by a software application streaming system, according to some embodiments of the technology described herein.

FIG. 26 shows a navigation GUI including a directory interface through which a user may access other interactive interfaces, according to some embodiments of the technology described herein.

FIG. 27 shows a viewer GUI including an interactive interface associated with a session of an interactive application, according to some embodiments of the technology described herein.

FIG. 28 shows a viewer GUI with a menu of additional options associated with a session of an interactive application, according to some embodiments of the technology described herein.

FIG. 29 shows a viewer GUI including an interface through which a user can create a new discussion associated with a session of an interactive application, according to some embodiments of the technology described herein.

FIG. 30 shows a GUI including a chat interface through which a user can communicate with another user, according to some embodiments of the technology described herein.

FIG. 31 is a block diagram of an example computer system, according to some embodiments of the technology described herein.

### DETAILED DESCRIPTION

Described herein is a software application streaming system that provides users with on-demand access to multiple different interactive applications. The software application streaming system uses a geographically distributed network of computer hardware (e.g., computing and storage devices) to execute interactive applications and obtain content from execution thereof. An interactive application may refer to a software application that provides a user the capability to manipulate content of the software application through input. For example, an interactive application may be a videogame application that gives a user control of a character in a virtual world. As another example, an interactive application may be a collaboration software application through which users can virtually interact with each other.

For example, the software application streaming system may provide users with on-demand access to various different videogame applications. The software application streaming system may be implemented as a cloud-based computing system that makes videogame content available to users on demand via the Internet (e.g., using geographically distributed servers of the cloud computing system). The software application streaming system does not require a specialized console for gameplay. For example, the software application streaming system may stream videogame content through an application on a smart tv, a mobile application (e.g., an ANDROID or IOS application) on a mobile device (e.g., a smartphone, tablet, or other mobile device), or an application on another computing device.

The inventors have recognized that conventional videogame systems are limited in their capability to provide a widespread and easily accessible videogame immersion experience. For example, a virtual world of a particular videogame may be limited to only users who have purchased the videogame and who play the videogame. As another example, a particular videogame may be restricted to a particular videogame console, or otherwise be inaccessible to one or more devices. The inventors have also recognized that conventional online videogame systems do not provide mechanisms through which large numbers of players (e.g., thousands, or millions) can efficiently access multiple different online videogame applications during a given period of time. Conventional online videogame systems typically provide multiple users access to a single videogame application, and do not contemplate simultaneous execution of multiple different videogames.

Accordingly, the inventors have developed a software application streaming system (e.g., a videogame application streaming system) that provides a widely accessible universe of multiple interactive applications (e.g., videogame applications). The software application streaming system provides access to different interactive applications from different providers without a limitation of specialized hardware (e.g., a console or particular type of device). For example, the software application streaming system may deliver content through an application that can be installed on a smart tv, a mobile application, and/or an application on another computing device. The software application streaming system provides a single navigation graphical user interface (GUI) through which users can access various different interactive applications. The software application streaming system may allow users to access the interactive applications on-demand. The software application streaming system manages allocation of geographically distributed computer hardware for simultaneous execution of multiple interactive applications.

One challenge in cloud-based execution of interactive applications is latency. The time required for data to travel between a user device and a computing device executing an interactive application (e.g., a videogame server executing a videogame application) has a significant effect on a user's interaction with the application. A large latency may negatively impact a user's experience by causing delays in reaction of the application to user input (e.g., lag in a videogame environment). For example, an interactive application may be a videogame application that provides a virtual world for a user in which the user controls a character. The videogame application may need to provide near real time reaction to user inputs (e.g., to render actions in response to user input). Latency may cause delays in a reaction rendered in the videogame application.

Accordingly, some embodiments provide a software application streaming system that allocates geographically distributed computer hardware to mitigate latency between user devices and computer hardware executing interactive applications. The system receives requests from multiple user devices to access multiple interactive applications. The system allocates geographically distributed computer hardware for execution of the multiple interactive applications. The system allocates the geographically distributed computer hardware by: (1) determining an indication of the geographic locations of the user devices; and (2) identifying, using the indication of the geographic locations of the device, computer hardware for execution of each of the interactive applications. The system then configures computer hardware identified for each interactive application for execution thereof. For a given interactive application, the system executes the application using its respective configured computer hardware and streams, through a communication network (e.g., the Internet) content (e.g., video and/or audio data) obtained from the execution to a user device. The system further receives user input from the user device and uses it in execution of the interactive application (e.g., to control content in response to user input).

Another factor that may affect latency in an interactive application is computing capacity available for execution of the interactive application. For example, one videogame application may require a minimum amount of graphical processing capacity in order to execute the videogame application without user perceivable delays in reaction to user input. Further, certain interactive applications may require more processing capacity than other interactive applications.

Accordingly, some embodiments provide a software application streaming system for executing multiple interactive applications using geographically distributed computer hardware by customizing an amount of computing capacity for each interactive application. The system allocates geographically distributed computer hardware for execution of a given interactive application by identifying computer hardware to execute the interactive application and configuring the identified computer hardware for execution of the interactive application. The system may configure the identified computer hardware for execution by: (1) dividing computing capacity (e.g., processing and/or memory) of the computer hardware into multiple portions; and (2) assigning one or more portions for execution of the interactive application. The system may execute the interactive application using its assigned computing portion(s). As an illustrative example, the system may divide processing capacity of a graphics processing unit (GPU) of computer hardware into multiple units and assign one or more of the units for execution of a videogame application (e.g., to ensure that there are sufficient unit(s) to execute the videogame application without perceivable delays in user experience). The system may then execute the videogame application using the assigned unit(s) of the GPU.

The inventors have further appreciated that users may wish to share objects among various interactive applications. For example, a user may wish to transmit a virtual object from one videogame application to a different videogame application. As another example, users of two different videogame application may wish to exchange objects between virtual worlds of their respective videogame applications.

Accordingly, some embodiments provide a software application streaming system for executing multiple different interactive applications that creates a virtual network among the interactive applications through which the interactive applications can exchange data (e.g., software objects with other interactive applications). The system may allocate different computer hardware for each of multiple different interactive applications. The system may route data between different interactive applications by: (1) obtaining, through the virtual network from one application, data obtained from execution of the application; and (2) transmit, through the virtual network, the data to another application. In various cases, the applications may be executing on different sets of computer hardware (e.g., located at different locations). The system may use the transmitted data in execution of the recipient application. As an illustrative example, the system may transmit, through the virtual network, a virtual object from a virtual world of one videogame application to a virtual world of another videogame application. The virtual object may then be used in the virtual world of the other videogame application.

The inventors have further recognized that, when given a universe of different interactive applications, users may wish to access specific content. However, it may be difficult for a user to know which interactive applications would include a desired type of content. For example, a user may wish to access a videogame application with specific characteristics of a virtual world of the videogame application (e.g., landscape, character capability, mode of transportation, set of actions available to a character, virtual objects available in the virtual world, time period of the virtual world, language(s) in the virtual world, genre of the virtual world, and/or other characteristics).

Accordingly, some embodiments provide a software streaming system for executing multiple interactive applications using geographically distributed computer hardware that allows users to search for software objects among the interactive applications. The system may receive, from a user device accessing the software streaming system, a query indicating a search object to identify in the interactive applications. The system may process the query by searching the interactive applications based on the search object to obtain one or more search results. The search result(s) may be an indication of one or more of the interactive applications that match the search object indicated in the query. In some embodiments, the system may parse software code of the interactive applications to perform the search. The system may present the search result(s) in a GUI displayed by the user device. As an illustrative example, the system may receive a query indicating a virtual object. The system may search multiple different videogame applications to identify one or more videogame applications that include the virtual object. The system may present, in a GUI displayed by the user device, an indication of the identified videogame application(s) (e.g., that provide access to the videogame application(s)).

The inventors have further recognized that a software streaming system that provides a universe of multiple different interactive applications may need a specially configured GUI that allows users to navigate the interactive applications. Furthermore, various users may wish to interact with other users through the software streaming system. For example, users may wish to view other users playing a videogame application, communicate with each other regarding an interactive application, and/or collaborate with one another to affect execution of an interactive application.

Accordingly, the inventors have developed a software application streaming system for executing multiple interactive applications that provides user devices with various different GUIs through which users can access interactive applications and interact with each other. Some embodiments provide a navigation GUI that provides graphical elements representing respective interactive applications that can be used to access the interactive applications. The graphical elements may have dynamic visual characteristics that are updated responsive to data associated with their corresponding interactive applications. For example, the graphical elements may be modified in the navigation GUI based on number of accesses, number of viewers, novelty of the interactive application, and/or other data. In some embodiments, the software application streaming system may provide a viewer GUI through which users can view execution of an interactive application being accessed by another user. For example, the viewer GUI may allow users to view a video feed of one or more other users interacting with a videogame application. The viewer GUI may provide a communication interface (e.g., a chat interface) through which viewers can communicate with one another (e.g., by exchanging messages). In some embodiments, the software application streaming system may provide a collaborative development interface through which users can provide input for developing functionality of an interactive application. The collaborative development interface may allow users to provide input that affects execution of an interactive application (e.g., by adding and/or modifying functionality).

The inventors have further recognized that streaming multiple different interactive applications simultaneously may require managing load on geographically distributed computer hardware over time. Accordingly, a software application streaming system may need to manage access and delivery of content to ensure that the computer hardware has the capacity to execute the interactive applications that are available to users.

Accordingly, some embodiments provide a software application streaming system that delivers interactive application content for different interactive applications episodically over a period of time. The software application streaming system may provide access to interactive applications (e.g., videogame applications) in designated periods of time. For example, during a regular period of time (e.g., daily, weekly, monthly, or other suitable frequency), users may access and play a particular interactive application. Accordingly, in the period of time many users (e.g., thousands, millions) may contemporaneously enter a virtual world provided by the interactive application. The software application streaming system may further provide access to interactive applications in time-limited segments. For example, each episode may be 5 minutes, 10 minutes, 15 minutes, 30 minutes, 1 hour, 1.5 hours, 2 hours, or 3 hours. In another example, an interactive application episode may be any amount of time between 1 minute to 240 minutes. Users may thus enjoy a particular interactive application episodically over time similar to a show.

Some embodiments may be described herein using videogame applications as example interactive applications. Some embodiments are not limited to interactive applications that are videogame applications. For example, some embodiments may be configured for interactive applications such as interactive training applications, conferencing applications, collaborative software development applications, virtual reality (VR) applications, augmented reality (AR) applications, virtual simulation applications, and/or other types of interactive applications.

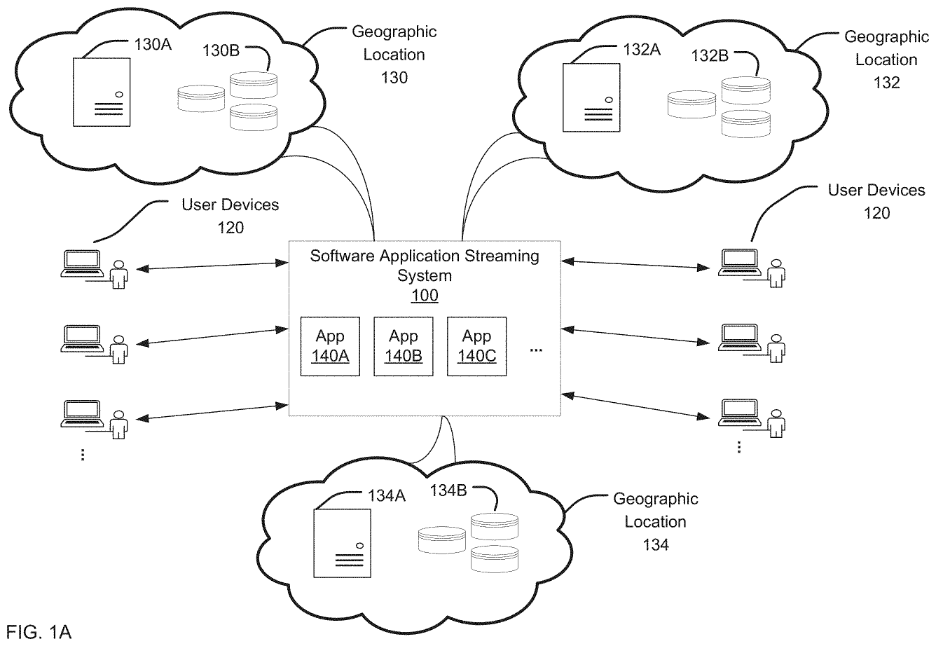

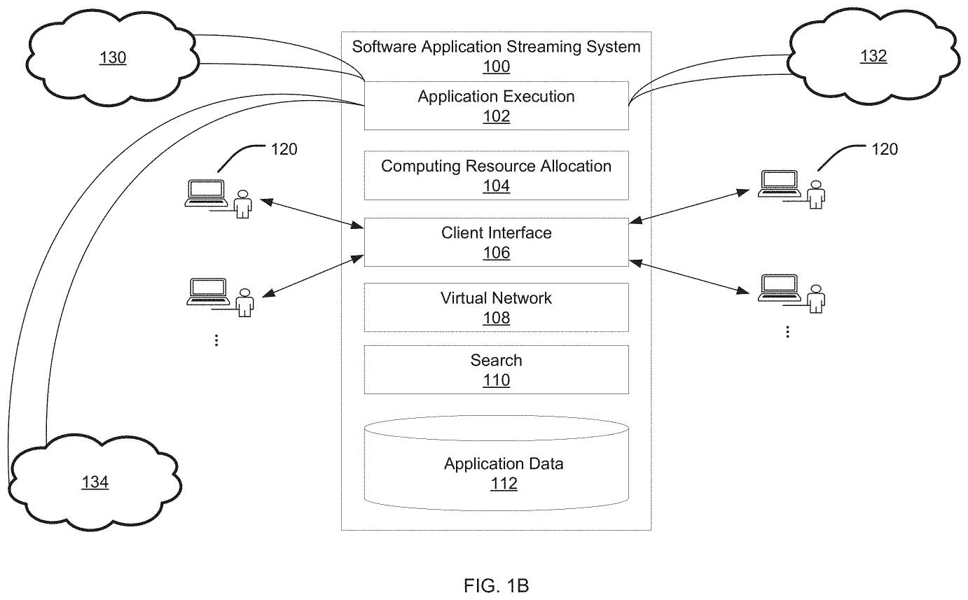

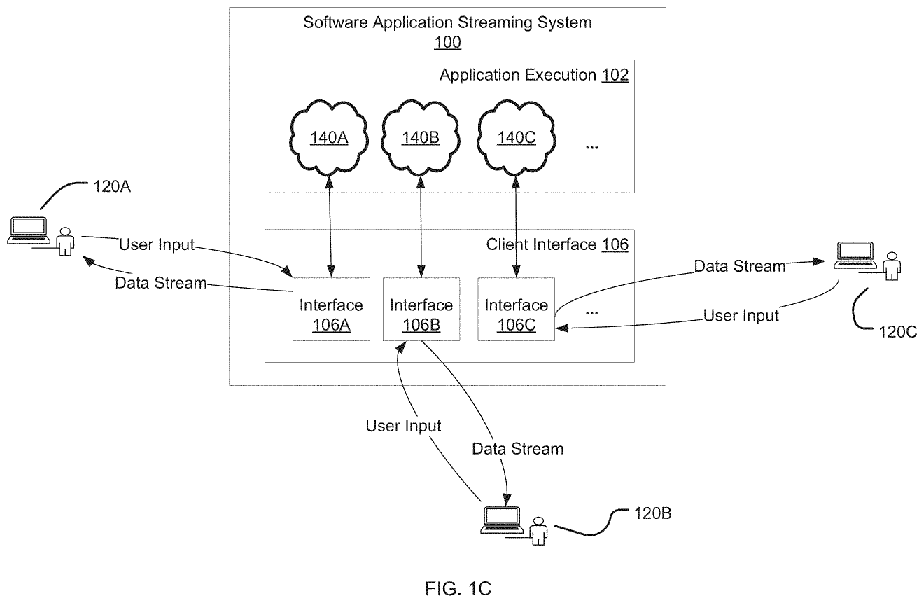

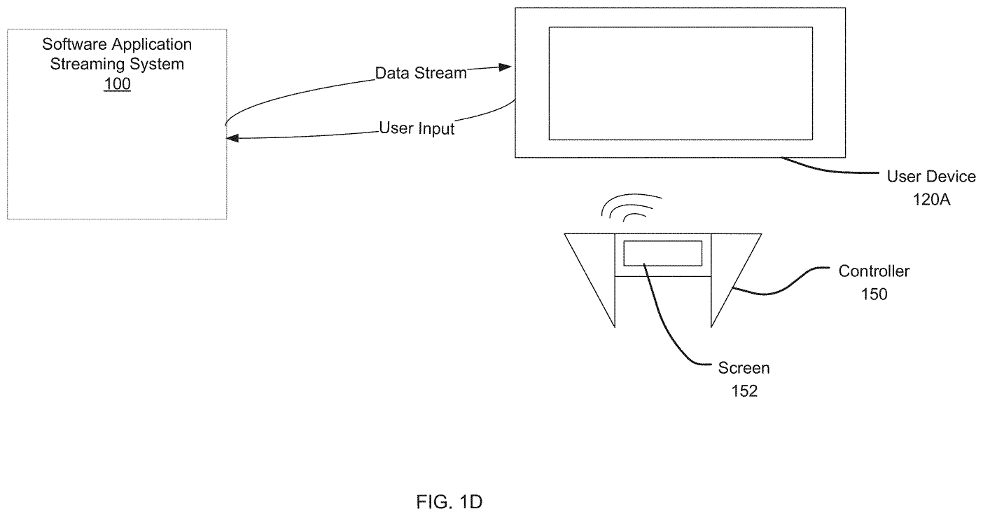

FIG. 1A is an example environment in which some embodiments of the technology described herein may be implemented. As shown in FIG. 1A, the environment includes a software application streaming system 100 (also referred to herein as “the system 100”) in communication with multiple user devices 120. The system 100 provides the user devices 120 access to multiple different interactive applications. The system 100 uses geographically distributed computer hardware to execute the interactive applications. The software application streaming system 100 may transmit a stream of content (e.g., video and/or audio data) obtained from execution of the interactive applications to user devices that are accessing the interactive applications. The software application streaming system 100 further receives input from the user devices which the system 100 may use in execution of the interactive applications (e.g., to control content rendered in the interactive applications).

As shown in FIG. 1A, in some embodiments, the software application streaming system 100 may use computer hardware that is distributed across multiple geographic locations in order to execute applications. For example, the software application streaming system 100 may comprise a cloud-based computer system with distributed computing devices (e.g., servers) and storage (e.g., datacenters). The system 100 may allocate computer hardware for execution of software applications. In the example of FIG. 1A, the system 100 may use computer hardware at geographic locations 130, 132, 134. To illustrate, the geographic location 130 may be located in a northeast region of the United States of America, the geographic location 132 may be located in a northwest region of the United States of America, and the geographic location 134 may be located in South Africa.

It should be appreciated that the system 100 is not limited to a number of geographic locations or specific geographic locations discussed herein. Example numbers of geographic locations and example geographic locations are provided for illustrative purposes. Some embodiments may use computer hardware in any number of suitable geographic locations. Some embodiments may be configured to use computer hardware in any suitable geographic location. In some embodiments, the geographic locations in which computer hardware used by the system is available may be expanded and/or updated (e.g., based on demand).

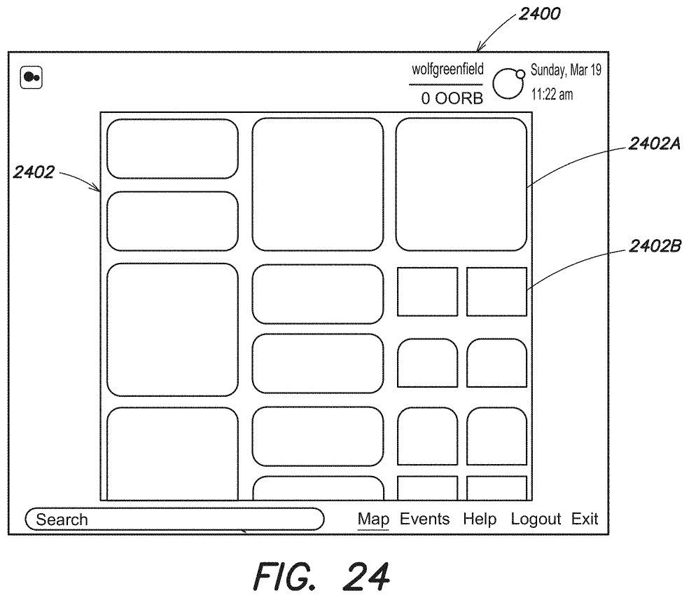

As shown in FIG. 1A, each of the geographic locations 130, 132, 134 has respective computer hardware. The geographic location 130 has a server 130A and storage devices 130B, the geographic location 132 has server 132A and storage devices 132B, and the geographic location 134 has server 134A and storage devices 134B. Although the example of FIG. 1A illustrates servers at each geographic location, some embodiments may use one or more computing devices in addition or instead of a server. Some embodiments may be configured to use any type of computer hardware in a given geographic location. Example computer hardware that may be available at a given geographic location is described herein with reference to FIG. 24.

In some embodiments, the software application streaming system 100 may be interconnected with the computer hardware at geographic locations 130, 132, 134. In some embodiments, the system 100 may be communicatively coupled to the computer hardware at the geographic locations 130, 132, 134 through a private wide area network (WAN). In some embodiments, the system 100 may be communicatively coupled to the computer hardware at the geographic locations 130, 132, 134 through a virtual private network (VPN). In some embodiments, the system 100 may be communicative coupled to the computer hardware at the geographic locations 130, 132, 134 through a virtual private cloud (VPC).

In some embodiments, the software application streaming system 100 operates as a single entity. The system 100 provides control and monitoring of computing resources. Accordingly, the system 100 does not require multiple datastores or synchronization between the datastores. In some embodiments, the system 100 has access to operational status and utilization of all computer hardware available to the system 100. The system 100 may use the information to efficiently allocate resources for execution of the applications.

In some embodiments, the software application streaming system 100 may allocate the geographically distributed computer hardware for execution of the applications 140A, 140B, 140C. The system 100 may configure computer hardware at different locations for different sessions of each application. For example, the system 100 may configure computer hardware at geographic location 130 for execution of one session of the application 140A and configure computer hardware at geographic location 132 for execution of another session of the application 140A. The system 100 may configure computer hardware at a single geographic location to execute multiple sessions of an application and/or sessions of multiple different applications. For example, the system 100 may configure the computer hardware at geographic location 130 to execute multiple sessions of application 140A (e.g., for different users). As another example, the system 100 may configure the computer hardware at geographic location 130 to simultaneously execute one or more sessions of application 140A, and one or more sessions of application 140B.

In some embodiments, the software application streaming system 100 may allocate geographically distributed computer hardware for execution of interactive applications based on locations of user devices. When the system 100 receives a request from a user device to access an interactive application, the system 100 may: (1) determine an indication of a geographic location of the user device; and (2) identify computer hardware of a particular location to use in execution of the interactive application. In some embodiments, the system may determine ping times of the user device to computer hardware at the geographic locations 130, 132, 134 as the indication of the geographic location of the user device. For example, the system may determine a ping time between the user device computer hardware of each of geographic locations 130, 132, 134. In this example, the system may select computer hardware of one of the geographic locations 130, 132, 134 to use for execution of the interactive application. In some embodiments, the system may use global positioning system (GPS) coordinates of the user device as the indication of the user device's location. The system may use the coordinates to select computer hardware of one of the geographic locations 130, 132, 134 to use for execution of the interactive application.

In some embodiments, the software application streaming system 100 may select computer hardware to execute an interactive application to minimize latency between a user device and the computer hardware. In some embodiments, the system 100 may select available computer hardware that has the lowest latency. For example, the system 100 may select available computer hardware that has the lowest ping time between the user device and the computer hardware. In some embodiments, the system 100 may select available hardware that the system determines is the closest distance. For example, the system may determine a distance between GPS coordinates of the user device and GPS coordinates of each of the geographic locations 130, 132, 134. The system may select computer hardware of the geographic location with the shortest distance to execute the interactive application.

In some embodiments, the software application streaming system may provide users with a single digital identity across all the interactive applications. For example, points collected in one videogame application may be used in another videogame application provided by the system. As another example, a user's avatar in one interactive application may be used in other interactive applications provided by the system. In some embodiments, the software application streaming system may provide universal software objects that can be shared among multiple interactive applications provided by the system (e.g., through a virtual network provided by the system). The software application streaming system may route software objects (e.g., virtual objects) to different interactive applications.

As shown in FIG. 1A, the software application streaming system 100 provides multiple different interactive applications 140A, 140B, 140C. The system 100 may provide any number of interactive applications. In some embodiments, an interactive application may be a videogame application. The videogame application may provide a virtual gaming environment in which a user is provided control. For example, the videogame application may be a real-time strategy (RTS) game, a shooter videogame (e.g., a third-person shooter or a first-person shooter videogame), a multiplayer online battle arena, a role-playing game, a simulation videogame (e.g., a sports simulation videogame), a puzzle game, and/or an action-adventure game. As another example, the videogame application may be a sandbox application in which user(s) are allowed to develop a virtual environment. In some embodiments, an interactive application may be an application that allows for real time collaboration between multiple users. For example, the interactive application may be a virtual training application in which users participate in a virtual training session together. It should be appreciated that although examples described herein may be discussed with reference to a videogame application, some embodiments are not restricted to video applications. Some embodiments may be configured with any type of interactive application.

In some embodiments, the software application streaming system 100 may store software code for each of the interactive applications 140A, 140B, 140C. To execute a particular interactive application session, the system 100 may access the software code associated with the interactive application and execute the software code (e.g., using processor(s) of computer hardware at a geographic location). The software application system 100 may store user-specific data for each of the interactive applications 140A, 140B, 140C (e.g., virtual identity, progress in the application, customizations in the application, obtained virtual items, and/or other user-specific data). When loading an interactive application for a user, the system 100 may load user-specific data associated with the user into memory of computer hardware being used to execute the interactive application such that the user is presented with a session customized for the user.

In some embodiments, the software application streaming system 100 may have a centralized datastore (e.g., a database) in which to store software application data. The system 100 may store application code, application data, user-specific data, and/or other information associated with the applications 140A, 140B, 140C in the datastore. The system 100 may access the datastore to execute the applications 140A, 140B, 140C (e.g., to load user-specific data into an interactive application). The system 100 may update data in the datastore during execution of the applications. In some embodiments, the datastore may comprise of one or more databases in which the system 100 persists data obtained from execution of the applications 140A, 140B, 140C. The persisted data may be loaded into computer hardware (e.g., memory) when being executed for a user.

In some embodiments, each interactive application 140A, 140B, 140C may be provided by a different provider (e.g., developer). The software application streaming system 100 may allow different applications to be accessed through the system 100. For example, each of the interactive applications 140A, 140B, 140C may be different videogame applications. Each videogame application may have a respective virtual environment. Each video game application may further use its own 3D gaming engine to render content in its virtual environment. The system 100 may provide the capability to access any number of software applications. In some embodiments, the system 100 may be loaded with additional interactive applications over time. For example, newly developed videogame applications may be added to the system 100 (e.g., by adding software code of the videogame applications to the system 100). The system 100 may further remove interactive applications (e.g., due to lack of use).

In some embodiments, the system 100 may provide access to an interactive application using various different types of hardware. For example, an interactive application may be a virtual reality (VR) application that can be accessed by a user device comprising of a VR device (e.g., a VR headset). As another example, an interactive application may be an augmented reality (AR) device that can be accessed by a user device with AR functionality (e.g., AR goggles and/or a mobile device configured with functionality to generate an AR environment). In some embodiments, the system 100 may provide access to an interactive application through various different types of devices. For example, the system 100 may provide access to an interactive application through a desktop computer, a mobile device (e.g., a smartphone, tablet, laptop, smartwatch, or other mobile device), a smart tv, or another device. The system 100 may provide flexibility for an interactive application to be accessed through multiple different types of devices.

In some embodiments, the user devices 120 that access the software application streaming system 100 may be any suitable computing devices. The computing devices may comprise desktops, laptops, smartphones, tablets, wearable devices, AR devices, VR devices, smart televisions (TVs), and/or other suitable computing devices. In some embodiments, the software application streaming system 100 may provide an application through which a user device may access interactive applications provided by the system 100. For example, the system 100 may provide a desktop application, mobile application, web application, smart TV application, or other type of application through which user devices may access interactive applications through the system 100.

In some embodiments, an interactive application may allow multiple users to simultaneously access the interactive application. In some embodiments, the interactive application may provide a distinct session to each of the users. In some embodiments, the interactive application may provide a single virtual environment in which all the multiple users may be present (e.g., a virtual world of a role-playing videogame). In some embodiments, the interactive application may provide a shared session for a set of users. For example, the system 100 may generate a session designated for the set of users that is restricted to access by the set of users.

In some embodiments, the software application streaming system 100 may communicate with user devices 120 through a communication network. In some embodiments, the communication network may be the Internet. The system 100 may configure computer hardware used for executing an application for a user to communicate with a user device through the Internet. The computer hardware may transmit data obtained from execution of the application (e.g., a video and/or audio stream of data) to the user device to provide a visualization. The computer hardware may receive input from the user device for use in execution of the application (e.g., control input in a videogame application).

FIG. 1B shows various modules of the software application streaming system 100 of FIG. 1A, according to some embodiments of the technology described herein. As shown in FIG. 1B, the software application streaming system 100 includes an application execution module 102, a computing resource allocation module 104, a client interface module 106, a virtual network module 108, and a search module 110. The system 100 further includes a datastore 112 storing application data.

The application execution module 102 may execute interactive applications. As shown in FIG. 1B, the application execution module 102 may use computer hardware allocated for respective applications (e.g., by the computing resource allocation module 104) to execute the applications. In some embodiments, the application execution module 102 may execute a session of a given software application using a computer hardware by: (1) loading the application onto the computer hardware; and (2) executing the application using the computer hardware according to an allocation determined by the computing resource allocation module 104. For example, the application execution module 102 may use computing capacity (e.g., processor and/or memory) assigned for the application to execute the application.

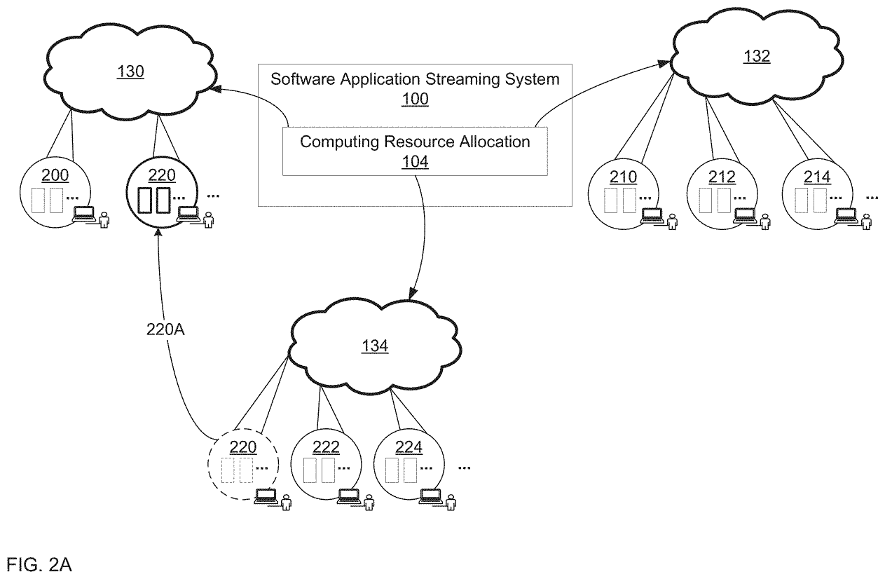

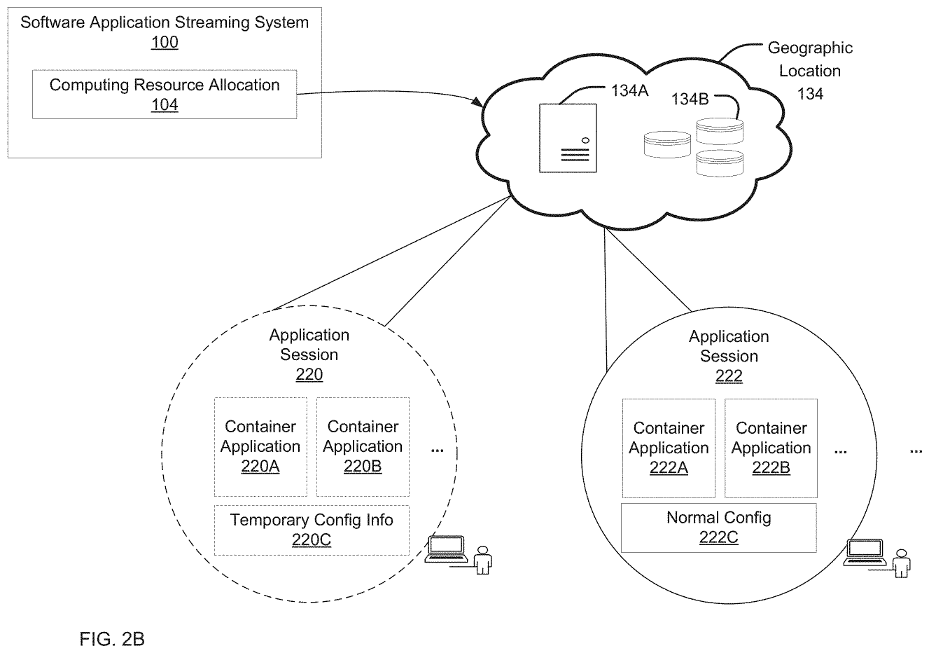

As described herein in detail with reference to FIGS. 2A-2B, in some embodiments, the application execution module 102 may execute an application using allocated computer hardware as a containerized application. The application execution module 102 may use one or more containers to execute the application. The application execution module 102 may execute multiple application sessions on computer hardware using multiple sets of containers. Each set of containers may be executed by the computer hardware using designated computing resources (e.g., processor capacity and/or memory). A containerized application may include the software resources needed for execution of the application. For example, the containerized application may include all the software libraries and dependencies required for execution of the application.

In some embodiments, the application execution module 102 may persist data obtained from execution of an application session (e.g., in the datastore 112). When a user device ends an application session (e.g., due to user command and/or idle time), the application execution module 102 may persist the application data. The application execution module 102 may use the application data in a subsequent session of the application for a user. Accordingly, the application execution module 102 may allow a user to pause and resume an interactive application as desired by the user.

In some embodiments, the computing resource allocation module 104 may allocate geographically distributed computer hardware (e.g., at locations 130, 132, 134) for execution of interactive applications. In response to a request from a user device to access an interactive application, the computing resource allocation module 104 may identify computer hardware to use in execution of the interactive application. In some embodiments, the computing resource allocation module 104 may allocate computer hardware based on geographic location of the user device (e.g., to minimize latency). The computing resource allocation module 104 may: (1) determine an indication of the geographic location of the user device (e.g., ping times to various devices, distances, and/or another indication of the geographic location); (2) identify, using the indication of the geographic location of the user device, computer hardware at one of the geographic locations 130, 132, 134 for use in executing the application; and (3) configure the identified computer hardware. For example, the compute resource allocation module 102 may select the computer hardware at a geographic location that would minimize communication latency among all the available computer hardware.

In some embodiments, the computing resource allocation module 104 may configure computer hardware identified for execution of an interactive application. The computing resource allocation module 104 may configure the computer hardware by loading the interactive application on the computer hardware. For example, the computing resource allocation module 104 may load a compilation of the application into memory of the computer hardware. In some embodiments, the computing resource allocation module 104 may load an application as a containerized application. The computing resource allocation module 104 may load the application as a containerized application by configuring a set of one or more container applications for execution. The set of container application(s) may operate together for execution of the interactive application.

In some embodiments, the computing resource allocation module 104 may dynamically update computer hardware allocations. The computing resource allocation module 104 may monitor availability of resources to maximize efficiency of communication between computer hardware and user devices. In some embodiments, the computing resource allocation module 104 may update computer hardware allocation to reduce latency. The computing resource allocation module 104 may initially allocate first computer hardware at geographic location 130 for execution of a software application. The computing resource allocation module 104 may subsequently determine that second computer hardware at geographic location 132 has freed capacity (e.g., due to ending of one or more other application sessions) for execution of the application, and that the second computer hardware at geographic location 132 would have lower latency with the lower device. The computing resource allocation module 104 may update the allocation and configure the second computer hardware to execute the application instead of the first computer hardware.

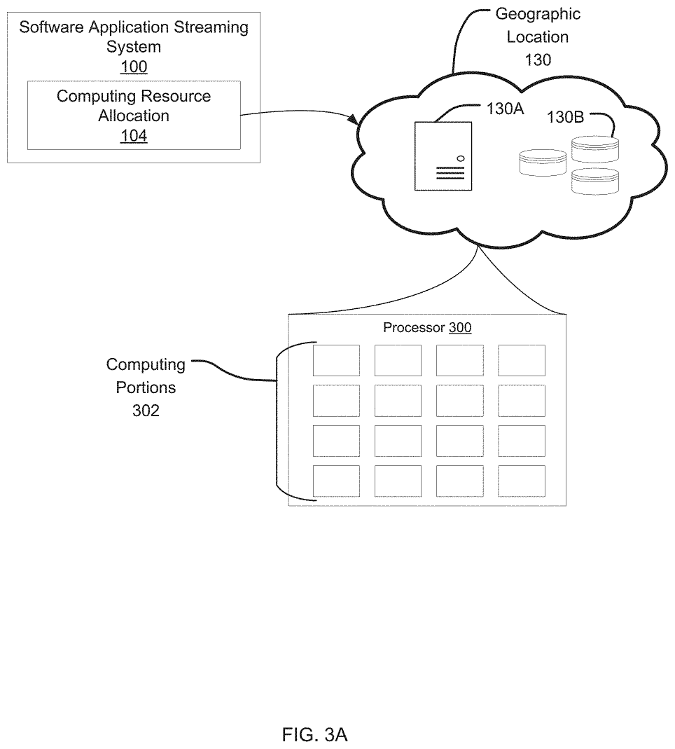

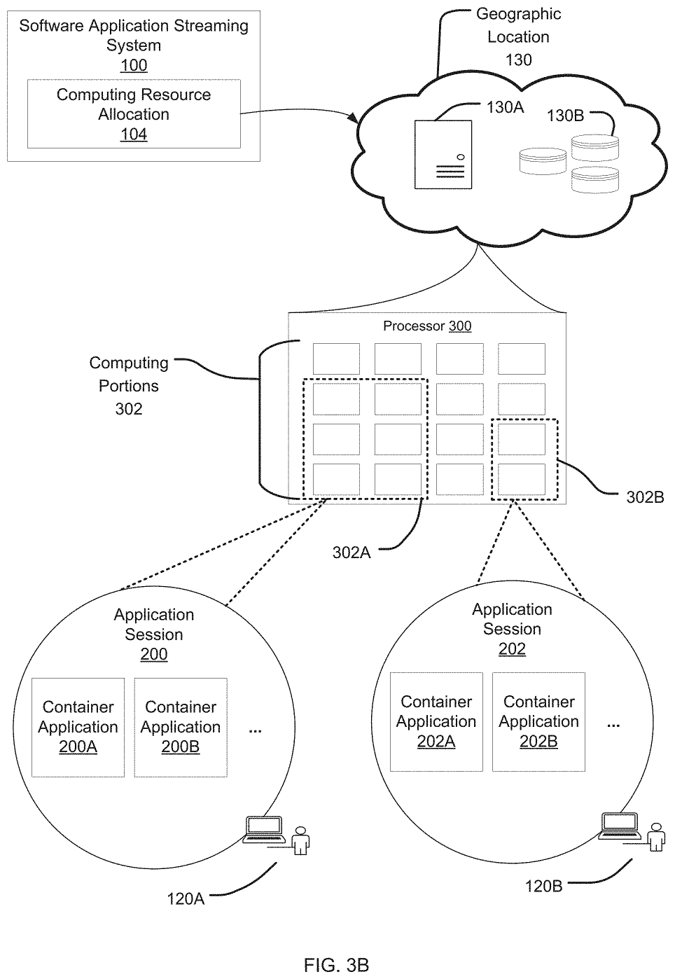

In some embodiments, as described in further detail with reference to FIGS. 3A-3B, the computing resource allocation module 104 may divide processing capacity of computer hardware into multiple portions (e.g., units). The computing resource allocation module 104 may then assign portions for execution of applications. The computing resource allocation module 104 may determine the number and size of portions assigned to a particular application session based on hardware requirements of the application. For example, the computing resource allocation module 104 may assign a first videogame application session more units of a GPU than a second videogame application because the first videogame application may require more resource intensive graphical processing.

In some embodiments, the computing resource allocation module 104 may configure computer hardware as a backup for execution of an application being executed by other computer hardware. For example, the computing resource allocation module 104 may designate computer hardware at a location as backup. The backup computer hardware may be a hot replica of the computer hardware executing the application. In some embodiments, the hot replica may be loaded into a memory cache that can be accessed in the case that the primary computer hardware has a fault. The computing resource allocation module 104 thus provides fault tolerance in application execution.

In some embodiments, the client interface module 106 may provide an interface with the user device 120. The client interface module 106 may communicate with the user devices 120 to stream application data (e.g., a video and/or audio data stream). The client interface module 106 may further receive user input from the user devices 120 for use in execution of interactive applications.

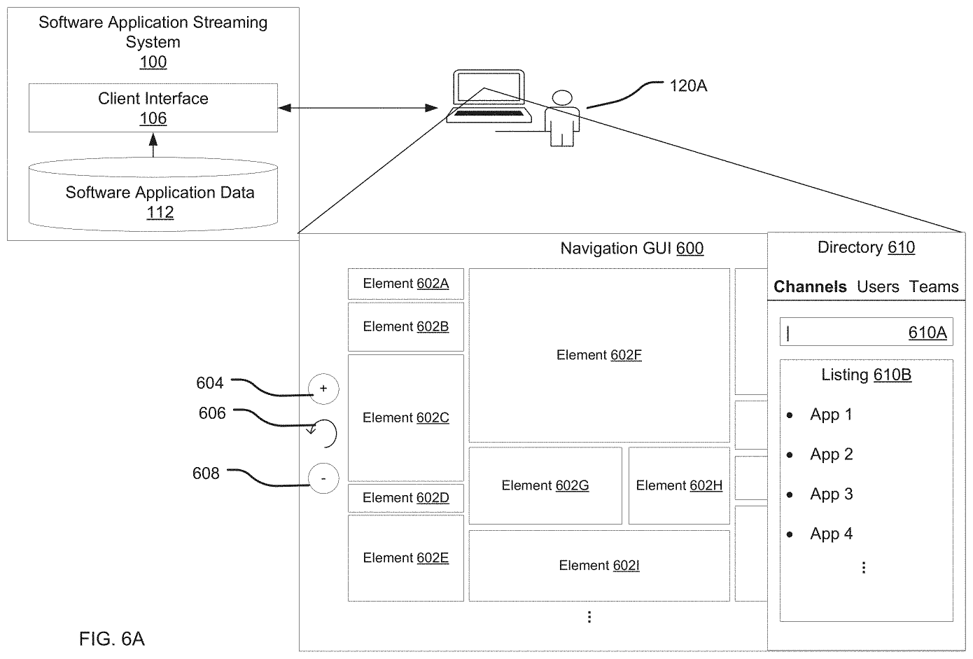

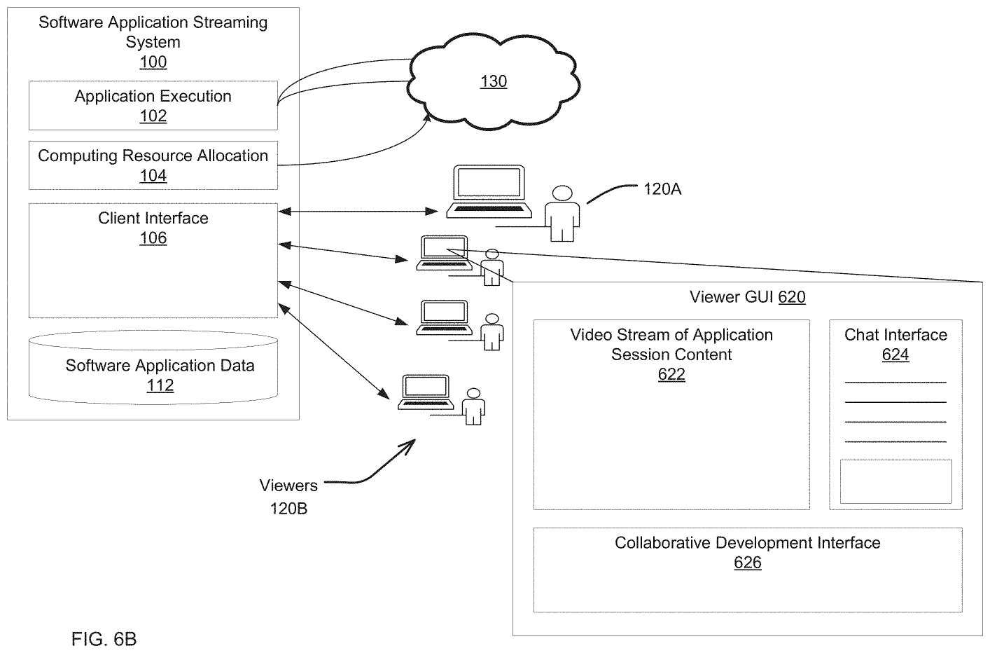

In some embodiments, the client interface module 106 may provide various GUIs through which content is provided to the user devices 120 and through which user input is received by the system 100. For example, the client interface module 106 may provide a navigation GUI through which users may navigate the multiple interactive applications provided by the system 100. The client interface module 106 may further provide a GUI through which users interact with a particular interactive application (e.g., a GUI displaying a video data stream). As another example, the client interface module 106 may provide a viewer GUI through which users can view another user's use of an interactive application (e.g., through which users can view a user playing a videogame), and interact with each other (e.g., my sharing messages). As another example, the client interface module 106 may provide a collaborative interface through which multiple users can develop and/or modify an interactive application. Example GUIs are described herein with reference to FIGS. 6A-6B.

In some embodiments, the virtual network module 108 may provide a virtual network among the various interactive applications provided by the system 100. The virtual network module 108 may generate a virtual network through which data can be routed between different interactive applications. In some embodiments, the virtual network module 108 may route software objects between different interactive applications. The virtual network module 108 may transform a software object from one interactive application to a software object that can be used in execution of another interactive application.

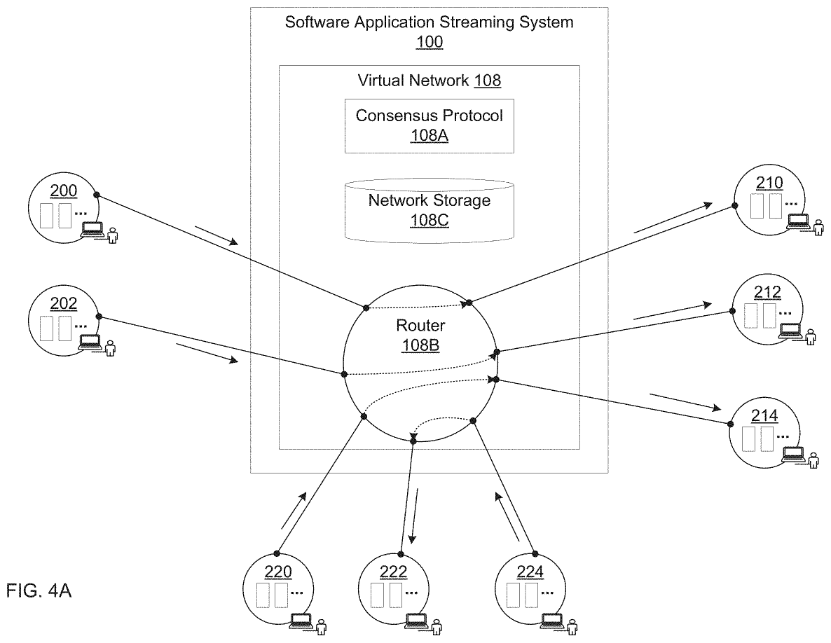

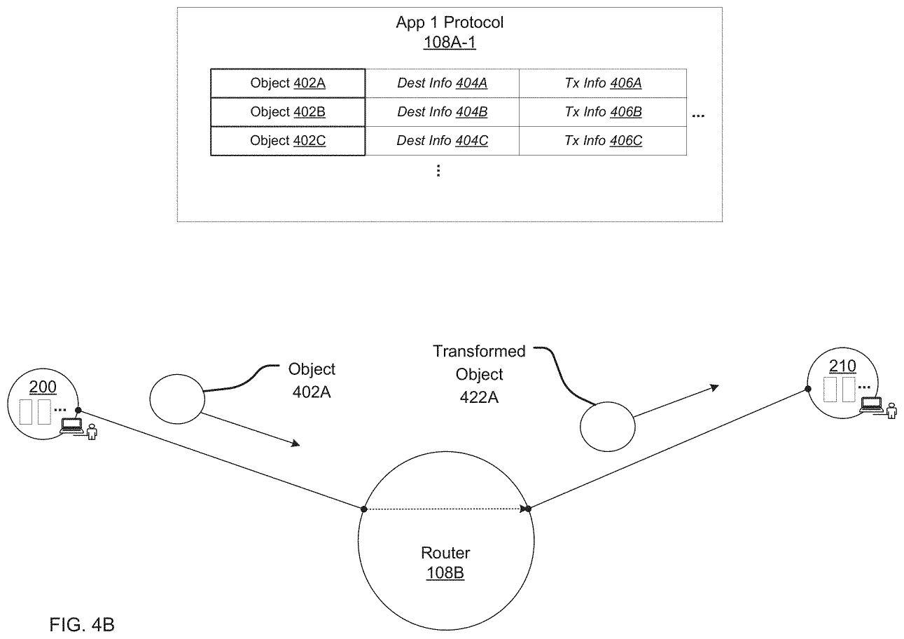

In some embodiments, the virtual network module 108 may provide the capability to have shared software objects that can be used in multiple interactive applications. As an illustrative example, the virtual network module 108 may allow a virtual object in one videogame application's virtual world to be incorporated and used in virtual worlds of other videogame applications. As another example, a form of currency in one videogame application may be transformed into a form of currency in another videogame application. The virtual network module 108 thus allows a software object to be a universal object accessible to users in multiple different interactive applications. The virtual network module 108 is described in more detail herein with reference to FIGS. 4A-4B.

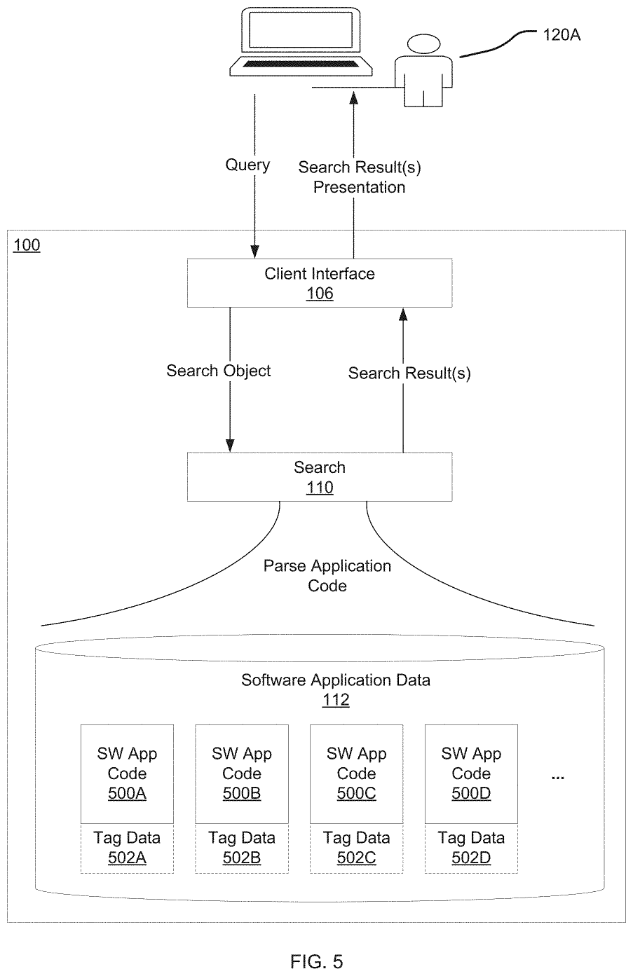

In some embodiments, the search module 110 may search for software objects among the interactive applications provided by the system 100. The search module 110 may receive a query (e.g., through the client interface module 106) from a user device. The search query may indicate a search object. For example, the search object may be text indicating a particular application object a user is searching for. For example, the application object may be a virtual object, virtual environment, virtual character, genre, and/or another object that the user is searching for. The search module 110 may analyze code of the interactive applications to identify search results for the query. The search results may comprise indications of interactive applications and/or objects therein that match the search object (e.g., that the search module 110 determines are likely to include the search object). Example operation of the search module 110 is described herein with reference to FIG. 5.

In some embodiments, the datastore 112 may comprise of storage hardware (e.g., hard drives and/or servers for data access operations). The system 100 may store application data in the datastore 112. In some embodiments, the system 100 may store data obtained from execution of the applications in the datastore 112. In some embodiments, the system 100 may store metadata about the applications in the datastore. For example, the system 100 may store statistics about use of an interactive application in the datastore 112. In some embodiments, the system 100 may store user-specific data in the datastore 112. For example, the system 100 may store profile data, user identifiers, and/or user-specific application data in the datastore 112.

In some embodiments, the datastore 112 may be configured as a single database. The system 100 may centrally store the application data. The system 100 may thus access the application data from the database. By using a single database, the system 100 may not need to synchronize multiple different databases. This may allow the system 100 to store data more efficiently for the multiple different applications. Further, the system 100 may use data in multiple different interactive applications. For example, user preferences in one application may be used to configure another application according to the user's preferences.

In some embodiments, the datastore 112 may store state information for each application session. The system 100 may initiate a record associated with a respective session (e.g., in response to a request to execute an application received from a user device). The system 100 may store, in the record, information about execution of the application session. For example, the record may store information about current network connectivity between a user device and computer hardware executing the application session, capacity of the computer hardware executing the application session, and/or other information. The information may be used by the computing resource allocation module 106 to manage allocation of computer hardware for execution of applications (e.g., by updating allocation in response to end of a session and/or detection of a fault).

FIG. 1C illustrates execution of the interactive applications 140A, 140B, 140C by the software application streaming system 100, according to some embodiments of the technology described herein. In some embodiments, the system 100 may be simultaneously executing sessions of the applications 140A, 140B, 140C. In some embodiments, the system 100 may be executing sessions of the applications 140A, 140B, 140C during different time periods.

In the example of FIG. 1C, the applications 140A, 140B, 140C are requested for access by respective devices 120A, 120B, 120C. The client interface module 106 may have received requests to access the applications 140A, 140B, 140C through interfaces 106A, 106B, 106C provided to the devices 120A, 120B, 120C. For example, the client interface module 106 may have received requests to access the applications 140A, 140B, 140C through GUIs displayed by the devices 120A, 120B, 120C. The computing resource allocation module 104 may have allocated respective computer hardware in response to each request (e.g., by identifying computer hardware for execution of each application based on geographic locations of the devices 120A, 120B, 120C).

The application execution module 102 may execute each of the applications 140A, 140B, 140C using computer hardware at various locations configured by the computing resource allocation module 104. For example, application 140A may be executed using computer hardware at geographic location 130, application 140B may be executed using computer hardware at geographic location 132, and application 140C may be executed using computer hardware at geographic location 134. As another example, multiple ones of the applications 140A, 140B, 140C may be executed at the geographic location 130 (e.g., using portions of processing capacity assigned for the respective applications).

As shown in FIG. 1C, the client interface module 106 may execute an interface with each of the user devices 120A, 120B, 120C. The client interface module 106 is executing an interface 106A through which the client interface module 106 is exchanging data with the device 120A, an interface 106B through which the client interface 106 is exchanging data with the device 120B, and an interface 106C through which the client interface 106 is exchanging data with the device 120C. As shown in FIG. 1C, the client interface module 106 is transmitting a data stream to each of the devices 120A, 120B, 120C. The data stream transmitted to a user device may be a data stream of content obtained from execution of an interactive application. In some embodiments, the data stream may be a video and/or audio stream that is displayed by the user devices 120A, 120B, 120C. The video and/or audio stream data may be generated by the computer hardware executing the applications 140A, 140B, 140C. The client interface module 106 may transmit the data stream through a communication network (e.g., the Internet).

In some embodiments, the client interface module 106 may compress data of the stream. For example, the client interface module 106 may apply video compression to video data being transmitted to the devices 120A, 120B, 120C. This may allow the client interface module 106 to more efficiently transmit data to the devices 120A, 120B, 120C.

As shown in FIG. 1C, the client interface module 106 may receive user input from each of the user devices 120A, 120B, 120C. The user input may be used by the application execution module 102 in execution of the applications 140A, 140B, 140C. For example, the applications 140A, 140B, 140C may be videogame applications. The user input received from each of the devices 120A, 120B, 120C may be control inputs for the videogame applications (e.g., to control a character in the videogame applications). The client interface module 106 may obtain the user input from the devices 120A, 120B, 120C (e.g., through a GUI displayed by the devices), and transmit the user input to the application execution module 102 for use in application execution.

FIG. 1D shows an example user device 120A interacting with the software application streaming system 100, according to some embodiments of the technology described herein. In the example of FIG. 1D, the user device 120A is a TV. In some embodiments, the TV may be a smart TV. The smart TV may communicate with the software application streaming system 100 (e.g., through the Internet). Although the example of FIG. 1D shows a smart TV, it should be appreciated that some embodiments are not restricted to smart TV. Example user devices are described herein. In some embodiments, data may be streamed to the user device 120A display. The data stream may be displayed using a client application installed on the user device 120A (e.g., a smart TV application).

As shown in the example of FIG. 1D, in some embodiments, the user device 120A may be used with a controller 150 in communication with the user device 120A. For example, the controller 150 may be in communication with a smart TV. The controller 150 may be coupled to the smart TV through a wired connection or a wireless connection (e.g., Bluetooth, WiFi, or other wireless connection). The data stream (e.g., video and/or audio data) may be transmitted to the smart TV for display. The user input (e.g., control inputs) may be provided from the controller 150 and transmitted to the software application streaming system 100. In some embodiments, the controller 150 may transmit user input to the software application streaming system 100 (e.g., without transmission through the user device 120A). In some embodiments, the controller 150 may be used to navigate a GUI provided by the software application streaming system 100 (e.g., displayed by the user device 120A).

As shown in the example of FIG. 1D, in some embodiments, the controller 150 may include a screen 152 displaying content (e.g., data stream content). For example, the screen 152 may display video data received from the software application streaming system 100, a GUI provided by the software application streaming system 100, a GUI complementing a GUI displayed by the user device 120A, and/or other content. In some embodiments, the screen 152 may be a touchscreen (e.g., an OLED display) through which a user can provide input and interact with an executing application. In some embodiments, the controller 150 may be used to control content in the interactive application (e.g., to control a character in a videogame application).

In some embodiments, the controller 150 may include one or more sensors. The sensor(s) may include camera(s), infrared (IR) sensor(s), light detection and ranging (LIDAR) sensor(s), touch sensor(s), and/or other sensor(s). The controller 150 may use input from the sensor(s) to allow a user to interact with the controller 150 and/or content of an interactive application being streamed by the software application streaming system 100.

FIG. 2A illustrates allocation of computer hardware for execution of sessions of various interactive applications, according to some embodiments of the technology described herein. As shown in the example of FIG. 2A, in some embodiments, the allocation may be performed by computing resource allocation module 104 of software application streaming system 100 described herein with reference to FIGS. 1A-1C.

In the example of FIG. 2A, the computing resource allocation module 104 is allocating computer hardware of geographic locations 130, 132, 134 for execution of application sessions 200, 202, 210, 212, 214, 220, 222, 224. As shown in FIG. 2A each of the sessions is associated with a user device. In some embodiments, the computing resource allocation module 104 may allocate computer hardware for each of the application sessions in response to a request received from a user device to access an interactive application of multiple interactive applications provided by the system 100. In some instances, each of the sessions 200, 202, 210, 212, 214, 220, 222, 224 may be a session of a different application. In some instances, some of the sessions 200, 202, 210, 212, 214, 220, 222, 224 may be sessions of the same application (e.g., being accessed by different users). For example, some application sessions may be different sessions of a videogame application being accessed by different users. The videogame application may have a single virtual world common to all the users accessing the videogame application.

As illustrated in FIG. 2A, each of the sessions 200, 202, 210, 212, 214, 220, 222, 224 comprises of one or more application containers indicated by the rectangles in each session. A set of application containers may also be referred to as a “container set” or a “pod”. The computing resource allocation module 104 may configure an application session to execute as one or more container sets. Each container set may contain one or more container applications. As an illustrative example, the module 104 may configure computer hardware to execute a 3D engine used by a videogame application as one or more container sets. The containerized 3D engine may be used by multiple application sessions. For example, multiple sessions of the same videogame application may access a pod executing a 3D engine.

In some embodiments, the computing resource allocation module 104 may dynamically swap application sessions among different container sets. The computing resource allocation module 104 may identify target computer hardware at a particular geographic location for execution of an application session (e.g., based on proximity) but determine that the computer hardware has reached its processing capacity (e.g., due to execution of other application sessions). The computing resource allocation module 104 may configure a temporary container set (also referred to as a “swapping pod”) for execution of the application session. The computing resource execution module 104 may assign the temporary container set for execution of the application session until the target computer hardware identified has sufficient capacity to execute the application session. When the computing resource execution module 104 determines that the target computer hardware has sufficient capacity, the computing resource execution module 104 may transfer the application session to a container set executed by the target computer hardware.

For example, application session 220 may initially be configured for execution by a temporary container set as indicated by the dotted lines of the container set. In this example, the computing resource allocation module 104 may have determined that the target computer hardware for execution of the application session 220 is that of geographic location 130. The module 104 may have determined that the computer hardware at the geographic location 130 did not have sufficient capacity to execute the application session 220. The module 104 may thus have configured computer hardware at geographic location 134 to execute the session 220 in a temporary container set. When the module 104 detects that the computer hardware at geographic location 130 has sufficient capacity, the module 104 configures the computer hardware at the geographic location 130 to execute the application session 220 in a container set. As indicated by the arrow 220A, the computing resource allocation module 104 thus transfers execution of the application session 220 to the computer hardware of geographic location 130.

As another example, the system 100 may receive a request from a user device to execute a given interactive application. The computing resource allocation module 104 may determine an indication of location of the user device and that the interactive application has a target latency of 15 ms in network communication between computer hardware executing the interactive application and the user device. The computing resource allocation module 104 may further determine that execution of the interactive application requires ⅙^{th} of the processing capacity of computer hardware (e.g., a node). The computing resource allocation module 104 may determine that the computer hardware at geographic location 130 is closest to the user based on latency between the computer hardware of geographic location 130 and the user device. For example, the computing resource allocation module 104 may determine that there is a latency of 10 ms between the computer hardware of geographic location 130 and the user device. The computing resource allocation module 104 may determine that the computing hardware of geographic location 130 has reached its capacity (e.g., the 116th of the processing capacity of the computer hardware is unavailable). The computing resource allocation module 104 may determine that the computer hardware at geographic location 134 has the next lowest latency (e.g., of 25 ms) to the device, and that the computer hardware has ⅙^{th} of its processing capacity available. The computing resource allocation module 104 may configure the computer hardware at geographic location 134 to temporarily execute the interactive application. The computing resource allocation module 104 may transition execution of the interactive application to computer hardware of geographic location 130 when sufficient processing capacity has freed up on the computer hardware.

In some embodiments, the computing resource allocation module 104 may store configuration information in a temporary set of containers. For example, the computing resource allocation module 104 may store the configuration information in a header associated with the set of containers. In some embodiments, the configuration information may include an indication of geographic location (e.g., region identifier, GPS coordinates, and/or other indication), a timestamp associated with the request to access the application, a processing capacity (e.g., compute size) needed for the application session, an indication of importance of latency, and a user identifier. In some embodiments, the processing capacity may store the configuration information when the temporary set of containers is generated. When the computing resource allocation module 104 determines that the target computer hardware has availability to execute the application session, the computing resource execution module 104 may remove the temporary configuration information from the container set executed by the target computer hardware. For example, the computing resource allocation module 104 may remove a header storing the information. The computing resource allocation module 104 may further store an indication in the container set executed by the target computer hardware indicating that the container set is not a temporary container set (e.g., by storing a variable value indicating the container set as non-temporary or normal).

In some embodiments, the computing resource configuration module 104 may pause execution of an application in a container set and allow computing capacity used for the container set to be assigned for execution of another application session. In some embodiments, the computing resource configuration module 104 may detect that a user has idled for a threshold period of time and/or that the user has disconnected from a first application session. In this scenario. The computing resource configuration module 104 may store data from the first session in memory (e.g., in a temporary cache). The computing resource configuration module 104 may thus free up the processing capacity for execution of a second application session in another container set. The computing resource configuration module 104 may determine when a user of the first session has resumed activity and/or reconnected. When the computing resource configuration module 104 determines that the user of the first session has resumed activity and/or reconnected, the computing resource configuration module 104 may load the data saved in memory from previous execution of the first session into a new container set, and resume execution of the first session. In the case that there is insufficient capacity for the first session, the computing resource allocation module 104 may instantiate a temporary container set on other computer hardware as described herein. The computing resource configuration module 104 may transfer the first session back to the original computer hardware when there is sufficient capacity.

FIG. 2B shows additional information about application sessions 220, 222 being executed by computer hardware at geographic location 134, according to some embodiments of the technology described herein. As shown in FIG. 2B, the application session 220 is executed in a container set that includes container applications 220A, 220B. As application session 220 is temporarily being executed by the computer hardware, the container set for application session 220 additionally stores temporary configuration information 220C. The application session 222 is executed in a container set including container applications 222A, 222B. The container set stores configuration information 222C indicating that the container set is a normal container (i.e., not a temporary container set).

In some embodiments, the computing resource allocation module 104 may configure computer hardware to execute one or more container sets in addition to a container set for executing an application session. The other container set(s) may be required to execute the system. For example, the container set(s) may be needed for supporting operations such as network communication with a user device. To illustrate, the module 104 may configure the computer hardware to configure a container set that transmits application content (e.g., a video and/or audio stream) to a user device and/or receives a user input data stream. The user input data stream may provide data about user input (e.g., received from user input devices such as a mouse, keyboard, controller, touchscreen, motion sensor, and/or other input device).

FIG. 3A illustrates division of computation capacity of computer hardware at geographic location 130, according to some embodiments of the technology described herein. In some embodiments, the computing resource allocation module 104 of the software application streaming system 100 may divide processing capacity of computer hardware into multiple portions (e.g., units). In the example of FIG. 3A, the module 104 has divided a processor 300 of the computer hardware into computing portions 302. In some embodiments, the processor 300 may be a central processing unit (CPU). In some embodiments, the processor 300 may be a GPU. In some embodiments, there may be multiple processors (e.g., a CPU and GPU) for which computation capacity is divided.

In some embodiments, the computing resource allocation module 104 may divide the processing capacity of the processor 300 into equally sized portions 302 of a size specified by the module 104. In some embodiments, the portions 302 may be processing units of a processor (e.g., a GPU). In some embodiments, the portions 302 may be portions of memory (e.g., random access memory (RAM)). The computing resource allocation module 104 may specify a size of the portions 302 of the processor 300 in a server configuration. In some embodiments, the computing resource allocation module 104 may divide the processing capacity of the processor 300 into portions 302 of different size specified by the module 104. For example, the module 104 may store configuration information for each of the portions 302 indicating a size of the respective portion.

In some embodiments, the computing resource allocation module 104 may assign one or more of the portions 302 for execution of an application session. The computing resource allocation module 104 may assign portion(s) to an application session by mapping the portion(s) to container set(s) configured for execution of the application session. FIG. 3B illustrates an assignment of computing portions of the processor 300 for execution of different application sessions, according to some embodiments of the technology described herein. As shown in FIG. 3B, the computing resource allocation module 104 has: (1) assigned the set of portions 302A for execution of application session 200; and (2) assigned the set of portions 302B for execution of the application session 202. The computing resource allocation module 104 may assign the set of portions 302A to container set(s) for execution of the application session 200 and may assign the set of portions 302B to the container set(s) for execution of the application session 202.

In some embodiments, the computing resource allocation module 104 may determine the set of compute portions assigned for execution of an application session using various techniques. The computing resource allocation module 104 may determine a number and/or size of compute portions based on compute capacity needed by the application. For example, the computing resource allocation module 104 may determine a minimum size of graphics computation required for the application and determine the number and/or size of compute portions of a GPU based on the minimum size. As another example, the computing resource allocation module 104 may determine a set of portions assigned for execution of an application session based on capacity of the computer hardware. For example, the computing resource allocation module 104 may limit the number of portions assignable to an application session to ensure that a minimum number of application sessions can be executed by the computer hardware at a given time.

As an illustrative example, a GPU in computer hardware at a geographic location may have 2560 processing units (e.g., compute unified device architecture (CUDA) cores, or stream processors), and 16 gigabytes (GB) of onboard memory. When a request to access a given interactive application is received by the software streaming system 100 from a user device, the computing resource allocation module 104 may determine that 540 processing units and 2 GB of memory are needed to execute the interactive application. The computing resource allocation module 104 may identify computer hardware for execution of the software with sufficient resources. The computing resource allocation module 104 may configure the identified computer hardware to execute the interactive application by allocating 540 processing units and 2 GB memory of the computer hardware for execution of the interactive application. For example, the computing resource allocation module 104 may configure a container set for execution of the interactive application, and allocate 540 processing units and 2 GB of memory for use by the container set. In some embodiments, the computing resource allocation module 104 may increase or decrease processing capacity (e.g., the amount of the portions 302) assigned for execution of the interactive application (e.g., assigned to the container set). For example, the computing resource allocation module 104 may increase the number of processing units and/or the amount of memory allocated for execution in response to a request to perform functionality that requires more processing capacity (e.g., higher level graphics processing). As another example, the computing resource allocation module 104 may decrease the number of processing units and/or the amount of memory allocated for execution when it determines that a lower processing capacity is needed for execution (e.g., due to the user going idle).

FIG. 4A illustrates components of the virtual network module 108 of the software application streaming system 100, according to some embodiments of the technology described herein. The virtual network module 108 provides a communication network among various interactive applications of the system 100. In some embodiments, the virtual network may be implemented as a private network among the interactive applications. The virtual network may have end points in each of multiple interactive applications and allow for communication of data between different applications. The virtual network may further include a datastore (e.g., datastore 112) for storage of data as part of data transmission.

As shown in FIG. 4A, in some embodiments, the virtual network module 108 includes a consensus protocol 108A, a router 108B, and network storage 108C.

The consensus protocol 108A may comprise information that allows communication of software objects between different applications. In some embodiments, the consensus protocol 108A may include, for each application, a list of assets (e.g., software objects), applications that the assets can be communicated to through the virtual network, and information for use in transmitting the asset. The virtual network module 108 may use the consensus protocol when transmitting data between applications (e.g., to transform an object). The information for use in transmitting the asset may include end points (e.g., ports) of the application where data can be transmitted and/or received. An example depiction of a consensus protocol is described with reference to FIG. 4B.

In some embodiments, the router 108B may route data (e.g., software objects) between applications. The router 108B may allow applications to use the consensus protocol 108A to transmit data. In the example of FIG. 4A, the router 108B is routing data from application session 200 to application session 210, from application session 202 to application session 212, from application session 220 to application session 214, and from application session 224 to application session 222.

In some embodiments, the network storage 108C may be used in transmission of data between applications. For example, the network storage 108C may be a portion of the datastore 112 of the software application streaming system 100. In some embodiments, the network storage 108C may include a replicated database in which replica datasets are available in multiple different geographic locations (e.g., locations 130, 132, 134). When data is transmitted between applications, the data may be stored in the network storage 108C. The data may be replicated across the replica datasets. In some embodiments, when an application session is executed, the application session reads data from the replica dataset. A software object transmitted from an application may be stored in the network storage 108C. A destination application may read the software object from the network storage 108C. In some embodiments, the destination application may read the data from the network storage using the consensus protocol 108A. For example, the destination application may only allow objects specified in the consensus protocol 108A to be transmitted into the destination application. As another example, the destination application may transform an object based on instructions in the consensus protocol 108A. A transmitted object may then be associated with a user. For example, a record indicating the transmitted software object will be stored in an application profile associated with the user.

FIG. 4B illustrates example transmission of a software object 202A from application session 200 to an application session 210, according to some embodiments of the technology described herein.

As shown in FIG. 4B, the protocol 108A-1 specifies a list of objects for a first application including objects 402A, 402B, 402C. For the objects 402A, 402B, 40C, the consensus protocol 108A includes: (1) respective destination information 404A, 404B, 404C; and (2) respective transmission information 406A, 406B, 406C.

The destination information for each object may include an indication of applications to which the object can be transmitted to. In some embodiments, destination information may include an indication of the application and/or a reference to a point in the application to which the object may be transmitted. As an illustrative example, the destination information may include an application identifier and destination address for use in transmission of data to the application.

The transmission information may be used in executing a transmission of the object to a destination. In some embodiments, the transmission information may include instructions for transforming the origin object into an object that is usable by the destination application. For example, the transmission information may specify a software class to use in transmitting the original object (e.g., by transmitting information from the origin object into an instance of the software class). As another example, the transmission information may specify parameters to set to transmit an object. In some embodiments, transmission information for an object may indicate that the object can be transmitted as is to the other application. In such cases, the object may not need to undergo any transformation for transmission to a destination application.

The application session 200 shown in FIG. 4B may be a session of the first application for which the protocol 108A-1 specifies objects that can be transmitted to other applications. As shown in FIG. 4B, the application of session 200 is transmitting an instance of the object 402A from the session 200 of the first application to a session of another application. For example, the application may be transmitting an object from a virtual environment of a first videogame application to a virtual environment of a second videogame application. In the example of FIG. 4B, the object 402A is transformed into object 422A. The transmission information 406A from the protocol 108A-1 may be used to transform the object 402A into the transformed object 422A. For example, the transmission information 406A may indicate a target object into which the object 402A may be transformed for transmission to the application of session 210.

In some embodiments, the virtual network module 108 may have a protocol for each interactive application. The protocol may specify assets (e.g., software objects) of the application that may be transmitted, destination applications the assets may be transmitted to, and/or transmission instructions. In some embodiments, the router 108B may allow applications to use the protocols to perform transmissions. The application may read an application's protocol to determine how to transmit an object to a destination application. For example, the application may read transmission instructions and use them to transmit an object (e.g., by transforming the object or transmitting the object as-is).

Example assets that may be transmitted by the router 108B through the virtual network include: a 3D object from one virtual environment of a first application to a virtual environment of another application, user activity data (e.g., data indicating achievements, ranking, scores, user-developed items, and/or other user activity data), a user's avatar, electronic currency, messages (e.g., text, audio, and/or video messages), and/or other data. A transmitted asset may be identical in an origin and destination application or may be transformed from an origin application for transmission to a destination application.

In some embodiments, the application being executed in session 200 may connect to the virtual network through the router 108B. The application may then use information from the consensus protocol 108A for transmission of a software object. For example, the application of session 200 may connect to the router 108B and transmit the object 402A to the application of session 210 using the protocol 108A-1 of the consensus protocol 108A.

FIG. 5 illustrates processing of a query by the search module 110 of the software application streaming system 100, according to some embodiments of the technology described herein. The search module 110 may process the query to identify one or more search results. The search result(s) may be indications of interactive application(s) and/or components thereof that match a search object indicated by the query.

As shown in FIG. 5, the client interface module 106 receives a query from a user device 120A. The query may indicate a search object. In some embodiments, the query may include text indicative of the search object. For example, the text may identify an object, topic, action, or other search object to search for among the interactive applications. As another example, the query may include an image and/or audio indicating a search object.

As shown in FIG. 5, the search module 110 uses the search object indicated by the query to identify search results. The search module 110 searches code of software applications 500A, 500B, 500C, 500D to identify search result(s). In some embodiments, the search module 110 may search code of the software applications by parsing code of the applications. The search module 110 may parse the code to identify objects, data, methods, libraries, and/or other coding constructs that match the search object. For example, the search module 110 may parse the code to identify text that matches text of the query. In some embodiments, the software applications may be videogame applications with respective virtual worlds. The search module 110 may parse the code of the videogame applications to identify those matching the search object. For example, to process a query indicating a search object of “space travel”, the search module 110 may parse videogame application code to identify videogame applications involving space travel. In some embodiments, the search module 110 may parse a 3D game engine of a videogame application to identify search result(s).

As shown in FIG. 5, in some embodiments, the software application data 112 may include tag data 502A, 502B, 502C, 502D associated with respective software application code 500A, 500B, 500C, 500D. The tag data may include tags associated with various software objects in the code. For example, the tag data may specify keywords associated with methods, classes, and/or other software objects specified in the code. The search module 110 may use the tags to identify search result(s). For example, the search module 110 may use the tags to identify software objects that match a search object indicated by a query (e.g., by determining a likelihood that tags match a keyword in the query). The search module 110 may identify one or more tags based on the search object and identify one or more software objects associated with the identified tag(s) to determine the search result(s).

As shown in FIG. 5, the search module 110 may transmit the search result(s) to the client interface module 106 for presentation on the user device 120A. In some embodiments, the client interface module 106 may present the search result(s) by displaying, in a GUI, an indication of one or more interactive applications that were determined to match the search object. For example, the client interface module 106 may present a listing of videogame application(s) including the search object. In some embodiments, the client interface module 106 may provide selectable element(s) corresponding to the search result(s). When selected, a selected element may direct the user device 120A to an interactive application. The interactive application may be executed by allocated computer hardware using techniques described herein. For example, the selectable element may be a URL that causes the user device 120A to access a videogame application included in the result(s).

In some embodiments, the search module 110 may identify search result(s) comprising of software objects within interactive applications and/or interactive applications. For example, the search module 110 may identify and return search result(s) including interactive application(s), virtual object(s) within interactive application(s), achievement(s) within interactive application(s), environment(s) within interactive application(s), level(s) within interactive application(s), and/or other objects. For example, the search module 110 may perform a search for objects matching a query of “fishing activity”. The search module 110 may return all interactive applications with fishing activity, virtual objects related to fishing, and achievements made by videogame players in performing fishing. As another example, the search module 110 may perform a search for objects matching a query specifying a specific branded shoe item with high speed running capabilities. The search module 110 may identify and return all interactive applications that include the specified brand that includes the high speed running shoe.

FIG. 6A illustrates an example navigation GUI 600 that may be presented on a user device 120A by the client interface module 106 of the software application streaming system 100, according to some embodiments of the technology described herein. The navigation GUI 600 depicted in FIG. 6A may allow a user of the device 120A to explore various interactive applications that can be accessed through the software application streaming system 100. The navigation GUI 600 may, for example, be presented through an application installed on the device 120A. As another example, the navigation GUI 600 may be presented on a webpage of an Internet website.

As shown in FIG. 6A, the navigation GUI 600 includes multiple different graphical elements 602A, 602B, 602C, 602D, 602E, 602F, 602G, 602H, 602I. Each of the graphical elements may be associated with a respective interactive software application. In some embodiments, selection of one of the graphical elements may launch a respective interactive application (e.g., a videogame application) or may provide a menu through which a user can launch the respective interactive application. In some embodiments, each of the graphical elements may include a visualization indicating its associated interactive application. For example, each graphical element may comprise a display of information about content of the interactive application such as a title, an image of content from the application, a video of content from the application, and/or other information.

In the example of FIG. 6A, the graphical elements 602A, 602B, 602C, 602D, 602E, 602F, 602G, 602H, 602I are rectangular tiles. In some embodiments, the graphical elements may be other shapes such as circles, squares, triangles, and/or other shapes. In some embodiments, different graphical elements may be of different types of shapes.

In some embodiments, the client interface module 106 may determine visual characteristics of the graphical elements according to which they are displayed in the navigation GUI 600. In some embodiments, the client interface module 106 may determine the visual characteristics using data associated with interactive applications associated with the graphical elements. The client interface module 106 may access the data associated with the applications from a datastore (e.g., datastore 112). The client interface module 106 may dynamically modify the visual characteristics of the graphical elements based on the data. In some embodiments, the client interface module 106 may set a size of a graphical element (e.g., dimensions and/or area) using data associated with a respective interactive application. For example, the client interface module 106 may adjust a length and/or height of tiles in the navigation GUI 600. As illustrated in FIG. 6A, the different tiles may have different dimensions relative to one another. For example, the client interface module 106 may set a first tile associated with a first application to a first size and a second tile associated with another application to a second size different from the first size (e.g., based on data associated with the applications).

The data associated with an application used by the client interface module 106 in determining visual characteristics of a respective graphical element (e.g., a tile) may include various types of data. In some embodiments, the data may include data obtained from execution of the application. For example, the data may include data indicative of user progress in the application (e.g., in a videogame), a current number of users accessing the application, and/or other information. The data may be obtained from sessions of the application during execution (e.g., from container sets used for execution of the application). In some embodiments, the data may include data about the application (e.g., application metadata). The data about the application may include a number of accesses of the application in a time period (e.g., in the past 24 hours, past week, past month, past year, or other time period), a number of times a user of device 120A has accessed the application in a time period, a number of viewers of the application, a number of current sessions of the application being executed, ratings of the application, and/or other information about the application. As an illustrative example, the client interface module 106 may make graphical elements associated with applications having a greater number of accesses larger relative to graphical elements associated with applications having a lower number of accesses.

In some embodiments, the client interface module 106 may customize a map of graphical elements displayed in the navigation GUI 600 for a particular user viewing the GUI 600. The client interface module 106 may obtain data specific to the user and determine visual characteristics of the graphical element based on the data. For example, the client interface module 106 may determine the visual characteristics based on the number of times the user has accessed applications, an amount of time for which the user has accessed applications (e.g., played videogames), interests of the user (e.g., predicted using a machine learning model and/or specified by user input), and/or other user-specific data. Accordingly, the client interface module 106 provides a customized experience for a given user.

In some embodiments, the client interface module 106 may determine a rating of applications and use the rating of applications to determine visual characteristics of associated graphical elements. The client interface module 106 may determine the rating using data associated with the applications (e.g., data obtained from execution and/or metadata). In some embodiments, the client interface module 106 may determine the rating based on information about a user. For example, the client interface module 106 may identify interests of the user (e.g., using a machine learning model and/or through user input) and rate the applications based on the user interests. As another example, the client interface module 106 may use user-specific data associated with the applications (e.g., number of accesses, amount of time accessed, viewership of the user) to determine the ratings.

In some embodiments, the client interface module 106 may: (1) assign a rating to each graphical element using data associated with a user and/or an application associated with the graphical element; (2) and determine visual characteristics (e.g., dimensions) of the graphical element based on its assigned rating. For example, the client interface module 106 may assign a rating between 1 and 3 to each tile associated with a respective interactive application: (1) for tiles with an assigned rating of 1, the client interface module 106 may make the tile a first size; (2) for tiles with an assigned rating of 2, the client interface module 106 may make the tile a second size; and (3) for tiles with an assigned rating of 3, the client interface module 106 may make the tile a third size. The first size may be the largest, the second size may be smaller than the first size and larger than the third size, and the third size may be the smallest.

In some embodiments, the client interface module 106 may dynamically update the visual characteristics of the graphical elements in the navigation GUI 600. The client interface module 106 may update the characteristics in response to update to data associated with the applications. For example, as new data from and/or about the applications is obtained, the client interface module 106 may update visual characteristics of the graphical elements. The updated graphical elements may be rendered in the navigation GUI 600.

As shown in FIG. 6A, the navigation GUI 600 may include controls including a zoom in option 604 and a zoom out option 608. When selected, the options 604, 608 may zoom in and zoom out the navigation GUI 600. The navigation GUI 600 further includes a selectable element 606 that refreshes the navigation GUI 600 (e.g., using updated data associated with applications).

The navigation GUI 600 further includes a directory interface 610. As shown in FIG. 6A, the director interface 610 may allow a user to search for applications. The interface 610 includes a search bar 610A in which a user may enter a query (e.g., which may be processed by the search module 110 as described herein with reference to FIG. 5). The directory 610 further includes a listing 610 of applications. In some embodiments, the listing of applications may be a list of results obtained from processing of a query entered in the search bar 610A. As shown in FIG. 6A, the directory interface 610 may allow a user to view information about other users and teams. For example, the directory 610 may provide access to applications being accessed by the users and/or teams.

FIG. 6B shows an example viewer GUI 620 that may be presented by the client interface module 106 of the software streaming system 100, according to some embodiments of the technology described herein. The viewer GUI 620 may allow a user to view a user's application session. For example, the viewer GUI 620 may allow the user to watch another user play a videogame. In the example of FIG. 6B, the user device 120A has accessed an application which is being executed using computer hardware at geographic location 130. The viewers 120B may view the application session in real time through the viewer GUI 620.

As shown in FIG. 6B, the viewer GUI 620 includes a section 622 displaying a video stream of content from the application session. The section 622 may thus provide a real time view of the application session in progress. The viewer GUI 624 further includes a chat interface through which viewers and/or the application user may communicate with each other. The chat interface 624 may allow the different users to send messages and/or media to each other. In some embodiments, the chat interface 624 may include voting functionality. In some embodiments, input from the chat interface 624 may affect the game. For example, a result of a voting poll may affect the game (e.g., by rewarding the application user with points or other application currency).

In some embodiments, input affecting execution of the application may be received during a session of the application. For example, the input may be received during a session of a videogame application. In this example, the input may affect the session of the videogame application (e.g., by causing a character movement, adding/removing videogame currency, providing access to additional activity in the videogame application, granting a reward in the videogame application, unlocking access to a component of the videogame application, and/or other effect). In some embodiments, input affecting execution of the application may be received while a session of the application is not being executed (e.g., prior to the start of a session, after an end of a session, and/or when a session is paused or otherwise inactive). The input may affect subsequent execution of the application. For example, the input may be used in a subsequent session of the application and/or in a session of the application after it is resumed. As an illustrative example, a voting poll may be completed while a session of the application is not being executed. When the session is resumed, the input may affect execution of the application in the session. The system 100 may store indication of user input for use in a session (e.g., in a new session or in a resumed session).

As shown in FIG. 6B, the viewer GUI 620 further includes a collaborative development interface 626. The collaborative development interface 626 may allow multiple users to collaborate to affect the application. A user may provide input through the collaborative development interface 626 that affects an aspect of the application (e.g., of gameplay in a videogame application). For example, the collaborative development interface 626 may display application code that can be executed in real time to view an effect in the application. In some embodiments, code updates may be transmitted through the collaborative development interface 626 and/or the chat interface 624.

In some embodiments, the collaborative development interface 626 may allow users to affect the application outside of a session. For example, users may submit commands and/or code updates to the software application that are incorporated into code prior to initiation of a session. The system 100 may store the command and/or code updates (e.g., in datastore 112). When the application is executed in a subsequent session, the command and/or updated code may be executed in the session. In some embodiments, the collaborative development interface 626 may allow user input during execution of an application session. The user input may be incorporated into execution of the application session.

In some embodiments, the collaborative development interface 626 may include a chat interface and/or a command line interface to affect execution of an application. The chat interface and/or command line interface may be configured to receive user input that affects execution of the application (e.g., textual instructions, selections of available actions in a GUI, voting poll, and/or other user input). For example, the chat interface and/or the command line interface may allow a user to provide input affecting execution of a videogame application. To illustrate, a user input through the chat interface and/or the command line interface may forward time in the videogame application environment (e.g., from day to night, night to afternoon, or another change in time). As another example, the chat interface and/or the command line interface may allow a user to provide input to vote to change a definition in the application originally set by a developer of the application. For example, the result of a voting poll may change scenery in a videogame environment or modify a character in the videogame environment (e.g., by making the character bigger or stronger).

FIG. 24 shows an example navigation GUI 2400 through which a user can navigate various interactive applications, according to some embodiments of the technology described herein. In some embodiments, the GUI 2400 may be generated by the client interface module 106 of software application streaming system 100. The GUI 2400 includes a map 2402 of graphical elements (e.g., tiles) associated with respective software applications. The map 2402 includes a first tile 2402A associated with a first software application and a second tile 2402B associated with a second software application. As can be seen in FIG. 24, the first tile 2402A has different dimensions than the second tile 2402B. The dimensions of each tile may be determined by the client interface module 106 using data specific to the associated software application as described herein with reference to FIG. 6A.

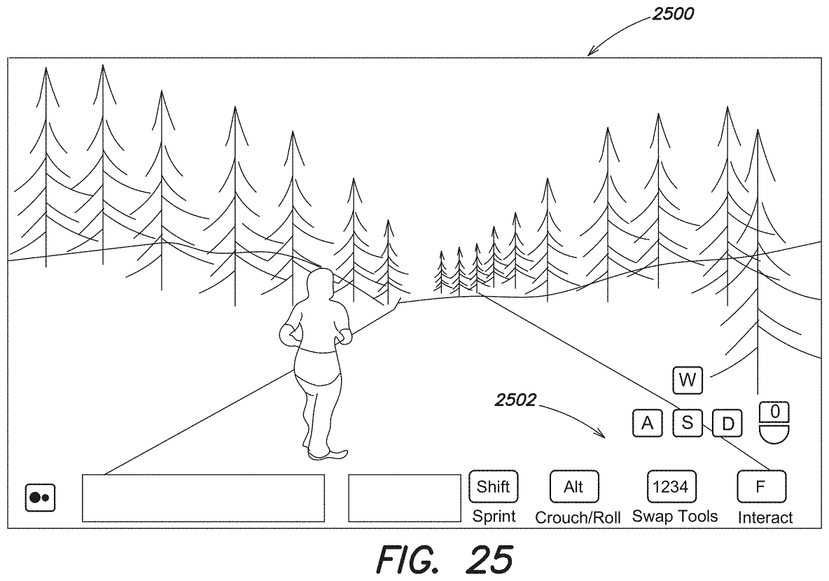

FIG. 25 shows an example GUI 2500 showing content streamed to a device from execution of an interactive application (e.g., accessed through the navigation GUI of FIG. 24) by a software application streaming system, according to some embodiments of the technology described herein. In some embodiments, the GUI 2500 may be generated by the client interface module 106 of the software application streaming system 100. In some embodiments, the interactive application may be executed by the software application streaming system 100. In the example of FIG. 25, the interactive application is a videogame application and the content streamed to the device is video of a user's character in the videogame application. The GUI 2500 includes a section 2502 indicating various control inputs that can be input by a user of the device. For example, the user can use the “w”, “a”, “s”, and “d” character keys to control movement of the user's character in the videogame application. Input received through the GUI 2500 may be used by the software application streaming system 100 in execution of the videogame application (e.g., to trigger actions by the user's character).

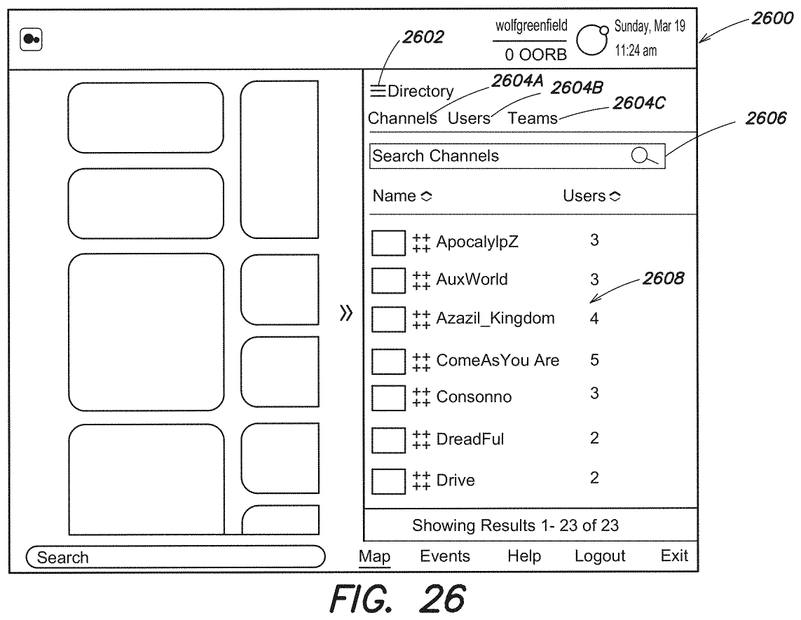

FIG. 26 shows a navigation GUI 2600 including a directory interface 2602 through which a user may access other interactive interfaces, according to some embodiments of the technology described herein. In some embodiments, the GUI 2600 may be generated by the client interface module 106. For example, the directory interface 2602 may be generated by the client interface module 106 in response to a selection in the navigation GUI 2400 of FIG. 24.

As shown in FIG. 26, the directory interface 2602 includes options 2604A, 2604B, 2604C to access different subdirectories. The option 2604A provides access to a subdirectory of channels associated with different interactive applications. The option 2604B provides access to a subdirectory of users. The option 2604C provides access to a subdirectory of teams (e.g., teams for a videogame application). In the example of FIG. 26, the directory interface 2602 shows a listing 2608 of channels in the subdirectory of channels. In some embodiments, the listing 2608 may show various sessions of interactive applications (e.g., channels). The director interface 2600 further includes a search box 2606 through which a user can provide a search query for items in the subdirectory. In the example of FIG. 26, the search box 2606 allows input of a search query for channels.

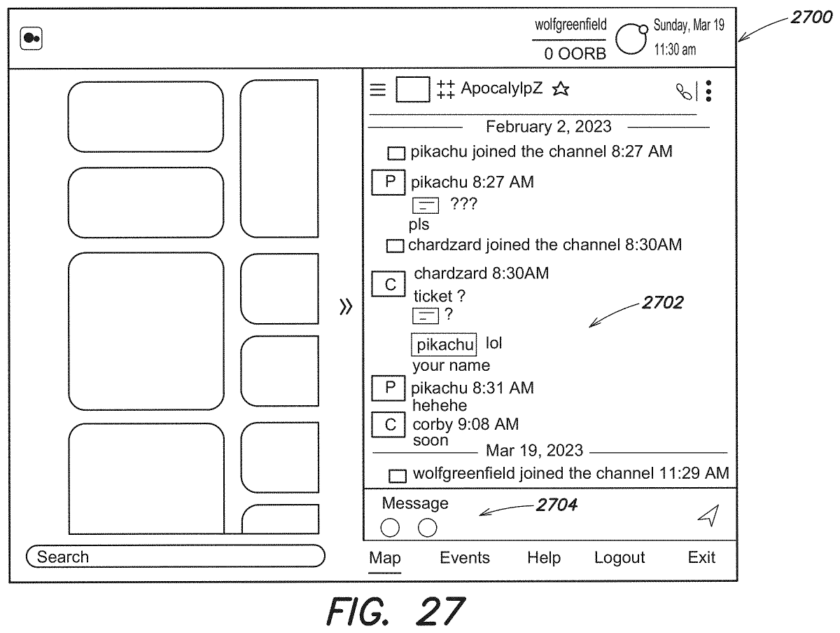

FIG. 27 shows a viewer GUI 2700 including an interactive interface associated with a session of an interactive application (e.g., a channel), according to some embodiments of the technology described herein. In some embodiments, the GUI 2700 may be generated by the client interface module 106 of software application system 100 (e.g., after a user accesses a particular channel from the directory interface 2602 of FIG. 26). In some embodiments, the interactive interface may include a chat interface. As shown in FIG. 27, the interactive interface includes a section 2702 displaying messages from various users. The interactive interface includes a section 2704 through which a user may submit messages. The interactive interface may allow users to communicate with respect to the session of the interactive application. For example, users may share messages and media (e.g., video and/or audio) through the interactive interface. In some embodiments, input in the interactive interface of FIG. 27 may affect execution of the interactive application. For example, a result of a poll completed through the interactive interface may provide a user in a videogame application with videogame currency (e.g., points). As another example, a videogame application may display graphical indications based on messages in the interactive interface. In some embodiments, the interactive interface may allow users to provide input in development of the interactive application. For example, the interactive interface may allow users to provide input that modifies functionality in the interactive application (e.g., by adding new functionality, removing functionality, or changing existing functionality), affects graphics in the interactive application (e.g., by adding visualizations to the software application), provides a user with an item in the interactive application, and/or affects execution of the interactive in another manner.

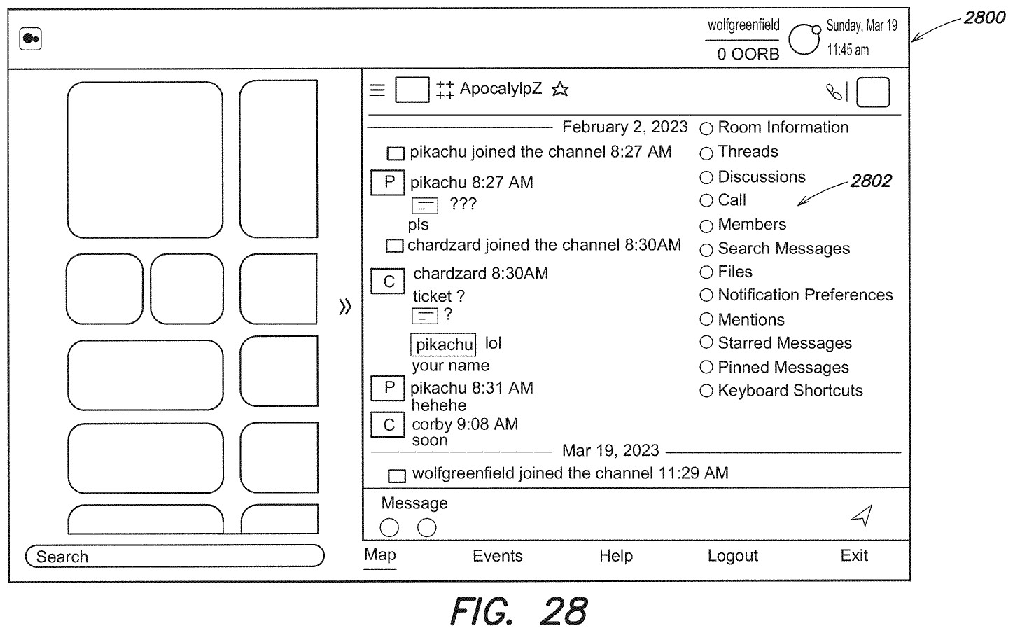

FIG. 28 shows a viewer GUI 2800 with a menu 2802 of additional options associated with a session of an interactive application (e.g., the channel of FIG. 27), according to some embodiments of the technology described herein. In some embodiments, the GUI 2800 may be generated by the client interface module 106 of software application streaming system 100 (e.g., after selecting an option in the interactive interface of FIG. 27). The menu 2802 provides a listing of options associated with a channel. The options may provide access to various other interfaces. For example, the menu 2802 includes an option to access threads, a discussions interface, a call interface, and a message search interface.

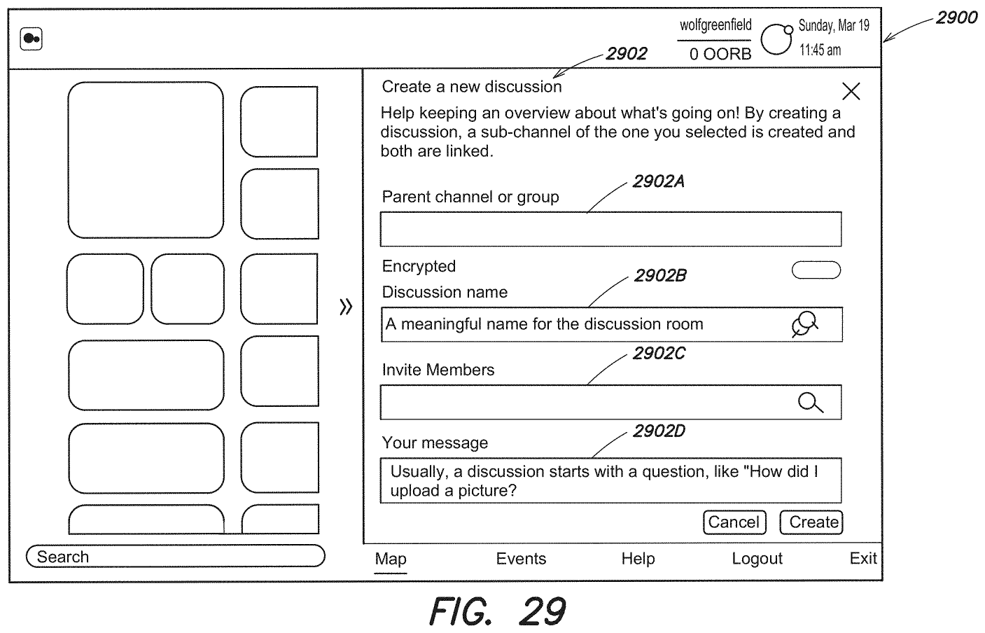

FIG. 29 shows a viewer GUI 2900 including an interface 2902 through which a user can create a new discussion associated with a session of an interactive, according to some embodiments of the technology described herein. In some embodiments, the GUI 2900 may be generated by the client interface module 106 of software application streaming system 100 (e.g., after selection of an option in the menu 2802 of GUI 2800 described with reference to FIG. 28). The interface 2902 includes various fields for creation of a discussion with respect to the session. In the example of FIG. 29, the fields include a field 2902A to specify a channel, a field 2902B for a discussion name, a field 2902C through which to invite members, and a field 2902D for a message. In some embodiments, the interface 2902 may include other field(s) in addition or instead of those shown in FIG. 29. A created discussion may allow multiple users to communicate and interact regarding the channel designated in the field 2902A.

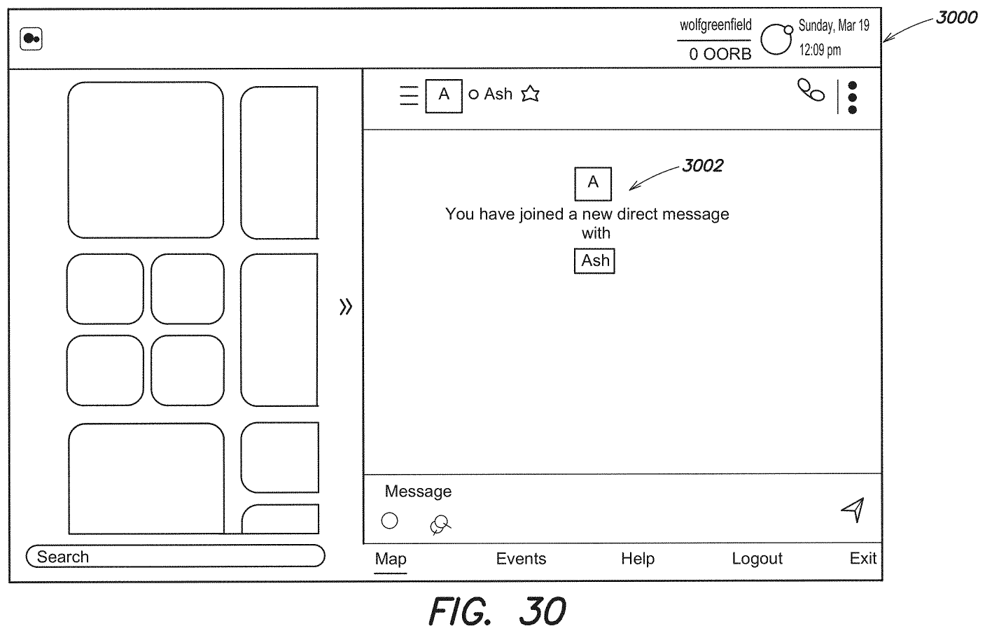

FIG. 30 shows a GUI 3000 including a chat interface 3002 through which a user can communicate with another user, according to some embodiments of the technology described herein. In some embodiments, the chat interface 3002 may be generated by the client interface module 106 of software application streaming system 100 (e.g., after a selection of a user from the directory interface 2602 of FIG. 26). As shown in FIG. 30, the chat interface 3002 includes a messaging interface through which a user may communicate with another user. The chat interface 3002 includes a section for displaying exchanged messages and a section through which a user can enter messages.

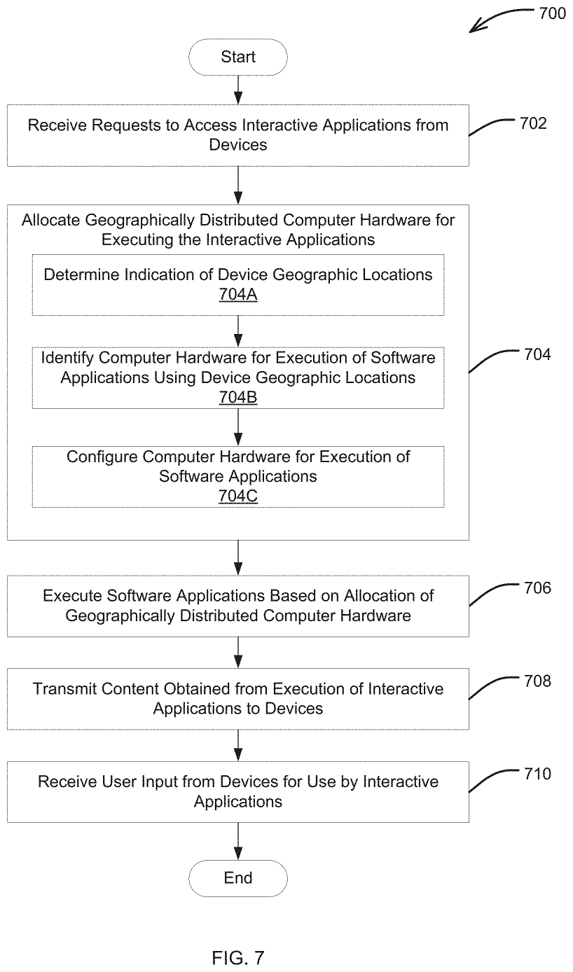

FIG. 7 shows an example process 700 of allocating geographically distributed computer hardware for execution of interactive applications, according to some embodiments of the technology described herein. In some embodiments, process 700 may be performed by software application streaming system 100 described herein with reference to FIGS. 1A-6B.

Process 700 begins at block 702, where the system receives requests to access interactive applications from multiple devices (e.g., user devices 120). In some embodiments, the system may receive the requests through GUIs provided to the user interfaces. For example, the system may receive the requests through a navigation GUI provided to the devices as described herein with reference to FIG. 6A. The system may receive a request from a given device in response to user input in the navigation GUI indicating a request to access a particular interactive application (e.g., videogame application). In some embodiments, the system may receive the requests through a communication network (e.g., the Internet). The system may receive the requests at various different times and/or simultaneously.

Next, process 700 proceeds to block 704, where the system allocates geographically distributed hardware for execution of the requested interactive applications. The system may configure hardware located in different geographic locations for execution of the applications requested for access at block 702. Block 704 includes sub-blocks 704A-704B.

At block 704A, the system determines an indication of geographic locations of the devices from which the requests were received. For example, the system may determine, as the indication of the device geographic locations, ping times between the devices and computer hardware at geographic locations that are configurable for execution of the applications. In this example, the system may cause computer hardware to transmit a ping message to one or more devices to and/or cause the devices to transmit a ping message to different sets of computer hardware. As another example, the system may determine GPS coordinates of the devices as the indication of their geographic locations. As another example, the system may determine IP addresses of the devices as the indication of their geographic locations.

Next, at block 704B, the system identifies computer hardware for execution of the requested software applications using the indication of the device geographic locations. In some embodiments, the system may identify computer hardware that is the closest of the available computer hardware to a given device to use for execution of an application requested by the device (e.g., to mitigate latency between the user device and the computer hardware). For example, the system may identify first computer hardware for execution of a first application based on determining that the first computer hardware is closest to a first user device that requested the first application. The system may identify second computer hardware for execution of the first application based on determining that the second computer hardware is closest to a second user device that requested the first application. Accordingly, two sessions of the first application may be executed on two different sets of computer hardware.

Next, at block 704C, the system configures the identified computer hardware for execution of respective applications. The system may be configured to configure computer hardware identified for execution of each application session. In some embodiments, the system may configure given computer hardware to execute an application session by configuring the computer hardware to execute the application session as a containerized application (e.g., as described herein with reference to FIGS. 2A-2B). The containerized application may include one or more sets of container applications (“container sets” or “pods”). Each container set or pod may include one or more container applications. In some embodiments, the system may be configured to use a container platform to manage execution of container applications. For example, the system may use Kubernetes to manage execution of the container applications. The Kubernetes may use one or more pods to execute an application session.

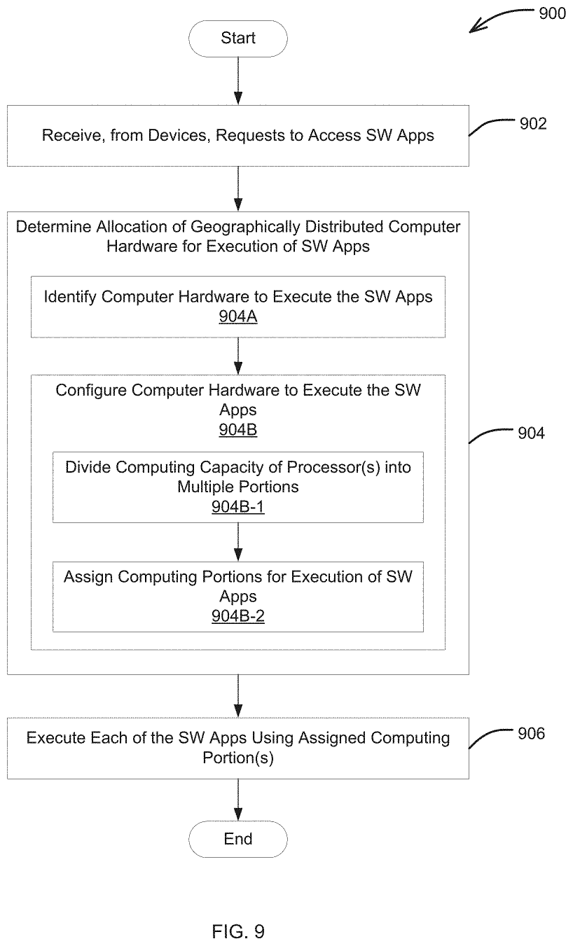

In some embodiments, the system may configure computer hardware to execute one or more applications by assigning compute portions of one or more processors of the computer hardware for execution of the application(s). An example process for doing so is described herein with reference to FIG. 9.

In some embodiments, the system may configure computer hardware to execute multiple application sessions. For example, where the computer hardware is located closest to multiple devices requesting access to one or more applications, the system may determine to configure the computer hardware to execute multiple application sessions. In some embodiments, the multiple application sessions may share certain resources (e.g., a 3D engine). The system may configure the computer hardware to execute one or more container applications that can be accessed by container sets of the respective application sessions. For example, the system may configure the computer hardware to execute one or more container applications providing a 3D engine that is used by multiple different application sessions being executed by the computer hardware.

After allocating the geographically distributed computer hardware for execution of the requested interactive applications at block 704, process 700 proceeds to block 706, where the system executes the software applications based on the allocation. The system may use the computer hardware configured for each application session to execute the application session. For example, the system may use processor(s) and memory of the computer hardware and/or portions thereof to execute the application sessions.

The system may communicatively couple computer hardware configured to execute a requested application with a requesting device. In some embodiments, the system may generate and transmit a secure URL to the user device that, when accessed, causes the user device to create a secure connection with the computer hardware. For example, the URL, when accessed, may cause the user device to form a secure connection through which the device can communicate with one or more container sets executing the requested application. The URL may be discarded after an application session is over (e.g., due to user exiting or threshold idle time).

Next, process 700 proceeds to block 708, where the system transmits content obtained from execution of the interactive applications to the devices. Computer hardware executing an application session may transmit content obtained from execution to a user device. In some embodiments, the computer hardware may transmit, to a user device, a video and/or audio stream of data generated from execution of the application session. The video and/or audio stream of data may be viewed and/or heard by a user of the user device. In some embodiments, the computer hardware may apply compression to the video and/or audio data prior to transmission. The user device may decompress and play the video and/or audio.

Next, process 700 proceeds to block 710, where the system receives user input from devices for use in execution of the interactive applications. Each of the user devices may be communicatively coupled to respective computer hardware executing application sessions. User input from the user device may be transmitted to respective computer hardware. For example, the user input may include input to a videogame application to control a character. The user input may be incorporated into execution of the applications (e.g., to affect progression of the application).

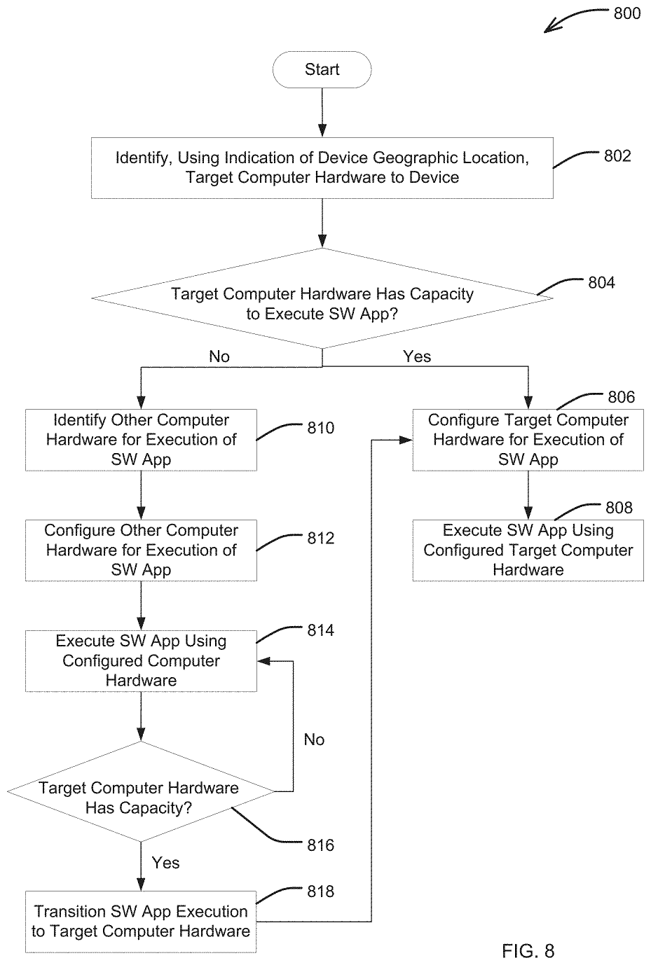

FIG. 8 is an example process 800 of dynamically allocating geographically distributed computer hardware for execution of an interactive application, according to some embodiments of the technology described herein. Process 800 may be performed by software application streaming system 100 described herein with reference to FIGS. 1A-6B.

Process 800 begins at block 802, where the system identifies target computer hardware for execution of an application using an indication of geographic location (e.g., ping times, GPS coordinates) of a requesting user device. The target hardware may be identified as described at block 704 of process 700 described herein with reference to FIG. 7. For example, the target computer hardware may be computer hardware located closest to the user device.

Next, process 800 proceeds to block 804, where the system determines whether the target computer hardware has sufficient capacity to execute the interactive application for the user device. For example, the system may determine whether the computer hardware has sufficient processing capacity (e.g., GPU and/or CPU processing capacity) to execute the interactive application. If the target computer hardware has sufficient capacity, then process 800 proceeds to block 806, where the system configured the target computer hardware for execution of the interactive application (e.g., by configuring the target computer hardware to execute a containerized application). The target computer hardware may then be used to execute the interactive. Example techniques of configuring computer hardware and executing an interactive application are described herein.

If, at block 804, the system determines that the target computer hardware does not have sufficient capacity to execute the interactive application, then process 800 proceeds to block 810 where the system identifies other computer hardware for execution of the interactive application. In some embodiments, the other computer hardware may be the computer hardware that is closest to the location of the user device after the target computer hardware. For example, the system may access a ranking of computer hardware by distance from the user device (e.g., as indicated by ping times) and select the other computer hardware from the ranking. In some embodiments, the other computer hardware may be computer hardware designated as backup for the target computer hardware.

Next, process 800 proceeds to block 812, where the system configured the other computer hardware for execution of the application. In some embodiments, the system may configure a temporary container set or pod on the other computer hardware. For example, the system may store configuration information indicating that the container set is temporary (e.g., as described herein with reference to FIG. 2A).

Next, process 800 proceeds to block 814, where the system executes the interactive using the configured other computer hardware. In some embodiments, the system may execute the interactive application using one or more container sets (e.g., temporary container set(s)) configured on the other computer hardware. For example, the user device may connect to the other computer hardware through a URL provided by the system to the device. The other computer hardware may stream content obtained from execution of the interactive application to the user device.

Next, process 800 proceeds to block 816, where the system determines whether the originally identified target computer hardware has capacity to execute the interactive. In some embodiments, the system may perform this determination during execution of the application by the other computer hardware. The system may monitor available processing capacity of the target computer hardware to determine whether there is capacity to execute the application.

If at block 816, the system determines that the target computer hardware does not have sufficient capacity, then process 800 returns to block 814 where the application continues being executed by the other computer hardware. If at block 816 the system determines that the target computer hardware has sufficient capacity to execute the application, then process 800 proceeds to block 818, where the system transitions the interactive execution from the other computer hardware to the target computer hardware. Process 800 may then proceed to block 806, where the system configures the target computer hardware for execution of the interactive. In some embodiments, the system may load application data into memory of the target computer hardware and initiate execution of the application data. The system may further load container set(s) for execution of the application in the target computer hardware.

The system may end the application session execution on the other computer hardware. In some embodiments, the system may close container set(s) that were configured for execution on the other computer hardware.

During execution of the application by the target computer hardware, in some embodiments, the system may pause execution when the system determines that a user has been idle for a threshold amount of time (e.g., 10 minutes, 15 minutes, 20 minutes, 30 minutes 1 hours, or another threshold amount of time) and/or when the system determines that the user has disconnected. The system may free the capacity of the target computer hardware for execution of other application(s). When the system determines that the user is active and/or reconnected, the system may repeat the steps described at blocks 804-818. The system may thus dynamically allocate computer hardware for active application sessions.

FIG. 9 is an example process 900 of allocating computer hardware capacity for execution of multiple interactive software applications, according to some embodiments of the technology described herein. In some embodiments, process 900 may be performed by software application streaming system 100 described herein with reference to FIGS. 1A-6B. In some embodiments, process 900 may be performed as part of block 704 of process 700 described herein with reference to FIG. 7.

Process 900 begins at block 902, where the system receives requests to access multiple interactive applications. The system may receive requests as described at block 702 of process 700 described herein with reference to FIG. 7.

Next, process 900 proceeds to block 904, where the system determines an allocation of geographically distributed computer hardware for execution of the interactive software applications. Process 900 includes sub-blocks 904A-904B.

At block 904A, the system identifies computer hardware for execution of the applications. The system may identify the computer hardware as described at block 704 of process 700. In the example of process 900, the system identifies computer hardware that will execute multiple software applications.

Next, process 900 proceeds to block 904B, where the system configures the identified computer hardware to execute the interactive software applications. The block 904B includes sub-blocks 904B-1 and 904B-2.

At block 904B-1, the system may divide the computing capacity of one or more processors of the computer hardware into multiple portions (e.g., as described herein with reference to FIG. 3A). The portions may be units of compute capacity that can be assigned for execution of applications. In some embodiments, the system may divide GPU processing capacity into multiple portions. The system may specify the size of each portion. In some embodiments, the system may divide CPU processing capacity into multiple portions and specify the size of each portion. In some embodiments, the system may divide processing capacity of both a GPU and CPU or the computer hardware. In some embodiments, the system may divide computing capacity of the processor(s) using configuration parameters provided through a container platform (e.g., Kubernetes).

Next, at block 904B-2, the system assigns computing portions for execution of each of the multiple applications. In some embodiments, the system may determine a number of computing portions to assign for a given application based on processing capacity required by the application. For example, the application may be a videogame that requires a minimum amount of GPU processing capacity. The system may assign sufficient GPU computing portions to meet the minimum capacity. In some embodiments, the system may store information indicating processing required for execution of an application. For example, the information may be provided in a configuration file populated by a developer of the application.

In some embodiments, the system may assign computing portion(s) to an application by assigning the computing portion(s) to container set(s) configured for execution of the application. The computing portion(s) may be designated for use by the container set(s). For example, the container set(s) may store information indicating compute portions that are available to the container set(s) for use in executing an application.

After determining the allocation of computer hardware at block 904, process 900 proceeds to block 906 where the system executes each of the interactive software applications on the computer hardware using their assigned compute portions. The applications may be executed in parallel on the computer hardware (e.g., as separate container set(s)).

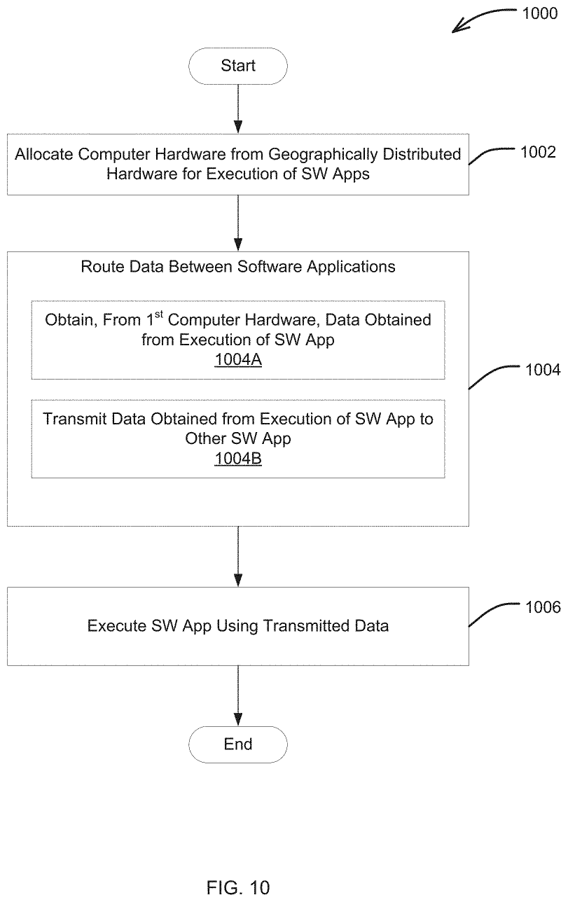

FIG. 10 shows an example process 1000 for routing data between interactive applications accessible through a software application streaming system, according to some embodiments of the technology described herein. In some embodiments, process 1000 may be performed by software application streaming system 100 described herein with reference to FIGS. 1A-6B.

Process 1000 begins at block 1002 where the system allocates computer hardware from geographically distributed computer hardware for execution of multiple interactive software applications. The system may allocate the computer hardware as described herein with reference to FIGS. 7-9.

Next, process 1000 proceeds to block 1004, where the system routes data between multiple interactive applications. As described herein with reference to FIGS. 4A-4B, the system may create a virtual network among the interactive applications with endpoints in the interactive applications. The system may route data (e.g., software objects) between interactive applications through the virtual network. Block 1004 includes sub-blocks 1004A-1004B.

At block 1004A, the system obtains, from first computer hardware, data obtained from execution of a first interactive application. In some embodiments, the first interactive application may be a videogame application having a virtual world. In some embodiments, the data may indicate a software object. For example, the software object may be a virtual item (e.g., a 3D object in a virtual world). As another example, the software object may be data associated with a user (e.g., user activity data such as progression in the application). As another example, the software object may be an avatar associated with a user. As another example, the software object may be a form of currency (e.g., points) of the first interactive application. As another example, the software object may be an executable function of the first interactive application.

Next, process 1000 proceeds to block 1004B, where the system transmits data obtained from execution of the first interactive application to another interactive application in the virtual network. In some embodiments, the system may transmit a software object from the first interactive application to the other interactive application. In some embodiments, the system may use its own protocol and/or a protocol associated with the other interactive application to transmit the software object. The protocol(s) may indicate destination application(s) of the software object and information for use in transmission of the software object to the destination application(s) (e.g., as described herein with reference to FIGS. 4A-4B). The system may use the protocol(s) to transmit the software object to the other interactive application.

In some embodiments, the system may transform the software object into a transformed object (e.g., using the protocol(s)) that can be used in execution of the recipient application. In some embodiments, the system may transmit the software object without applying a transformation (e.g., because it may be used in the recipient application with transformation). In some embodiments, the system may transmit data indicating the software object to a virtual network datastore. The data may be read by the recipient application to incorporate the transferred object (e.g., using a protocol associated with the recipient application).

Next, process 1000 proceeds to block 1006, where the system executes the recipient interactive application using the transmitted data. In some embodiments, the system may incorporate the software object into its environment. For example, the recipient application may be another virtual world of a videogame into which a 3D item from the transferring application is incorporated (e.g., provided to a user). As another example, currency from the transferring application (e.g., points) may be transferred as currency that can be used in the recipient application.

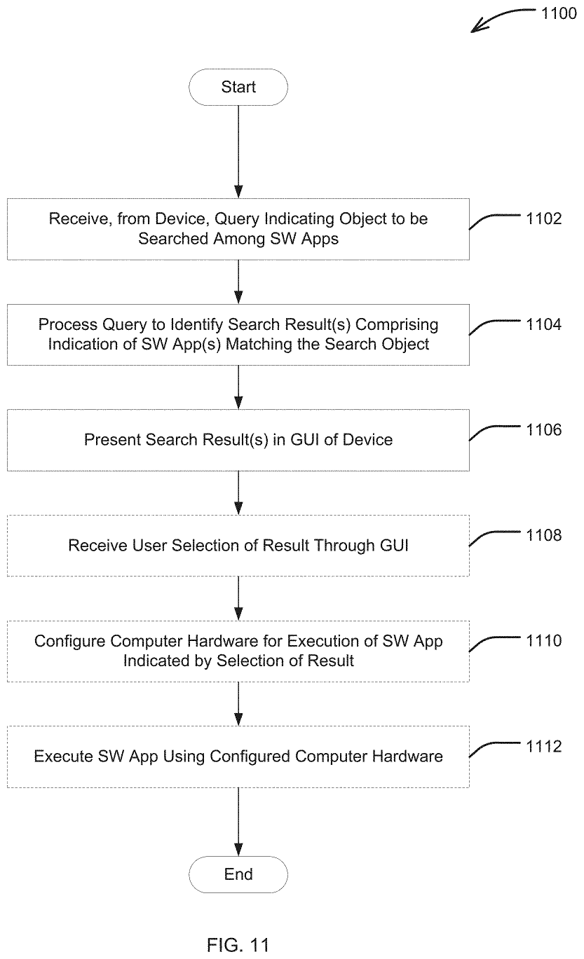

FIG. 11 is an example process 1100 of processing a search query submitted by a user device to an interactive application streaming system, according to some embodiments of the technology described herein. In some embodiments, process 1100 may be performed by software application streaming system 100 described herein with reference to FIGS. 1A-6B.

Process 1100 begins at block 1102, where the system receives, from a user device, a query indicating an object to be searched among the interactive software applications. In some embodiments, the search object may be a textual string indicating an object to be searched in the applications. For example, the search object may indicate a particular virtual object (e.g., a 3D item), a type of environment, a genre, a type of character, and/or another target of the search.

Next, process 1100 proceeds to block 1104, where the system may process the query to identify one or more search results. The search result(s) may be one or more applications and/or portions thereof that match the search object indicated by the query. In some embodiments, the system may process the query by parsing code of the applications to identify matches to the search object. For example, the system may analyze code to identify software objects matching the search object. In some embodiments, the system may store tags associated with various portions of code. The system may identify search result(s) by matching the search object query to one or more tags.

Next, process 1100 proceeds to block 1106, where the system presents search result(s) on a GUI of the device. In some embodiments, the system may present a listing of the search result(s). The listing may indicate application(s) including content that matches the search object indicated by the query. For example, the GUI may display a search results interface providing a list of identified application(s). In some embodiments, the listing may include selectable elements that, when selected, provide a user access to an application or portion thereof.

Next, process 1100 proceeds to block 1108, where the system receives user selection of a result through the GUI. The selection may launch an application or otherwise provide access to the application. Upon receiving a request to access the application, process 1100 proceeds to block 1110 where the system configures computer hardware for execution of the interactive application (e.g., as described herein with reference to FIGS. 7-9). Process 1100 then proceeds to block 1112, where the system executes the accessed interactive application using the configured computer hardware (e.g., as described herein with reference to FIGS. 7-9).

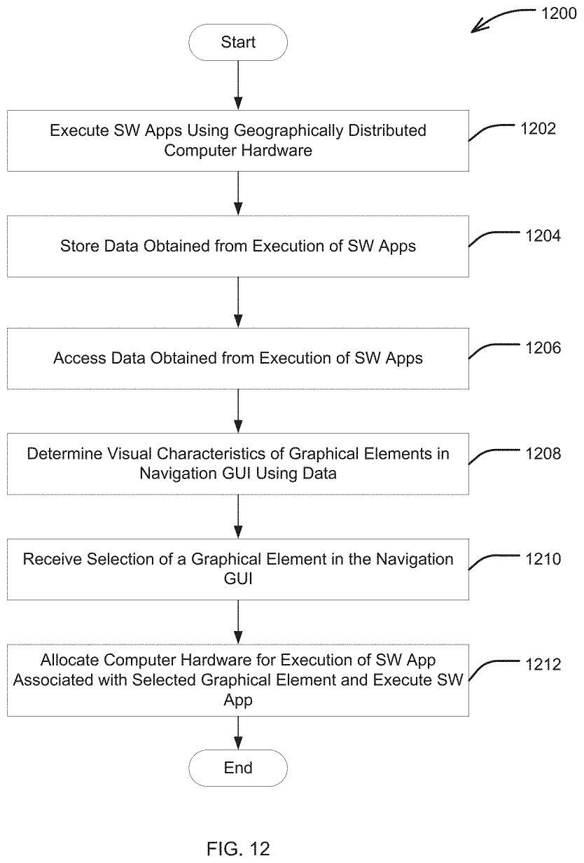

FIG. 12 shows an example process 1200 for generating a navigation GUI to navigate applications provided by a software application streaming system, according to some embodiments of the technology described herein. In some embodiments, process 1200 may be performed by software application stream 100 described herein with reference to FIGS. 1A-6B.

Process 1200 begins at block 1202, where the system executes interactive applications using geographically distributed computer hardware (e.g., as described herein with reference to FIGS. 7-9).

Next, process 1200 proceeds to block 1204, where the system stores data associated with respective interactive applications. In some embodiments, the system may store data obtained as a result of executing an application. For example, the system may store user activity (e.g. progression), time spent executing the application, achievements in the application, and/or other data. In some embodiments, the system may store data about applications. For example, the data about an application may comprise number of accesses across all users in a period of time, amount of time spent executing the application across all sessions, ratings of the application, and/or other data about the application.

Next, process 1200 proceeds to block 1202, where the system accesses the data associated with applications. For example, the system may read the data from a datastore of the system.

Next, process 1200 proceeds to block 1208, where the system determines visual characteristics of graphical elements in the navigation GUI using the data. Each graphical element may be associated with a respective application and provide access to a session of the application. In some embodiments, the system may determine dimensions and/or size of graphical elements (e.g., tiles) associated with respective applications. Example graphical elements and visual properties thereof are described herein with reference to FIG. 6A. The system may use the data to generate a dynamic visualization of the graphical elements. In some embodiments, the system may dynamically update the graphical elements responsive to updates in data associated with applications associated with the graphical elements.

In some embodiments, the graphical elements may provide a map that can be used by a user to navigate interactive applications accessible through the system. For example, the graphical elements may be a layout of tiles representing the applications. The navigation GUI may allow a user to scroll through the tiles to navigate the applications.

Next, process 1200 proceeds to block 1210, where the system receives selection of a graphical element in the navigation GUI. For example, the system may receive user input in response to a click, touch, or other interaction in the GUI. After receiving selection of the graphical element, process 1200 proceeds to block 1212 where the system allocates computer hardware for execution of the interactive application (e.g., as described herein with reference to FIGS. 7-9).

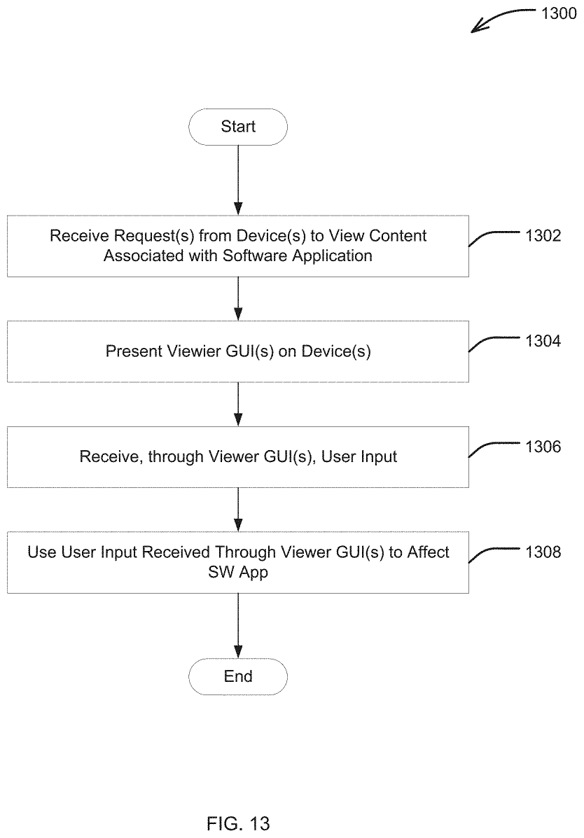

FIG. 13 is an example process 1300 of affecting execution of an interactive software application provided by a software application streaming system based on user input received through a viewer GUI, according to some embodiments of the technology described herein. In some embodiments, process 1300 may be performed by software application streaming system 100 described herein with reference to FIGS. 1A-6B.

Process 1302 begins at block 1302, where the system receives a request from user devices to view content associated with an interactive application. In some embodiments, the request may be a request to view another user using the (e.g., playing a videogame application). In some embodiments, the request may be received through a collaborative development interface to develop the interactive application.

Next, process 1300 proceeds to block 1304, where the system presents a viewer GUI on the devices. In some embodiments, the viewer GUI may allow users of the devices to view video streams of a user accessing the interactive application. In some embodiments, the viewer GUI may include a chat interface through which the user can communicate with each other (e.g., by sending messages or participating in polls). In some embodiments, the viewer GUI may include a collaborative development interface through which users can work together in developing the interactive application (e.g., by modifying code and/or triggering actions in the application).

Next, process 1300 proceeds to block 1306, where the system receives, through the viewer GUI user input. For example, the system may receive user input through the chat interface and/or a collaborative development interface provided by the viewer GUI.

Next, process 1300 proceeds to block 1308, where the system affects the interactive application in response to the received user input. In some embodiments, the input may be received during execution of the application. The input may be used to affect execution of the application. For example, a videogame application may reward a user with an item or points in response to the user input (e.g., a result of a voting poll). In some embodiments, the input may be received outside of a session in which the application is being executed. For example, the input may be a command and/or a change in code. The system may save a record of the input and respond to the input in a subsequent session of the application. For example, the system may trigger an action in a videogame in a subsequent session of the videogame.

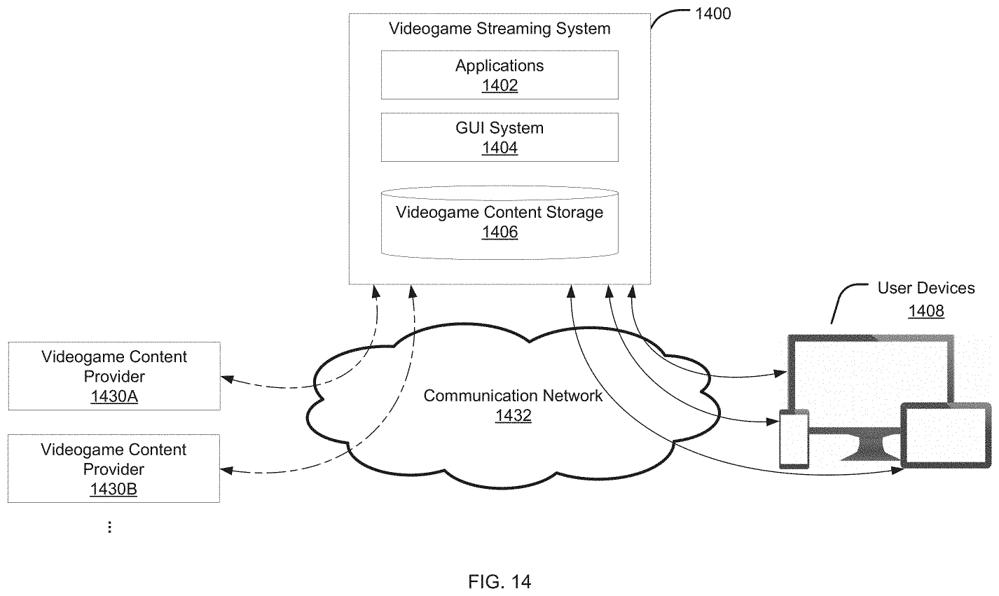

FIG. 14 is a block diagram of an example environment in which some embodiments of the technology herein may be implemented. The example FIG. 14 is an implementation of the software application streaming system 100 for streaming of videogame applications. The environment of FIG. 14 includes a videogame streaming system 1400, videogame content providers 1410A, 14410B, and client devices 1408. The videogame streaming system 1400, videogame content providers 1410A, 1410B, and client devices may communicate through a communication network 1412 (e.g., the Internet).

The videogame streaming system 1400 includes applications 1402, a graphical user interface (GUI) system 1404, and videogame content storage 1406.

The applications 1402 may be used by the videogame streaming system 1402 to deliver content to users through client devices 1408. In some embodiments, the applications 102 may be used by the videogame streaming system 1402 to stream a videogame to a client device. For example, an application may stream videogame content stored by the videogame streaming system (e.g., in storage 1406) to a client device through the communication network 1412 using an application.

In some embodiments, the applications 1402 may include an application that coordinates episodic delivery of videogame content. The application may be configured to activate and deactivate access to videogame segments (e.g., episodes) in different time periods such that the videogame segments are delivered to users over time. The application may be configured to coordinate episodic delivery of videogame content to optimize use of resources (e.g., streaming bandwidth, load distribution, and/or other resources).

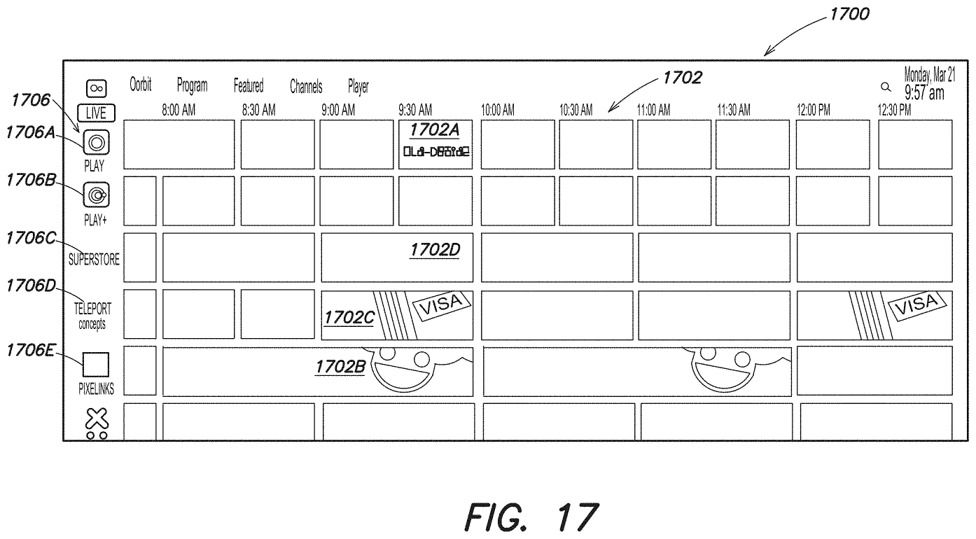

The GUI system 1404 may be configured to generate a GUI through which users can access videogame content from the videogame streaming system 1400 from a device (e.g., one of client devices 1408). The GUI system 1404 may be configured to generate a GUI that can be used by a user to browse available videogames, access videogames, and play videogames. In some embodiments, the GUI system 1404 may be configured to provide a plurality of channels through which videogame content can be provided. In some embodiments, a channel can be dedicated to a particular videogame content provider, a particular videogame, or to another entity. In some embodiments, the GUI system 1404 may be configured to generate a GUI that indicates time periods and videogame content available for access in each time period. Example GUIs that may be generated by the GUI system 1404 are described herein with reference to FIGS. 17-23. In some embodiments, the GUI system 1404 may include a portion that resides on a client device. For example, an application that generates a GUI for a particular device may be installed on a device (e.g., a smart tv, smartphone, tablet, laptop, or other computing device). The GUI system 1404 may provide a GUI for a user through the application on the device (e.g., after a user logs in with an account).

The videogame content storage 1406 may comprise storage resources for storing videogame content provided by videogame content providers (e.g., videogame content providers 1410A, 1410B). The storage hardware may comprise data warehouses, data servers, storage hardware (e.g., hard drives), computing devices, and/or other resources for storage of videogame content. The applications 1402 may obtain content from the videogame content storage 1406 to deliver to devices. In some embodiments, the applications 1402 may cause devices to access the videogame content storage 1406 to access content.

Video game content providers 1410A, 1410B may provide content (e.g., videogame episodes) to the videogame streaming system 1400. In some embodiments, a videogame content provider may upload content from a computing system to the videogame streaming system (e.g., through the communication network 1412). In some embodiments, the videogame streaming system 1400 may be configured to request content from the videogame content providers 1410A, 1410B. As indicated by the three dots, the videogame streaming system 1400 is not limited to any particular number of videogame content providers that can provide content to the videogame streaming system.

The client devices 1408 may include any suitable computing device. In some embodiments, the client devices 1408 may include smart TVs. For example, users may access the videogame streaming system 1400 through an application on the smart TV. In some embodiments, the client devices 1408 may include smartphones. For example, users may access the videogame streaming system 1400 through a mobile application of the smartphone. In some embodiments, the client devices 1408 may include a laptop, tablet, or other computing device. Users may access the videogame streaming system 1400 through an application on the computing device.

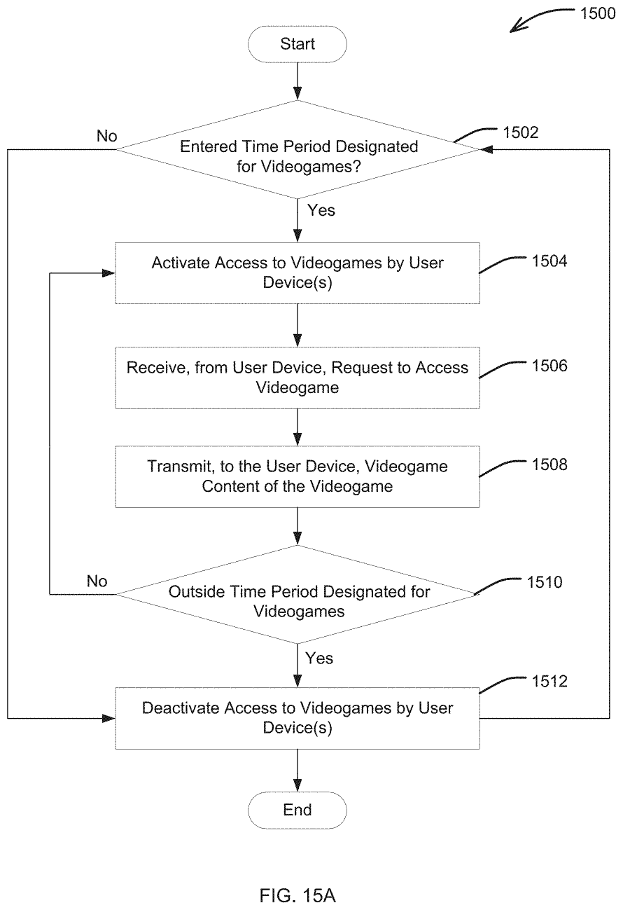

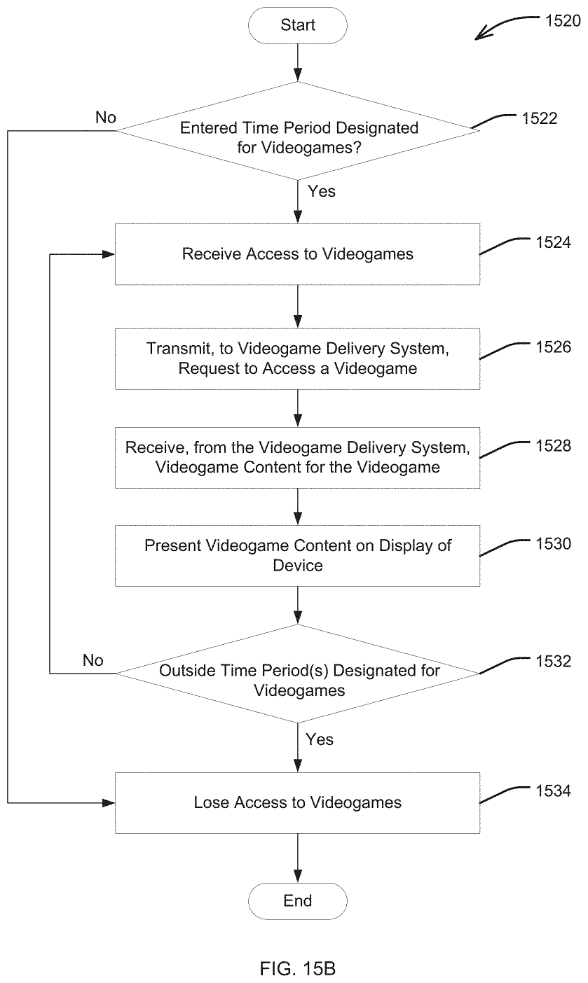

FIG. 15A is an example process 1500 of providing videogame content to devices, according to some embodiments of the technology described herein. Process 1500 may be performed by videogame streaming system 1400 described herein with reference to FIG. 14.

Process 1500 begins at block 1502, where the system determines whether it has entered a time period designated for videogames to be accessible by users. If it has not, then process 1500 proceeds to block 1512, where access to the videogames is not activated. If the system has entered such a time period, process 1500 proceeds to block 1504, where the system activates access to the videogames by client devices.

Next, at block 1506, the system receives, from a client device (e.g., through a communication network), a request to access a videogame for which access has been activated. Next, process 1500 proceeds to block 1506, where the system transmits, to the client device, videogame content (e.g., accessed from storage), or otherwise causes the client device to obtain the videogame content (e.g., by allowing and/or command the client device to access the content from storage). A user may then use the videogame content (e.g., by playing the videogame).

Next, process 1500 proceeds to block 1510, where the system determines whether the system has entered a time outside of a time period designated for videogames. If the system determines that the system has not entered such a time period, then process 1500 returns to block 1504, where the system maintains access to the videogames activated. Otherwise, the process 1500 proceeds to block 1512 where the system deactivates access to the videogames by the client device(s). After block 1512, process 1500 proceeds to block 1502.

It should be appreciated that process 1500 may be performed by the system for multiple different videogames and/or other content.

FIG. 15B is an example process 1520 of obtaining videogame content by a device, according to some embodiments of the technology described herein. Process 1520 may be performed by one of the client devices 1408 shown in FIG. 14. For example, the client device may perform the process 1500 by executing an application on the client device.

Process 1520 begins at block 1522, where the device may enter a time period in which access has been designated for videogames (e.g., by the system that performs process 1500). If so, then process 1500 proceeds to block 1524, where the device performing process 1500 receives access to the videogames. If the device has not entered a time period designated for access to the videogames, then process 1520 proceeds to block 1534 where the device remains unable to access the videogames.

After receiving access to the videogames at block 1524, process 1520 proceeds to block 1526, where the system transmits, to a videogame delivery system (e.g., the system performing process 1500), a request to access a videogame that it has access to. Next, at block 1528, the device receives, from the videogame delivery system, videogame content for the videogame. Next, at block 1530, the device presents the videogame content on a display of the device. For example, the device may generate an interactive GUI of the videogame that a user can use to play the videogame.

Next, process 1520 proceeds to block 1530, where the device enters a time period outside of the time period designated for the videogames. When the device enters such a time period, process 1520 proceeds to block 1534, where the device loses access to the videogames. If the device has not entered such a time period, then process 1520 returns to block 1524, where the device still has access to the videogames. For example, the user may access another one of the videogames available for access.

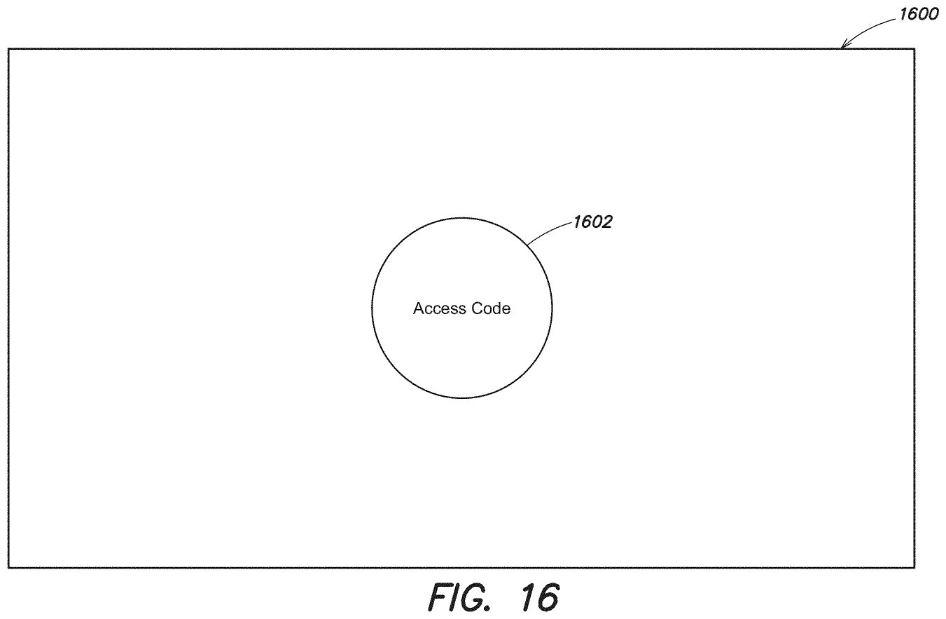

FIG. 16 is an example graphical user interface (GUI) 1600 for logging into a videogame delivery application, according to some embodiments of the technology described herein. The GUI 1600 includes a field 1602 for a user to enter an access code to access the videogame streaming system.

FIG. 17 is an example GUI 1700 providing access to streaming videogame content, according to some embodiments of the technology described herein. The GUI 1700 presents a tiled display of videogame content available in different time blocks. For example, in the time period from 9:30 AM to 10:00 AM, the videogames designated by tiles 1702A, 1702B, 1702C, 1702D are accessible. The GUI 1700 organizes videogame content into multiple different channels 1706. The channels 1706 include the channels 1706A, 1706B, 1706C, 1706D, 1706E. For example, a channel may be designated for a particular videogame content provider. In another example, a channel may be designated for a particular category of videogame content. In another example, a channel may be designated for a particular videogame (e.g., a virtual store).

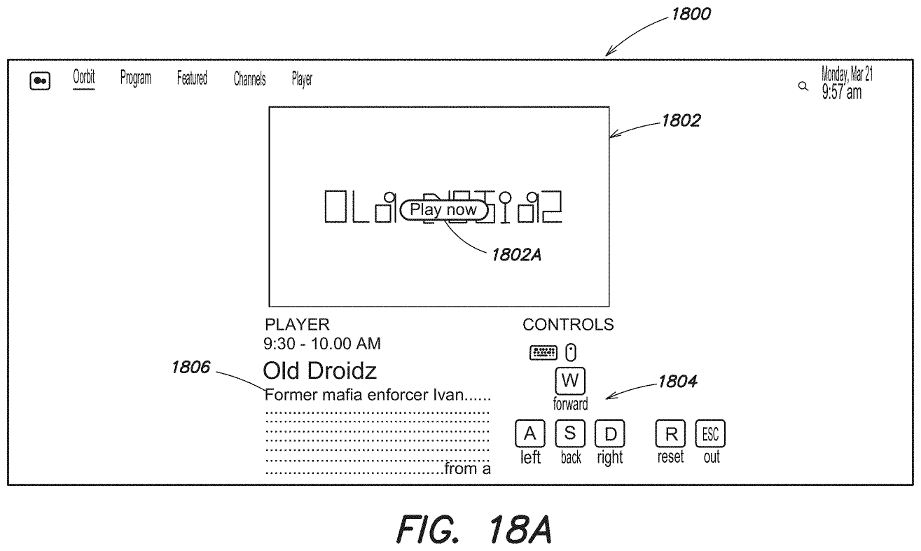

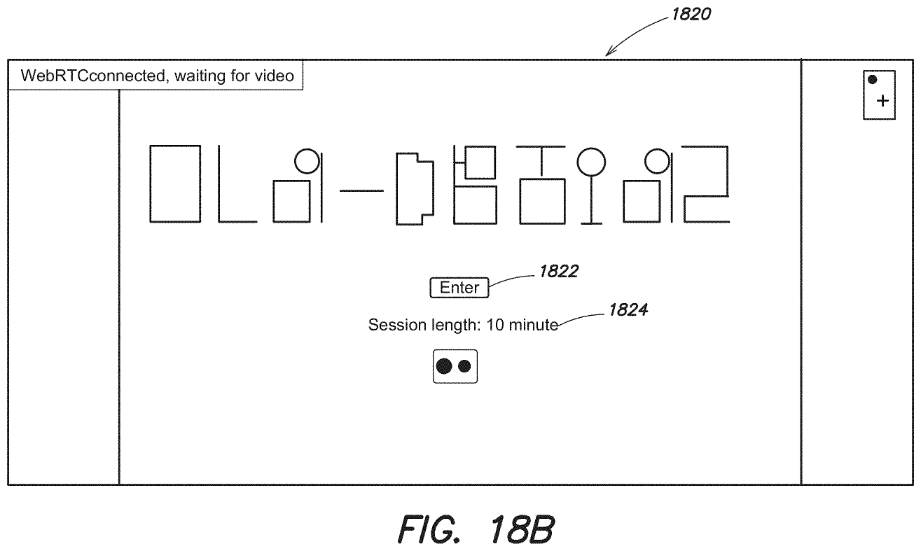

FIG. 18A is an example GUI 1800 for providing access to a particular videogame, according to some embodiments of the technology described herein. The GUI 1800 may be displayed after selection of the videogame designated by tile 1702A in FIG. 17. The GUI 1800 includes a section 1802 illustrating and/or for displaying the videogame. The section 1802 includes a selectable graphical element 1802A for initiating gameplay. The GUI 1800 further includes an indication 1804 of controls to play the videogame, and a description 1806 of the videogame.

FIG. 18B is an example GUI 1820 of a menu for starting the videogame of FIG. 18A, according to some embodiments of the technology described herein. The GUI 1820 may be displayed after a user has selected the graphical element 1802A of FIG. 18A. The GUI 1820 shows an option 1822 to enter the videogame. The GUI 1820 further includes an indication 1824 of the length of the content.

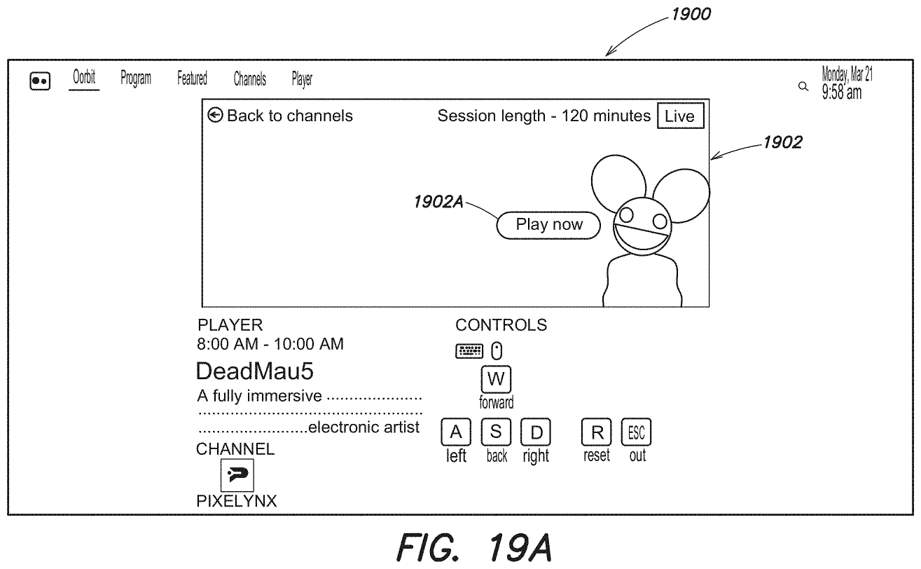

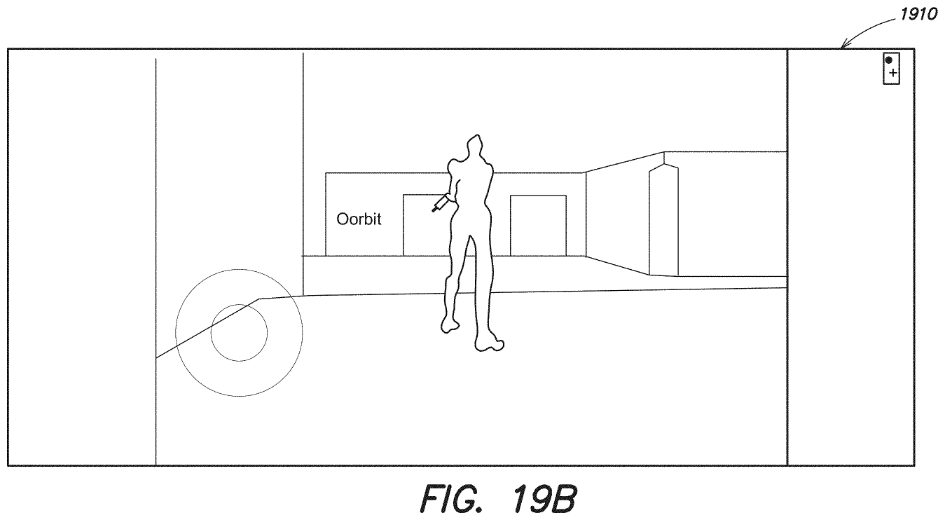

FIG. 19A is an example GUI 1900 for providing access to a particular videogame, according to some embodiments of the technology described herein. The GUI 1900 may be presented after selection of the videogame designated by 1702B of FIG. 17. The GUI 1900 includes an area 1902 for illustration of the videogame. The area 1902 includes a graphical element 1902A that may be selected to initiate the videogame.

FIG. 19B is a GUI 1910 for gameplay of the videogame of FIG. 19A, according to some embodiments of the technology described herein. The GUI 1910 may be displayed after selection of the graphical element 1902A of FIG. 19A.

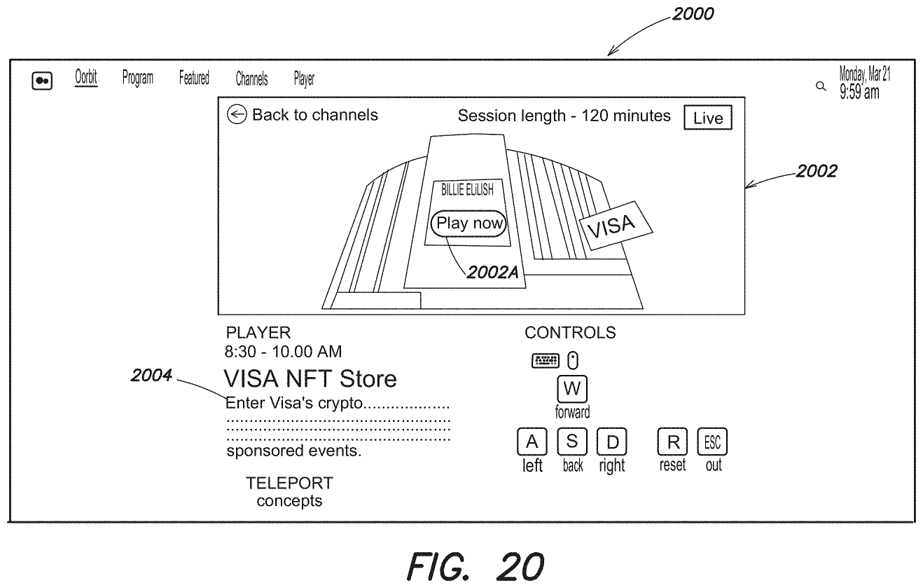

FIG. 20 is an example GUI 2000 for accessing a virtual store, according to some embodiments of the technology described herein. The GUI 2000 may be displayed after selection of the tile 1702C of FIG. 17. The GUI 2000 includes an area 2002 for displaying illustration associated with the virtual store. The area 2002 includes a graphical element 2002A that may be selected to access the virtual store. The GUI 2000 further includes a description 2004 of the store. A user may access the store to purchase items (e.g., using currency associated with a digital identity of the user in the videogame streaming system).

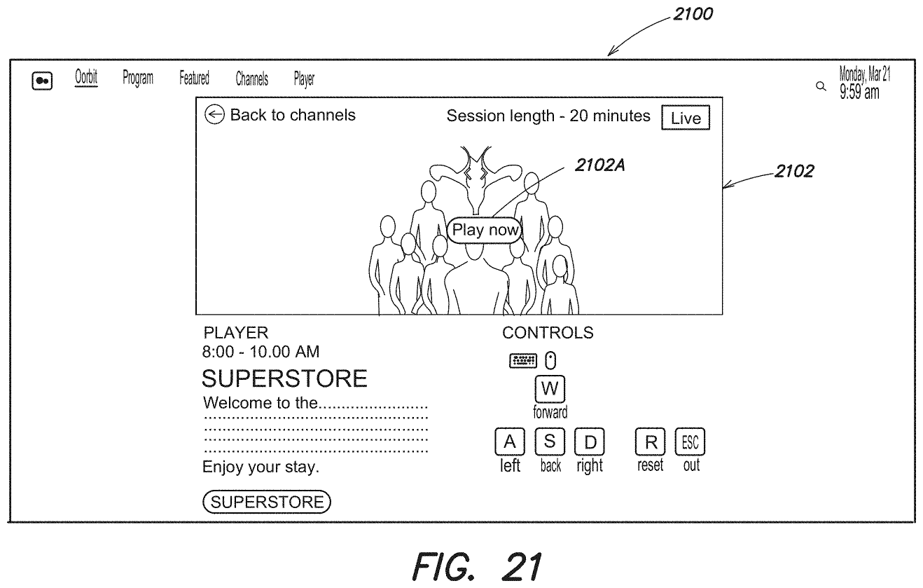

FIG. 21 is an example GUI 2100 for accessing a virtual store, according to some embodiments of the technology described herein. The GUI 2100 may be displayed after selection of the tile 1702D of FIG. 17. The GUI 2100 includes an area 2102 for displaying an illustration associated with the virtual store. The area 2102 includes a graphical element 2102A that may be selected to access the virtual store. The GUI 2100 further includes a description of the store, and information indicating controls for the store.

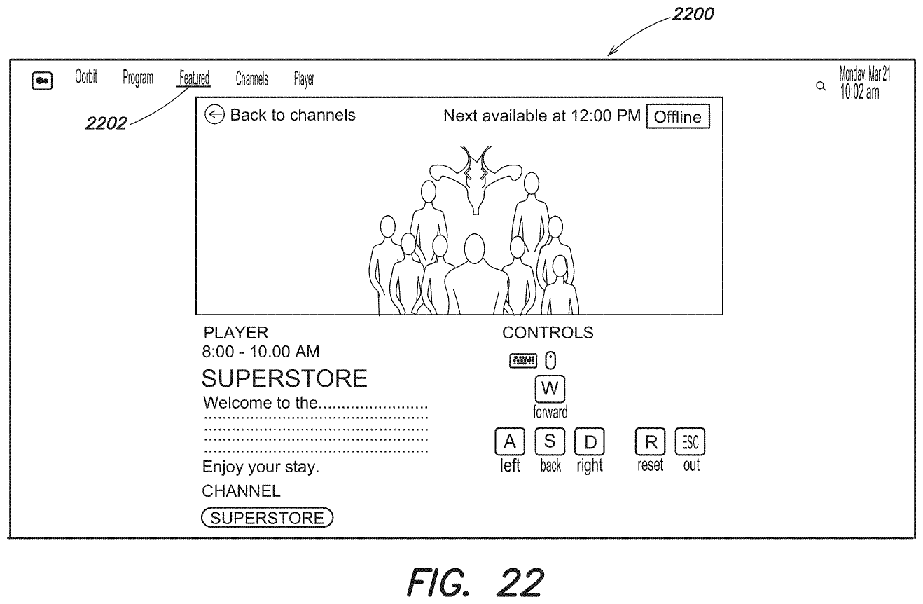

FIG. 22 is an example GUI 2200 for providing access to featured videogame content, according to some embodiments of the technology described herein. The GUI 2200 may be displayed after selection of a menu item 2102. The featured videogame content may be designated by the videogame streaming system (e.g., to promote the content).

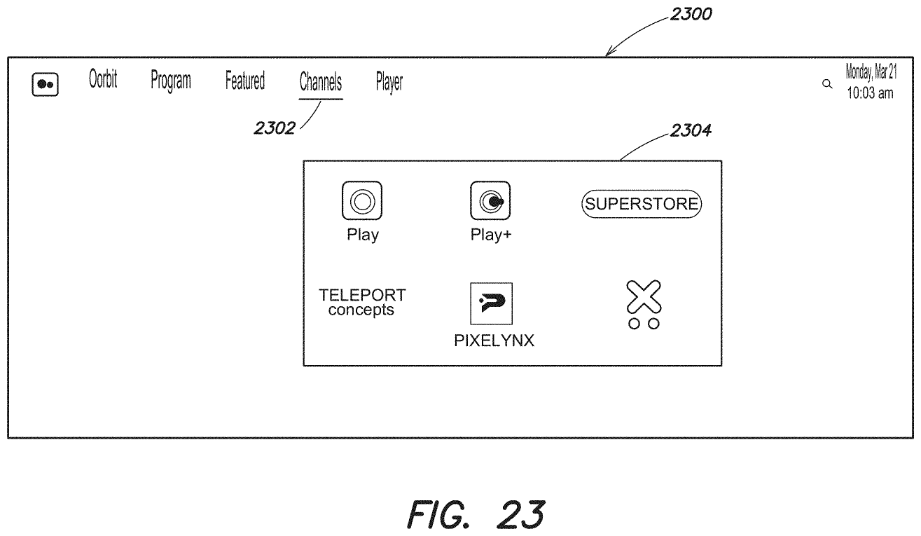

FIG. 23 is an example GUI 2300 displaying different channels of videogame content, according to some embodiments of the technology described herein. The GUI 2300 may be presented after selection of menu item 2302. The GUI 2300 includes a display 2304 of graphical elements indicating different channels of the videogame streaming system.

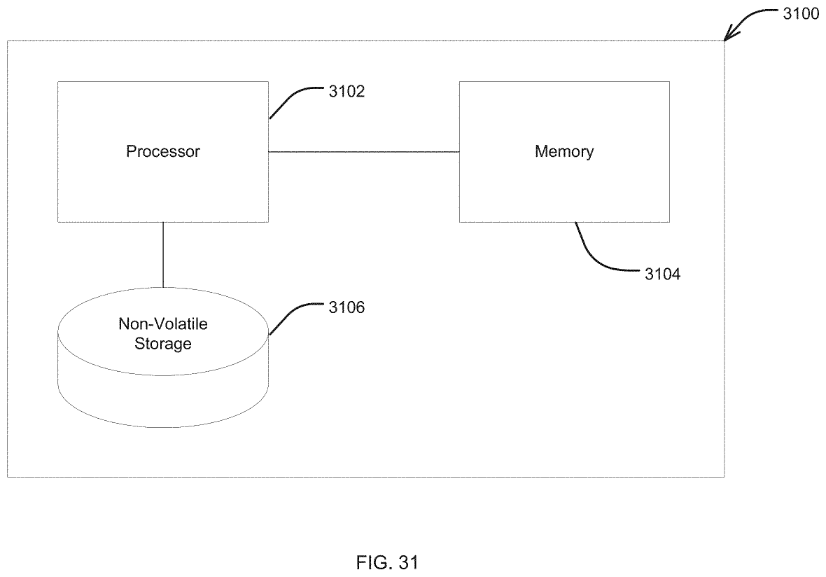

FIG. 31 shows a block diagram of an example computer system 3100 that may be used to implement embodiments of the technology described herein. The computing device 3100 may include one or more computer hardware processors 3102 and non-transitory computer-readable storage media (e.g., memory 3104 and one or more non-volatile storage devices 3106). The processor(s) 3102 may control writing data to and reading data from (1) the memory 3104; and (2) the non-volatile storage device(s) 3106. To perform any of the functionality described herein, the processor(s) 3102 may execute one or more processor-executable instructions stored in one or more non-transitory computer-readable storage media (e.g., the memory 3104), which may serve as non-transitory computer-readable storage media storing processor-executable instructions for execution by the processor(s) 3102.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A software application streaming system for executing a plurality of interactive applications accessible by multiple devices by allocating geographically distributed computer hardware for execution of the plurality of interactive applications, the system comprising:
a datastore;
at least one processor; and
at least one non-transitory computer-readable storage medium storing instructions that, when executed by the at least one processor, cause the at least one processor to execute a plurality of modules of the software application streaming system, the plurality of modules including:
an application execution module configured to:
execute at least some of the plurality of the interactive applications using computer hardware of the geographically distributed computer hardware; and
store, in the datastore, data obtained from previous execution of the at least some interactive applications;
a client interface module configured to:
provide a navigation GUI to the multiple devices through which the multiple devices can access the plurality of interactive applications, the navigation GUI comprising a map comprising a plurality of graphical elements each associated with a respective one of the plurality of interactive applications;
access, from the datastore, data associated with the at least some interactive applications;
determine, using the data associated with the at least some interactive applications, visual characteristics of at least some of the plurality of graphical elements; and
receive, through the navigation GUI from a first one of the multiple devices, user input selecting a first one of the plurality of graphical elements associated with a first one of the at least some interactive applications; and a computing resource allocation module configured to:
after receipt of the user input selecting the first graphical element, allocate first computer hardware of the geographically distributed computer hardware for execution of the first interactive application;
wherein the application execution module is configured to use the first computer hardware to execute the first interactive application.

2. The system of claim 1, wherein determining, using the data associated with the at least some interactive applications, the visual characteristics of the at least some graphical elements associated with the at least some interactive applications comprises:
setting dimensions of the at least some graphical elements in the GUI using the data associated with the at least some interactive applications.

3. The system of claim 2, wherein setting the sizes of the at least some graphical elements in the GUI using the data associated with the at least some interactive applications comprises:
determining a rating of the at least some interactive applications using the data associated with the at least some interactive applications; and
setting the dimensions of the at least some graphical elements in the GUI based on the rating.

4. The system of claim 2, wherein:
the data associated with the at least some interactive applications comprises data indicating numbers of accesses and/or viewers of the at least some interactive applications; and
setting the dimensions of the at least some graphical elements using the data associated with the at least some interactive applications comprises setting the dimensions of the at least some graphical elements based on numbers of accesses and/or viewers of the at least some interactive applications.

5. The system of claim 4, wherein:
the at least some interactive applications comprise a first interactive application and a second interactive application; and
setting the dimensions of the at least some graphical elements based on numbers of accesses and/or viewers of the at least some interactive applications comprises:
setting a first one of the at least some graphical elements associated with the first interactive application to a first size; and
setting a second one of the at least some graphical elements associated with the second interactive application to a second size different from the first size.

6. The system of claim 1, wherein the plurality of graphical elements associated with the plurality of interactive applications comprises tiles associated with the plurality of interactive applications.

7. The system of claim 1, wherein:
the client interface module is further configured to dynamically update the visual characteristics of the at least some graphical elements in response to updates to the data associated with the at least some interactive applications.

8. The system of claim 1, wherein:
the data associated with the at least some interactive applications comprises data obtained from execution of the at least some interactive applications.

9. The system of claim 1, wherein the client interface module is further configured to:
after receipt of a user selection of a graphical element of the plurality of graphical elements from a device of the multiple devices:
provide, to the device, an application GUI displaying content generated from execution of an interactive application associated with the selected graphical element.

10. The system of claim 1, wherein the client interface module is further configured to provide, to a plurality of devices, a viewer GUI associated with a session of the first interactive application.

11. The system of claim 10 wherein the viewer GUI comprises:
a chat interface through which messages can be transmitted among at least some of the multiple devices.

12. The system of claim 10, wherein the viewer GUI further comprises:
a collaborative development interface through which users of the plurality of devices can provide input for developing functionality of the first interactive application.

13. The system of claim 11, wherein the application execution module is further configured to:
receive, through a viewer GUI of a device of the plurality of devices, user input; and
affect execution of the session of the first interactive application based on the user input.

14. The system of claim 13, wherein the first interactive application is a videogame application and affecting execution of the session of the first interactive application based on the user input comprises modifying an aspect of gameplay within the videogame application in response to the user input.

15. The system of claim 12, wherein receiving the user input comprises receiving the user input prior to initiation of the session of the first interactive application.

16. The system of claim 12, wherein receiving the user input comprises receiving the user input during the session of the first interactive application.

17. A method for executing a plurality of interactive applications accessible by multiple devices by allocating geographically distributed computer hardware for execution of the plurality of interactive applications, the method comprising:
using at least one processor to perform:
executing at least some of the plurality of the interactive applications using computer hardware of the geographically distributed computer hardware; and
storing, in a datastore of the software application streaming system, data obtained from previous execution of the at least some interactive applications;
providing a navigation GUI to the multiple devices through which the multiple devices can access the plurality of interactive applications, the navigation GUI comprising a map comprising a plurality of graphical elements each associated with a respective one of the plurality of interactive applications;
accessing, from the datastore, data associated with the at least some interactive applications;
determining, using the data associated with the at least some interactive applications, visual characteristics of at least some of the plurality of graphical elements; and
receiving, through the navigation GUI from a first one of the multiple devices, user input selecting a first one of the plurality of graphical elements associated with a first one of the at least some interactive applications; and
after receipt of the user input selecting the first graphical element, allocating first computer hardware of the geographically distributed computer hardware for execution of the first interactive application; and
using the first computer hardware to execute the first interactive application.

18. The method of claim 17, wherein determining, using the data associated with the at least some interactive applications, the visual characteristics of the at least some graphical elements associated with the at least some interactive applications comprises:
setting dimensions of the at least some graphical elements in the GUI using the data associated with the at least some interactive applications.

19. The method of claim 17, further comprising:
providing, to a plurality of devices, a viewer GUI associated with the first interactive application;
receiving, through a viewer GUI of a device of the plurality of devices, user input; and
affecting execution of the first interactive application in a session based on the user input.

20. At least one non-transitory computer-readable storage medium storing instructions that, when executed by at least one processor, cause the at least one processor to perform a method for executing a plurality of interactive applications accessible by multiple devices by allocating geographically distributed computer hardware for execution of the plurality of interactive applications, the method comprising:
executing at least some of the plurality of the interactive applications using computer hardware of the geographically distributed computer hardware; and
storing, in a datastore of the software application streaming system, data obtained from previous execution of the at least some interactive applications;
providing a navigation GUI to the multiple devices through which the multiple devices can access the plurality of interactive applications, the navigation GUI comprising a map comprising a plurality of graphical elements each associated with a respective one of the plurality of interactive applications;
accessing, from the datastore, data associated with the at least some interactive applications;
determining, using the data associated with the at least some interactive applications, visual characteristics of at least some of the plurality of graphical elements; and
receiving, through the navigation GUI from a first one of the multiple devices, user input selecting a first one of the plurality of graphical elements associated with a first one of the at least some interactive applications; and
after receipt of the user input selecting the first graphical element, allocating first computer hardware of the geographically distributed computer hardware for execution of the first interactive application; and
using the first computer hardware to execute the first interactive application.
